(19) United States
(12) Patent Application Publication
(10) Pub. No.: US 2026/0148254 A1
(43) Pub. Date: May 28, 2026

(54) PREDICTION SYSTEM AND CONTROL METHOD THEREOF, AND LEARNING METHOD OF PREDICTION SYSTEM

(71) Applicant: LG MANAGEMENT DEVELOPMENT INSTITUTE CO., LTD., Seoul (KR)

(72) Inventors: Kyo Chul JANG, Seoul (KR); Jae Mu CHOI, Seoul (KR); Seung Jun JANG, Seoul (KR); Seo Young CHOI, Seoul (KR); Young Hoon HONG, Seoul (KR)

(21) Appl. No.: 19/454,377

(22) Filed: Jan. 21, 2026

Related U.S. Application Data
(63) Continuation of application No. PCT/KR2025/009639, filed on Jul. 4, 2025.

(30) Foreign Application Priority Data
Aug. 16, 2024 (KR) 10-2024-0109936
Jun. 9, 2025 (KR) 10-2025-0074974
Jul. 4, 2025 (KR) 10-2025-0089656

(51) Int. Cl. G06Q 30/0202; G06N 5/01

(52) U.S. Cl. CPC G06Q 30/0202; G06N 5/01

(57) ABSTRACT

A prediction system predict valid customer companies or valid customers in business-to-business (B2B) and/or business-to-consumer (B2C) sales situations. A computerized method comprise: specifying a train dataset including values for a plurality of different categories; configuring a plurality of different sub-datasets based on a specific value of a specific category using the train dataset such that a ratio of different values corresponding to the specific category among the plurality of different categories satisfy a preset ratio criterion; training a plurality of target prediction models on each of the plurality of different sub-datasets; inputting input data to be predicted to each of the plurality of the trained target prediction models; acquiring a plurality of prediction values for the input data from the plurality of trained target prediction models; and specifying a final prediction value for the input data using the plurality of prediction values.

### CROSS REFERENCE TO RELATED APPLICATION(S)

This application is a continuation of International Application No. PCT/KR2025/009639, filed on Jul. 4, 2025, which claims the priority to Korean Patent Application No. 10-2024-0109936, filed on Aug. 16, 2024, Korean Patent Application No. 10-2025-0074974, filed on Jun. 9, 2025, and Korean Patent Application No. 10-2025-0089656, filed on Jul. 4, 2025, which are all hereby incorporated by reference in their entireties.

### TECHNICAL FIELD

The present disclosure generally relates to a prediction system, control method thereof, and a learning method of the prediction system. More particularly, some embodiments of the present disclosure relate to a prediction system for predicting valid customer companies or valid customers in business-to-business (B2B) and/or business-to-consumer (B2C) sales situations, and a control method and a learning method of the prediction system.

### BACKGROUND ART

The recent development of artificial intelligence (AI) has led to a rapid increase in cases of remarkable achievements across various industry fields. In particular, the development of machine learning (ML) and deep learning technologies have significantly contributed to the development of artificial intelligence models that learn patterns from massive amounts of data and support prediction and decision-making.

Meanwhile, the quantity and quality of train data directly affect the generalization performance of an artificial intelligence model. High-quality data enables models to make more accurate predictions, and the integration and preprocessing of various data sources may maximize the usefulness of the data.

On the other hand, an unbalanced data problem may lead to reduced prediction accuracy in the artificial intelligence model. Most datasets have an unbalanced state in which the number of certain classes of data is significantly greater or smaller than the number of of other classes, which may lead to a problem where the artificial intelligence model is trained in a biased manner toward the classes that appear more frequently. For example, in business data, positive results (e.g., purchases) often occur relatively less frequently than negative results (e.g., non-purchases). This may lead to the unbalanced data problem and negatively impact the learning and prediction performance of the artificial intelligence model.

Therefore, efficient training of the artificial intelligence model should be considered. Recently, research regarding methods for addressing an unbalanced data problem have been actively progressed.

### SUMMARY

Various embodiments of the present disclosure may provide a prediction system for addressing an unbalanced data problem and being applied universally across various industry fields, and a control method and a learning method of the prediction system.

More specifically, some embodiments of the present disclosure may provide a prediction system for predicting valid customers and formulating optimal business strategies, and a control method and a learning method of the prediction system.

Further, certain embodiments of the present disclosure may provide a learning method of a prediction model configured to predict valid customers by analyzing various customer data.

According to an aspect of the present disclosure, a learning method of a prediction system, performed cooperatively by a memory and at least one processor, may include specifying a train dataset, configuring a plurality of respectively different sub-datasets using the train dataset, training a training target prediction model on each of the respectively different sub-datasets, acquiring, based on the training, a plurality of trained prediction models, each trained on the respectively different sub-datasets, inputting input data to be predicted to each of the plurality of trained prediction models, acquiring a plurality of prediction values for the input data from each of the plurality of trained prediction models, and specifying a final prediction value for the input data using the plurality of prediction values.

In an embodiment, the train dataset may be configured to include a plurality of records having values for the plurality of respectively different categories, and in the configuring of the plurality of respectively different sub-datasets, the plurality of respectively different sub-datasets may be configured based on a value corresponding to a specific category among the plurality of categories.

In an embodiment, the train dataset may include marketing qualified lead (MQL) data configured to have the values for the plurality of respectively different categories, and the specific category may be a category that represents whether a customer's purchase conversion has occurred, and the value corresponding to the specific category may be configured to have a first value or a second value depending on whether the customer's purchase conversion has occurred.

In an embodiment, each of the plurality of trained prediction models may be configured to predict a value for the specific category.

In an embodiment, the learning method may further include performing feature engineering on the train dataset.

In the performing of the feature engineering, a derived category may be generated using at least some of the plurality of categories and values corresponding to the at least some of the plurality of categories, and a value corresponding to the generated derived category may be specified.

In an embodiment, the train dataset may further include the derived category and the value corresponding to the derived category.

In an embodiment, the value corresponding to the specific category may be configured to have a first value or a second value, and in the configuring of the plurality of respectively different sub-datasets, at least some of the plurality of records may be included in each of the plurality of respectively different sub-datasets such that a composition ratio of a first record(s) including the first value for the specific category and a second record(s) including the second value for the specific category among the plurality of records satisfies a preset composition ratio criterion.

In an embodiment, the preset composition ratio criterion may be related to ensuring that each of the plurality of respectively different sub-datasets has an equal ratio of the number of first records including the first value for the specific category and the number of second records including the second value for the specific category.

In an embodiment, the number of respectively different sub-datasets may be determined based on the number of second records including the second value for the specific category and the number of first records including the first value for the specific category among the total number of records included in the train dataset.

In an embodiment, the learning method may further include determining the number of respectively different sub-datasets, and in the determining, the number of respectively different sub-datasets may be determined based on a value obtained by dividing the number of second records including the second value for the specific category by the number of first records including the first value for the specific category.

In an embodiment, each of the plurality of respectively different sub-datasets may include all the first records having the first value for the specific category among the records included in the train dataset, and some of the second records having the second value for the specific category among the records in the train dataset may be included in a number corresponding to the number of first records included in each of the plurality of respectively different sub-datasets.

In an embodiment, all of the plurality of respectively different sub-datasets may each include the same first record, and each of the plurality of respectively different sub-datasets may include respectively different second records.

In an embodiment, the training target prediction model may include a plurality of prediction models based on a gradient boosting decision tree (GBDT) algorithm, and in the training, the plurality of prediction models may each be trained on each of the respectively different sub-datasets, and the plurality of trained prediction models, each trained on the respectively different sub-datasets, may be acquired.

In an embodiment, in the training, as a result of training each of the plurality of prediction models on each of the respectively different sub-datasets, the plurality of trained prediction models may be acquired in a number corresponding to the product of the number N of respectively different sub-datasets and the number M of the plurality of (multiple) prediction models.

In an embodiment, the number of plurality of (multiple) prediction values acquired from the plurality of trained prediction models may correspond to the value obtained by multiplying the number N of respectively different sub-datasets by the number M of plurality of prediction models.

In an embodiment, in the specifying of the final prediction value, soft voting may be performed based on the plurality of prediction values to specify the final prediction value.

According to another aspect of the present disclosure, a method for predicting a valid customer, performed cooperatively by a memory and a processor, may include receiving prediction target customer data to be predicted from a user terminal, inputting the prediction target customer data to each of a plurality of prediction models, each trained on respectviely different sub-datasets split based on purchase customer data in train datasets composed of the purchase customer data and non-purchase customer data, acquiring, as outputs of each of the plurality of prediction models, a plurality of prediction values representing a probability that a customer corresponding to the prediction target customer data is a valid customer, specifying a final prediction value for the prediction target customer data using the plurality of prediction values, and providing, using the specified final prediction value, to the user terminal information as to whether the customer corresponding to the prediction target customer data is the valid customer.

According to another aspect of the present disclosure, there is provided a prediction system including a memory and at least one processor, in which the memory and the processor cooperate to configure a plurality of respectively different sub-datasets using a train dataset, train a training target prediction model on each of the respectively different sub-datasets, acquire, based on the training, a plurality of trained prediction models, each trained on the respectively different sub-datasets, input, to each of the plurality of trained prediction models, input data to be predicted, acquire a plurality of prediction values for the input data from each of the plurality of trained prediction models, and specify a final prediction value for the input data using the plurality of prediction values.

According to another aspect of the present disclosure, there is provided a program stored on a computer-readable medium, executed by one or more processes in an electronic device, in which the program may include instructions to perform specifying a train dataset, configuring a plurality of respectively different sub-datasets using the train dataset, training a training target prediction model on each of the respectively different sub-datasets, acquiring, based on the training, a plurality of trained prediction models, each trained on the respectively different sub-datasets, inputting input data to be predicted to each of the plurality of trained prediction models, acquiring a plurality of prediction values for the input data from each of the plurality of trained prediction models, and specifying a final prediction value for the input data using the plurality of prediction values.

According to another aspect of the present disclosure, a computerized learning method of a prediction system may include specifying a train dataset configured to include a plurality of records having values for a plurality of respectively different categories, classifying each of the plurality of records included in the train dataset based on a value corresponding to a target category among the plurality of categories, configuring a plurality of respectively different sub-datasets based on indexes corresponding to each of the plurality of classified records, and training a training target prediction model on each of the plurality of respectively different sub-datasets.

In an embodiment, the train dataset may include marketing qualified lead (MQL) data configured to have the values for the plurality of respectively different categories, and in the configuring of the plurality of respectively different sub-datasets, the plurality of respectively different sub-datasets having a preset size may be configured based on the indexes corresponding to each of the plurality of records classified based on the value corresponding to the target category.

In an embodiment, in the classifying each of the plurality of records, to configure the plurality of respectively different sub-datasets, each of the plurality of records may be classified based on the values that each of the plurality of records includes for the target category, the target category may be a category that represents whether a customer's purchase conversion has occurred, and the value corresponding to the target category may be configured to have a first value or a second value depending on whether the customer's purchase conversion has occurred.

In an embodiment, in the classifying each of the plurality of records, a record including the first value for the target category, among the plurality of records, may be classified as a first record(s), and a record including the second value for the target category, among the plurality of records, may be classified as a second record(s).

In an embodiment, the indexes corresponding to each of the plurality of classified records may include a first index corresponding to the first record and a second index corresponding to the second record.

In an embodiment, the computerized learning method may further include storing the plurality of classified records and the indexes corresponding to each of the plurality of classified records in a pre-specified storage based on the value corresponding to the target category, in which, in the configuring of the plurality of respectively different sub-datasets, the plurality of respectively different sub-datasets having the preset size may be configured based on the indexes corresponding to each of the plurality of classified records stored in the pre-specified storage.

In an embodiment, the plurality of classified records may include a first record including a first value for the target category and a second record including a second value for the target category, in the storing, the first record and a first index corresponding to the first record and the second record and a second index corresponding to the second record may each be stored in the pre-specified storage, and in the configuring of the plurality of respectively different sub-datasets, the plurality of respectively different sub-datasets having the preset size may be configured based on the first index corresponding to the first record and the second index corresponding to the second record which are stored in the pre-specified storage.

In an embodiment, in the configuring of the plurality of respectively different sub-datasets, at least some of the plurality of classified records to be included in each of the plurality of respectively different sub-datasets may be specified based on the indexes corresponding to each of the plurality of classified records, and at least some of the specified records may be included in each of the plurality of respectively different sub-datasets to configure the plurality of respectively different sub-datasets having the preset size.

In an embodiment, in the configuring of the plurality of respectively different sub-datasets, at least some of the plurality of classified records may be included in each of the plurality of respectively different sub-datasets such that a composition ratio of a first record(s) including the first value for the target category and a second record(s) including the second value for the target category among the plurality of records satisfies a preset composition ratio criterion.

In an embodiment, the preset composition ratio criterion may be related to ensuring that each of the plurality of respectively different sub-datasets has an equal ratio of the number of first records including the first value for the target category and the number of second records including the second value for the target category.

In an embodiment, the number of respectively different sub-datasets may be determined based on the number of second records including the second value for the target category and the number of first records including the first value for the target category among the total number of the plurality of classified records, or may be determined based on the number of second indexes corresponding to the second records and the number of first indexes corresponding to the first records among the total number of the plurality of classified records. In an embodiment, the computerized learning method may further include determining the number of respectively different sub-datasets, in which, in the determining, the number of respectively different sub-datasets may be determined based on a value obtained by dividing the number of second records including the second value for the target category by the number of first records including the first value for the target category, or may be determined based on a value obtained by dividing the number of second indexes corresponding to the second records by the number of first indexes corresponding to the first records.

In an embodiment, the number of respectively different sub-datasets may be determined based on the number of storage servers on which the respectively different sub-datasets are to be stored, and when the number of respectively different sub-datasets is determined based on the number of storage servers, the respectively different sub-datasets may be stored in the storage servers.

In an embodiment, each of the plurality of respectively different sub-datasets may include all the first records having the first value for the target category among the plurality of classified records, and some of the second records having the second value for the target category among the plurality of classified records may be included in a number corresponding to the number of first records included in each of the plurality of respectively different sub-datasets.

In an embodiment, all of the plurality of respectively different sub-datasets may each include the same first record, and each of the plurality of respectively different sub-datasets may include respectively different second records.

In an embodiment, the computerized learning method may further include acquiring, based on the training, each of a plurality of trained prediction models trained on the plurality of respectively different sub-datasets, inputting input data to be predicted to each of the plurality of trained prediction models, acquiring a plurality of prediction values for the input data from each of the plurality of trained prediction models, and specifying a final prediction value for the input data using the plurality of prediction values.

In an embodiment, in the training, the plurality of prediction models may each be trained on each of the plurality of respectively different sub-datasets, and the plurality of trained prediction models, each trained on the plurality of respectively different sub-datasets, may be acquired.

In an embodiment, in the specifying of the final prediction value, soft voting may be performed based on the plurality of prediction values acquired from the plurality of trained prediction models to specify the final prediction value.

According to another aspect of the present disclosure, there is provided a prediction system, including a memory configured to store executable instructions and one or more processors configured to perform an operation by executing one or more instructions, in which the prediction system may include specifying a train dataset configured to include a plurality of records having values for a plurality of respectively different categories, classifying each of the plurality of records included in the train dataset based on a value corresponding to a target category among the plurality of categories, configuring a plurality of respectively different sub-datasets based on indexes corresponding to each of the plurality of classified records, and training a training target prediction model on each of the plurality of respectively different sub-datasets.

According to another aspect of the present disclosure, there is provided a program stored on a computer-readable medium, executed by one or more processes in an electronic device, in which the program may include instructions to perform specifying a train dataset configured to include a plurality of records having values for a plurality of respectively different categories, classifying each of the plurality of records included in the train dataset based on a value corresponding to a target category among the plurality of categories, configuring a plurality of respectively different sub-datasets based on indexes corresponding to each of the plurality of classified records, and training a training target prediction model on each of the plurality of respectively different sub-datasets.

According to another aspect of the present disclosure, a method for predicting a valid customer, performed cooperatively by a memory and a processor, may include receiving customer data of a customer who is a purchase prediction target for a specific product, inputting the customer data related to the specific product to at least one prediction model trained on a plurality of sub-datasets generated using marketing qualified lead (MQL) data, acquiring, as an output of the prediction model, a probability value that the customer is the valid customer, and providing, using the probability value, a prediction result as to whether the customer is a valid customer to purchase the specific product via a service page output on a user terminal.

In an embodiment, the service page may include product information for the specific product and customer information related to the customer, and the customer information may include purchase probability information of the customer as the prediction result.

In an embodiment, when there are multiple customers, the service page may include purchase probability information for the specific product for each of the multiple customers.

In an embodiment, the marketing qualified lead (MQL) data related to the specific product may be composed of purchase customer data and non-purchase customer data for the specific product.

In an embodiment, the plurality of sub-datasets may be generated by splitting the MQL data based on the purchase customer data.

In an embodiment, the plurality of sub-datasets may be configured based on the purchase customer data such that the purchase customer data and the non-purchase customer data satisfy a preset composition ratio criterion.

In an embodiment, the preset composition ratio criterion may be related to ensuring that the number of purchase customer data and the number of non-purchase customer data included in each of the plurality of respectively different sub-datasets have the same ratio.

In an embodiment, the number of the plurality of respectively different sub-datasets may be determined based on the number of purchase customer data and the number of non-purchase customer data among the total number of records included in the MQL data.

In an embodiment, in the inputting of the customer data, the customer data may be input to each of the plurality of prediction models, each trained on the MQL data, and in the acquiring of the probability value, the plurality of prediction values may be acquired from each of the plurality of prediction models, and the plurality of prediction values may be used to specify the probability value that the customer is the valid customer.

In an embodiment, the plurality of prediction models may be configured as a prediction model based on a gradient boosting decision tree (GBDT) algorithm, and the plurality of prediction models may be trained on each of the respectively different sub-datasets.

In an embodiment, in the acquiring of the probability value, soft voting may be performed based on the plurality of prediction values acquired from each of the plurality of prediction models.

In an embodiment, the customer data may include at least one of information related to name, account, contact information, email address, job title, location information, country of affiliation, and affiliated enterprise of a customer.

In an embodiment, the MQL data may be collected from a source based on at least one of a pre-configured database, web crawling, an API, and a pre-linked server.

According to another aspect of the present disclosure, there is provided a system for predicting a valid customer, including a memory and at least one processor, in which the memory and the processor cooperate to receive customer data of a customer who is a purchase prediction target for a specific product, input the customer data related to the specific product to at least one prediction model trained on a plurality of sub-datasets generated using marketing qualified lead (MQL) data, acquire, as an output of the prediction model, a probability value that the customer is the valid customer, and provide, using the probability value, a prediction result as to whether the customer is the valid customer to purchase the specific product via a service page output on a user terminal.

According to another aspect of the present disclosure, there is provided a program stored on a computer-readable medium, executed by one or more processes in an electronic device, in which the program may include instructions to perform receiving customer data of a customer who is a purchase prediction target for a specific product, inputting the customer data related to the specific product to at least one prediction model trained on a plurality of sub-datasets generated using marketing qualified lead (MQL) data, acquiring, as an output of the prediction model, a probability value that the customer is the valid customer, and providing, using the probability value, a prediction result as to whether the customer is a valid customer to purchase the specific product via a service page output on a user terminal.

As described above, according to some embodiments of the present disclosure, a prediction system, a control method thereof, and a learning method of the prediction system according to the present disclosure may provide a prediction model trained on various business data, thereby effectively responding to various sales situations.

In addition, according to certain embodiments of the present disclosure, a prediction system, a control method thereof, and a learning method of the prediction system provide learning on balanced train data by addressing an unbalanced data problem of various business data. In this way, by training the prediction model with the balanced input data, some embodiments of the present disclosure may maintain stable and high prediction performance even with diverse inputs during actual use.

In addition, a prediction system, a control method thereof, and a learning method of the prediction system according to some embodiments of the present disclosure may perform the learning on the balanced business data, thereby addressing the unbalanced data problem in the actual use environment. That is, according to certain embodiments of the present disclosure, by enhancing the generalization performance of the prediction model, it is possible to enable more accurate sales conversion prediction in an actual business environment, efficient allocation of business resources, and formulation of optimized business strategy.

In addition, according to certain embodiments of the present disclosure, a prediction system, its control method, and a learning method of the prediction system according to the present disclosure may provide an automatic computation environment for formulating customized business strategies tailored to customer characteristics by analyzing various customer data. In this way, by allowing the enterprise to flexibly respond to various customer types and market environments, some embodiments of the present disclosure may strengthen long-term relationships with customers and significantly improve the performance of various businesses. In addition, the enterprise may optimize the performance in a global market and develop customized strategies tailored to country-specific characteristics. In other words, according to certain embodiments of the present disclosure, it is possible to provide critical insights for enterprise's strategic decision-making and contribute to enhancing long-term business performance.

Furthermore, according to some embodiments of the present disclosure, a prediction system, its control method, and a learning method of the prediction system may equally split the entire dataset into a predetermined size and construct a plurality of respectively different sub-datasets based on index information. In this way, certain embodiments of the present disclosure can achieve diverse combinational experiments without wasting the storage space and therefore may perform operations with less computation and storage resources. In particular, by constructing sub-datasets to satisfy ratio conditions according to a target class, some embodiments of the present disclosure may effectively alleviate the unbalanced data problem during learning. This can help improve both the accuracy and generalization performance of the prediction model.

Furthermore, according to certain embodiments of the present disclosure, by equally configuring the entire dataset to have a preset size, a prediction system, its control method, and a learning method of the prediction system according to the present disclosure may simultaneously consider data transmission efficiency and storage space utilization. In this way, some embodiments of the present disclosure may enable the parallel learning of the prediction model and shorten the overall learning time.

### BRIEF DESCRIPTION OF DRAWINGS

FIG. 1 is a conceptual diagram for describing a prediction system and a control method thereof according to an embodiment of the present disclosure.

FIGS. 2A and 2B are conceptual diagrams for describing a prediction system according to an embodiment of the present disclosure.

FIG. 3 is a flowchart for describing a learning method of a prediction system according to an embodiment of the present disclosure.

FIGS. 4-9 are conceptual diagrams for describing a learning method of a prediction system according to an embodiment of the present disclosure.

FIG. 10 is a flowchart for describing a method for predicting a valid customer in a prediction system according to an embodiment of the present disclosure.

FIG. 11 is a conceptual diagram for describing a method for predicting a valid customer in a prediction system according to an embodiment of the present disclosure.

FIGS. 12 and 13 are conceptual diagrams for describing a prediction system according to another embodiment of the present disclosure.

FIGS. 14A and 14B are flowcharts for describing a learning method of a prediction system according to another embodiment of the present disclosure.

FIGS. 15A and 15B are conceptual diagrams for describing a train dataset according to another embodiment of the present disclosure.

FIGS. 16A and 16B are conceptual diagrams for describing a method of classifying each of a plurality of records included in a train dataset according to another embodiment of the present disclosure.

FIG. 17 is a conceptual diagram for describing a learning method of a prediction system according to another embodiment of the present disclosure.

FIGS. 18 and 19 are conceptual diagrams for describing a method for efficiently processing data by utilizinga data sequence-based index according to another embodiment of the present disclosure.

### DETAILED DESCRIPTION OF EMBODIMENTS

Hereinafter, embodiments disclosed in the present specification will be described in detail with reference to the accompanying drawings and the same or similar components are given the same reference numerals regardless of the numbers of figures and are not repeatedly described. In addition, terms “module” and “unit” for components used in the following description are used only to easily make the disclosure. Therefore, these terms do not have meanings or roles that distinguish from each other in themselves. Further, when it is determined that a detailed description for the related known art in describing embodiments disclosed in the present specification may obscure the gist of the present disclosure, a detailed description thereof will be omitted. Further, it should be understood that the accompanying drawings are provided only in order to allow embodiments disclosed in the present specification to be easily understood, and the spirit of the present disclosure is not limited by the accompanying drawings, but includes all the modifications, equivalents, and substitutions included in the spirit and the scope of the present disclosure.

Terms including ordinal numbers such as “first”, “second”, etc., may be used to describe various components, but the components are not to be construed as being limited to the terms. The terms are used to distinguish one component from another component.

It is to be understood that when one element is referred to as being “connected to” or “coupled to” another element, it may be connected directly to or coupled directly to another element or be connected to or coupled to another element, having the other element intervening therebetween. On the other hand, it should be understood that when one element is referred to as being “connected directly to” or “coupled directly to” another element, it may be connected to or coupled to another element without the other element interposed therebetween.

Singular expressions are intended to include plural expressions unless the context clearly indicates otherwise.

It will be understood that terms “include”, “have”, or the like used in the present specification specify the presence of features, numerals, steps, operations, components, parts mentioned in the present specification, or combinations thereof, but do not preclude the presence or addition of one or more other features, numerals, steps, operations, components, parts, or combinations thereof.

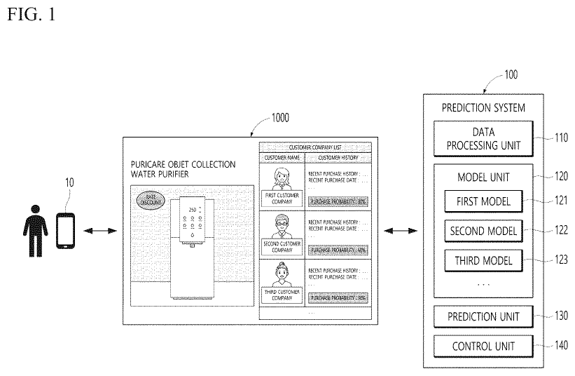

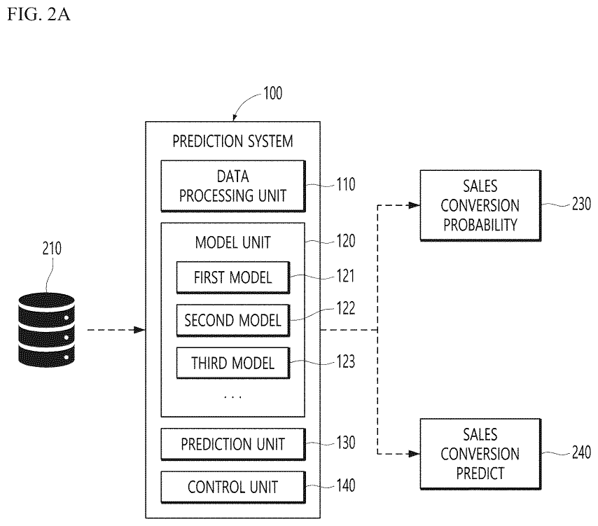

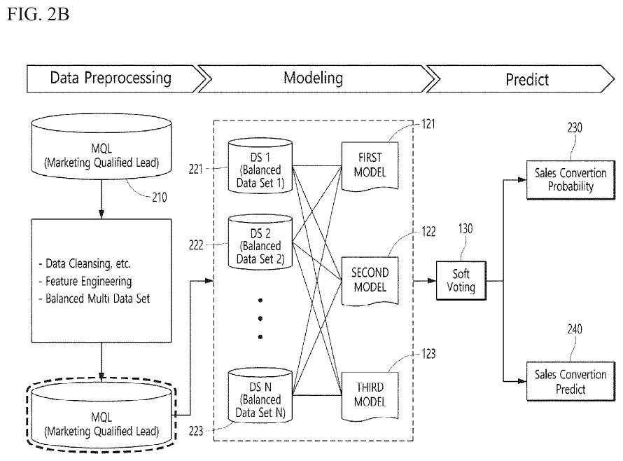

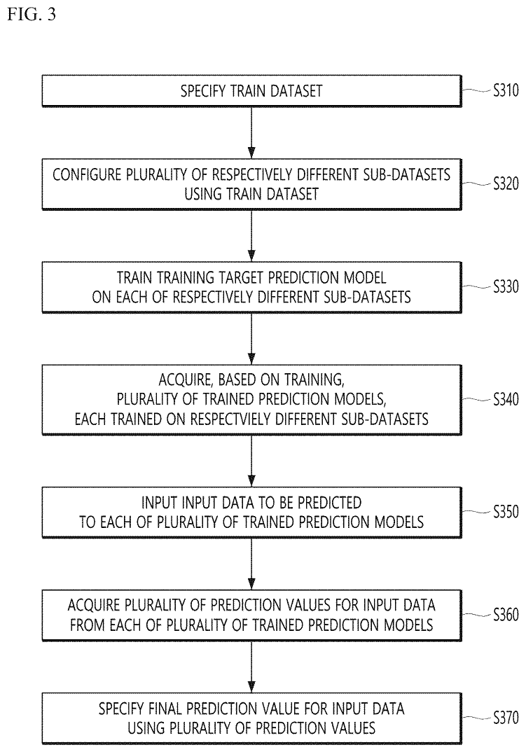

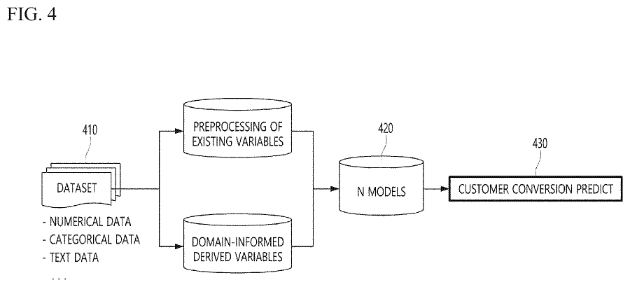

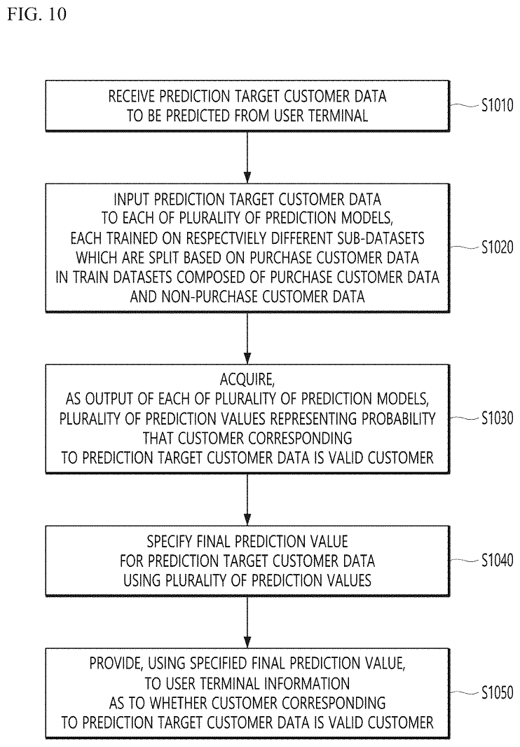

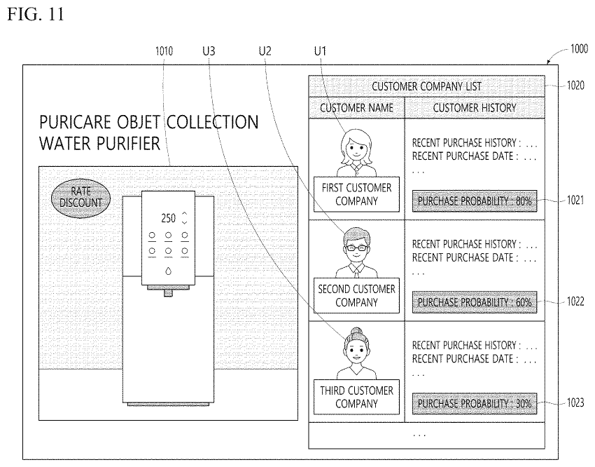

Hereinafter, exemplary embodiments of the present disclosure will be described in more detail with the accompanying drawings. FIG. 1 is a conceptual diagram for describing a prediction system and a control method thereof according to an embodiment of the present disclosure, and FIGS. 2A and 2B are conceptual diagrams for describing a prediction system according to an embodiment of the present disclosure. FIG. 3 is a flowchart for describing a learning method of a prediction system according to an embodiment of the present disclosure, and FIGS. 4-9 are conceptual diagrams for describing a learning method of a prediction system according to an embodiment of the present disclosure. FIG. 10 is a flowchart for describing a method for predicting a valid customer in a prediction system according to an embodiment of the present disclosure, and FIG. 11 is a conceptual diagram for describing a method for predicting a valid customer in a prediction system according to an embodiment of the present disclosure.

A prediction system and a control method thereof, and a learning method of the prediction system according to some embodiments of the present disclosure may be usefully utilized in various environments or situations. For example, a prediction system may be utilized to effectively predict the purchase likelihood of potential customers thereby enabling the generation or formulation of efficient marketing strategies, or to predict the market demand for specific products or services thereby optimizing inventory management and production planning.

In an embodiment of the present disclosure, a prediction system may be useful in business-to-business (B2B) sales situations. Here, the B2B may refer to transactions or commercial activities between enterprises or firms. The B2B may represent a business model in which a specific enterprise provides products (or commodities) or services to other enterprises. For example, the B2B transaction may include providing software solutions from a software enterprise to other enterprises, or supplying components from component manufacturers to other enterprises. In other words, unlike business-to-consumer (B2C) which targets consumers, the B2B focuses on the relationships between enterprises.

Furthermore, a prediction system and control method thereof, and a learning method of the prediction system according to certain embodiments of the present disclosure may be applied to and utilized effectively in various industries and services. For example, a learning method of a prediction system according to the present disclosure may be applied to a prediction model which may be utilized in the healthcare industry to diagnose rare diseases, the financial industry to detect fraudulent transactions, or the security industry to quickly detect and respond to security threats.

In the present disclosure, the use or intended purpose of a prediction system is described as being related to the B2B and/or B2C sales, but is not necessarily limited thereto. For example, a prediction system according to the present disclosure may be applied to and utilized effectively in various industry fields, such as healthcare, finance, and security, as described above. Furthermore, in the present disclosure, the term “customer” may be used interchangeably with “customer company”.

A prediction system and a control method thereof according to an embodiment of the present disclosure will be described with reference to FIG. 1. As illustrated in FIG. 1, a prediction system 100 according to an embodiment of the present disclosure may include at least one of a data processing unit or a data processor 110, a model unit 120, a prediction unit 130, or a control unit or a controller 140.

The prediction system 100 or one or more units or components comprised in the prediction system 100 may be implemented as one or more processors. The processors may include one or more general-purpose processors and/or one or more special-purpose processors (e.g., a digital signal processor, a tensor processing unit (TPU), a graphics processing unit (GPU), a neural network processing unit (NPU), an application-specific integrated circuit (ASIC), etc.). One or more processors may be configured to execute instructions stored or included in memory, computer-readable instructions, and/or other instructions described herein. Such a prediction system and method may perform data processing to be described below in association with a memory and at least one processor. The processor may perform a series of operations and data processing using data and information stored in the memory.

The data processing unit or data processor 110 may be configured to collect data from various sources (e.g., a database, web crawling, an API, a server communicationally connected or linked to the prediction system 100, an external server, etc.) and perform pre-processing on the collected data.

The data processing unit 110 may collect various data used for training at least one of models 121, 122, and 123 included in the model unit 120. For example, as illustrated in FIGS. 2A and 2B, the data processing unit 110 may collect marketing qualified lead (MQL) data 210 configured to have values for a plurality of respectively different categories from various sources.

For example, the MQL data may be information on or about potential customers (e.g., customer companies) selected through marketing activities. The MQL data may be data which may be used to identify potential customers who have shown interest in products or services or are likely to purchase products or services. The MQL data may include various elements related to records and/or behaviors representing a customer's interest in products or services. For example, the various elements may include at least one of customer information such as information about a customer company (e.g., name, account (or customer identification number or code), contact information, email address, job title, location information, country of affiliation, affiliated enterprise (or firm) of a customer, etc.), information on an affiliated enterprise of a customer, a type and/or category of products (e.g., enterprise's name, industry, size, etc.) or services that the customer has shown interest in, a customer's event history (e.g., website visit record (or number of visits) of a customer, purchase history of a customer, product page views, product inquiry, survey response, etc.), and information related to a customer's purchase intention (e.g., information such as expected budget, expected time of purchase.).

However, the collected data is not necessarily limited to the examples described above. In an embodiment, in addition to the MQL data 210, the data processing unit 110 may collect at least one of product data (e.g., product identification information (e.g., a product code), product name and description, product price, inventory status, product category, product ratings and reviews, product launch date, product specifications and features, etc.), sales process data (e.g., lead information, sales representative information, sales opportunity information, sales activity records, sales stages, contract information, performance indicators, etc.), and market trend data (e.g., market research reports, competitor information, industry trends, consumer behavior, economic indicators, technology trends, regional-specific or national-specific characteristics and regulatory information, etc.). For convenience of description, the collected data will be referred to as a “train dataset” or a “training dataset” (e.g. “train data 400”).

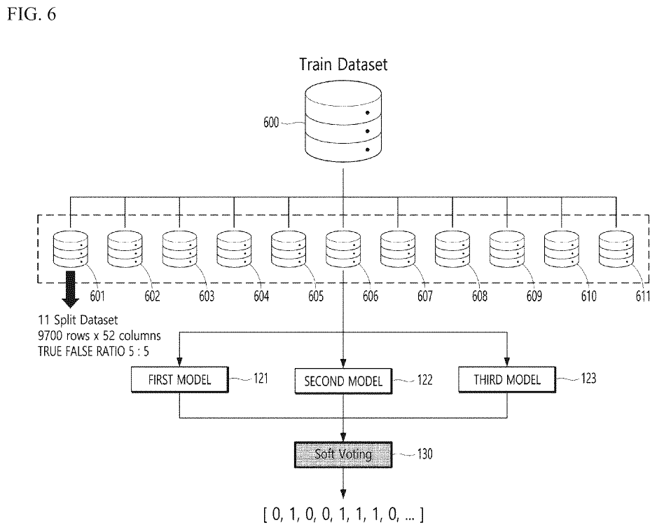

Meanwhile, the data processing unit 110 may perform pre-processing on the train dataset 410 of FIG. 4 or 600 of FIG. 6.

The data processing unit 110 may cleanse the train dataset 410, 600 to handle errors or missing values in the train dataset 410, 600 and detect (or identify) and remove abnormal values or duplicate records (or data) in the train dataset 410, 600. For example, the data processing unit 110 may replace the missing values with an average value or delete the missing values in the train dataset 410, 600 and detect and remove the abnormal values (e.g., outliers) which are abnormally large or small and the duplicate records in the train dataset 410, 600.

In addition, when the train dataset 410, 600 includes categorical data (or variables), the data processing unit 110 may convert the categorical data into a numerical form understandable by an artificial intelligence (AI) model. For example, the data processing unit 110 may convert the categorical data into a multidimensional vector using at least one of one-hot encoding and/or label encoding.

In addition, the data processing unit 110 may adjust the range of numerical data (or continuous data) so that all variables have the same range. For example, the data processing unit 110 may convert the numerical data into data with a mean of 0 and a variance of 1 through normalization (e.g., Z-score normalization) for the numerical data, or convert continuous data into data with a range between 0 and 1 through scaling (e.g., min-max scaling) for the continuous data. This may be understood as data processing to prevent the results from being distorted by the size of a specific variable during AI model training or to prevent the AI model from being biased toward specific features.

Furthermore, the data processing unit 110 may expand (or augment) the data from which the AI model may learn by generating new variables (or derived variables) from the train dataset 410, 600 through feature engineering for the train dataset 410, 600 in which the existing variables have been pre-processed.

In this case, the data processing unit 110 may generate the derived variables (or derived categories) from the train dataset 410, 600 based on recency-frequency-monetary (RFM) analysis during the feature engineering process.

The RFM analysis is a marketing method used to evaluate and classify customers, and may include recency, frequency, and monetary. Here, the recency may refer to the time from a customer's most recent time of purchase to the present, the frequency may refer to the number of times of purchase made by a customer over a certain period or a predetermined period, and the monetary may refer to the total amount that a customer has spent over a certain period or a preset period.

In an embodiment, the data processing unit 110 may extract specific data (or variables) (for example, sales representative (e.g., “lead_owner”), customer's identification information (e.g., “customer_idx”), etc.) with high feature importance from the train dataset 410, 600 based on the RFM analysis, and generate derived variables (for example, variables representing a representative's experience level or frequency (e.g., “lead_owner_job”), variables representing whether and how often a customer makes repeat purchases (e.g., “customer_idx_count”), variables in which a sales representative's experience and a customer's revisit frequency are combined (e.g., “oppty”), etc.) for the extracted specific data.

In another embodiment, the data processing unit 110 may separate year and month information using date data (e.g., “lead_date”) included in the train dataset 410, 600, and generate derived variables (e.g., “lead_date_yearmonth”) that include the customer's recent purchase activity.

Meanwhile, the data processing unit 110 may use the train dataset 410, 600 to configure at least one sub-dataset.

For example, the train dataset 410, 600 may be in an unbalanced state where data including a specific value is significantly greater or less than data including another value, which may lead to problems in which the AI model may be biased toward frequently occurring classes. For example, in the MQL data, data including values corresponding to a case where a customer's purchase conversion has occurred may occur relatively less frequently than data including values corresponding to a case where the customer's purchase conversion has not occurred. This may lead to the unbalanced data problem and negatively impact the learning and prediction performance of the artificial intelligence model.

To address the problem of the unbalanced data, the data processing unit 110 may configure a plurality of respectively different sub-datasets such that a composition ratio of a plurality of records each including the respectively different values for a specific category among a plurality of data (or records) included in the train dataset 410, 600 satisfies a preset composition ratio criterion. More specific description thereof will be described below.

The model unit 120 may include at least one training target prediction model. For example, the model unit 120 may include at least one of a first model 121, a second model 122, and a third model 123 which are a training target.

For instance, the first model 121 may be referred to as a “CatBoost model” and may be a model specialized for processing categorical data (or variables or features). The first model 121 may use a regularization technique or method called “Ordered Target Statistics” and/or “Ordered Boosting” to prevent a target leakage problem that may occur in the categorical data. In addition, the first model 121 may use a symmetric tree structure to distribute balanced data at each level of a tree. This first model 121 may prevent overfitting and achieve high prediction performance.

The second model 122 may be referred to as a “LightGBM (LGBM) model”, and may be a model that uses “gradient-based one-side sampling (GOSS)” and/or “exclusive feature bundling (EFB)” methods to maximize a training speed, maintain high prediction performance, and reduce memory usage. The gradient-based one-side sampling (GOSS) may reduce computational complexity by sampling data based on the magnitude of the gradient, while the exclusive feature bundling (EFB) reduces the number of variables by bundling rare features. Furthermore, the second model 122 may use a leaf-wise tree growth scheme to learn deeply about specific portions of data and better identify complex data patterns.

The third model 123 may be referred to as a “XGBoost model”, and may be a gradient boosting decision tree (GBDT) algorithm-based model which is optimized for high prediction performance and overfitting prevention. The third model 123 may use normalization to prevent the overfitting and tree pruning to reduce model complexity by removing unnecessary branches. The third model 123 provides flexibility in handling missing values, and may use the level-wise tree growth scheme to equally split all nodes, thereby performing extensive training to effectively reflect diverse characteristics.

The first model 121, the second model 122, and the third model 123 may be a gradient boosting decision tree (GBDT) algorithm-based model, and may split data and perform training based on the decision tree.

However, one or more models included in the model unit 120 according to an embodiment of the present disclosure are not necessarily limited to the examples of the models described above, and may include various models. The model unit 120 according to an embodiment of the present disclosure may a single model or a plurality of models, and the number of the models included in the model unit 120 may be varied.

Meanwhile, a plurality of sub-datasets 221, 222, and 223 generated from the data processing unit 110 may be input to each of the first, second, and third models 121, 122, and 123 included in the model unit 120. Each of the plurality of models 121, 122, and 123 may receive a plurality of sub-datasets 221, 222, and 223 as input and perform training on each of the plurality of sub-datasets 221, 222, and 223.

Specifically, the first model 121, the second model 122, and the third model 123 independently perform training on each of the plurality of sub-datasets 221, 222, and 223, and when the training of each model 121, 122, and 123 is completed, a plurality of trained prediction models may be acquired.

Here, the term of the “plurality of trained prediction models” may refer to the trained prediction models corresponding to the product of the number “N” of the plurality of respectively different sub-datasets and the number “M” of the plurality of prediction models 121, 122, and 123, as a result of training each of the plurality of prediction models 121, 122, and 123 on each of the plurality of sub-datasets 221, 222, and 223.

That is, when the training of each of the plurality of prediction models 121, 122, and 123 on each of the N respectively different sub-datasets is completed, each of the plurality of prediction models 121, 122, and 123 may include the plurality of trained prediction models trained on each of the N sub-datasets. In the present disclosure, the prediction model may also be referred to as a “binary classification model” or a BalancedTreeMarketer model.

The prediction unit 130 may be configured to specify a final prediction result (e.g., a final prediction value) using output values of at least one trained prediction model (e.g., N trained models).

Specifically, the prediction unit 130 may perform soft voting based on the plurality of prediction values output from each of the plurality of trained prediction models to determine or specify a final prediction value.

In an embodiment, the prediction unit 130 may calculate (or produce) an averaged probability (e.g., “sales conversion probability” 230) based on the soft voting, by averaging a plurality of prediction values (or prediction probabilities) independently predicted by each of the plurality of trained prediction models, and determine or specify a final prediction value (e.g., “sales conversion predict”, or customer conversion, 240) based on the calculated probability 230.

Here, the soft voting is one of ensemble techniques, and may determine a final prediction by combining (e.g. averaging) results (e.g., probabilities) independently predicted by each of a plurality of AI models. That is, the prediction unit 130 may determine or specify the final prediction result (or a prediction value) by combining the result values (or prediction values) from each of the plurality of trained prediction models.

In addition, the averaged probability is a result of synthesizing the prediction values output by the trained prediction models, and may be understood as representing, as a probability value, the likelihood (purchase conversion probability) that a customer will purchase a product or service. For example, the prediction unit 130 may express the probability value as a value between 0 and 1. In this example, a value of 0.7 may indicate that a customer has a 70% likelihood of purchasing a product.

Furthermore, the final prediction value 240 is the finally extracted prediction result, and may be, for instance, but not limited to, a binary classification representing whether a customer will purchase a product or service. For example, the prediction unit 130 may indicate “purchased (1)” when a customer is predicted to purchase a product, and “not purchased (0)” when a customer is predicted not to purchase a product.

For instance, the prediction unit 130 may compare the averaged probability 230 with a preset threshold value, and when the averaged probability 230 exceeds the preset threshold value, determine or specify the final prediction value 240 as “purchased (1)”, and when the averaged probability 230 does not exceed the threshold value, determine or specify the final prediction value 240 as “not purchased (0)”. More specific description thereof will be described below.

The control unit or controller 140 may be configured to control the overall operation of the prediction system 100. The control unit 140 may process signals, data, information, etc., input or output through the components described above, or may perform a series of data processing to provide or process appropriate information and functions to a user.

In an embodiment, the control unit 140 may provide a service page 1000 to a user terminal 10. The service page 1000 may provide a list of at least one enterprise (or a list of at least one customer company) that interacts (e.g., transactions, collaborations, etc.) with a specific enterprise. In this example, the control unit 140 may provide, in one area of the service page 1000, information on a purchase probability of each customer company for a specific product (e.g., “PuriCare Objet Collection Water Purifier”) sold by a specific enterprise, as predicted by the prediction system 100.

Some embodiments of the present disclosure may provide a prediction system which may address an unbalanced data problem and be applied universally across various industry fields, a control method of the prediction system, and a learning method of the prediction system. More specifically, certain embodiments of the present disclosure may provide a prediction system capable of predicting valid customers by analyzing various customer data. Hereinafter, a learning method of a prediction system or a prediction model will be described in more detail.

First, at step S310 of FIG. 3, a process of specifying a train dataset may be performed.

The control unit 140 may specify a train dataset to be used for training a training target prediction model.

The criteria for specifying the train dataset may vary. The control unit 140 may specify the train dataset to be used for training the training target prediction model based on various criteria.

In an embodiment, the control unit 140 may collect (or receive) a dataset from at least one of various sources (e.g., a database (DB), web crawling, an API, a server communicationally connected or linked to the prediction system 100, an external server, etc.) and specify the collected dataset as the train dataset to be used for training the training target prediction model.

In another embodiment, the control unit 140 may specify a dataset stored in at least one of various storages (e.g., a storage unit, memory, a database (DB), etc.) as the train dataset to be used for training the training target prediction model.

The train dataset may include various data. For example, as illustrated in FIG. 4, a train dataset 410 may include at least one of MQL data, product data, sales process data, and market trend data. The data included in the train dataset may comprise at least one of the following forms: numerical data, categorical data, and text data. However, the form of the data included in the train dataset is not necessarily limited to the examples described above, and the train dataset may include data in various other forms as well.

The train dataset 410 may be configured to include a plurality of records having values for a plurality of respectively different categories.

Here, the record represents at least one data unit, and may include data values (e.g., multiple fields or attributes, etc.) for a plurality of categories. In a database, the record may also be referred to as a “row”. For example, in an Excel spreadsheet, each row represents one record, and each column may represent data values for various categories within the record.

That is, each piece of data included in one dataset, or a single data unit including data values for a plurality of categories, may be referred to as a “record” or a “sample”.

The train dataset 410 may include the MQL data configured to have the values for the plurality of respectively different categories. Furthermore, in the present disclosure, the categories may also be referred to as “features”, “variables”, or “elements”.

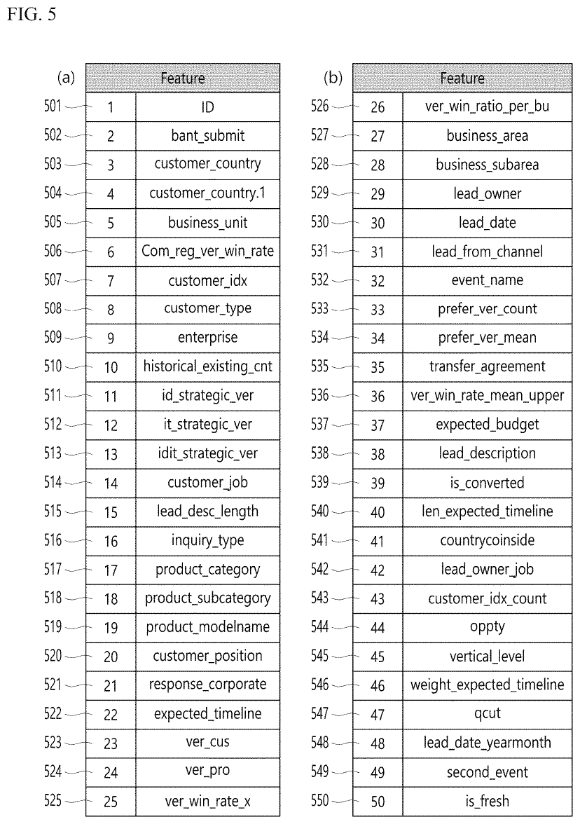

Before describing a process for pre-processing the train dataset 410, the plurality of categories and the values for those categories included in the train dataset 410 will be described with reference to FIG. 5.

A first category (i.e., “ID” 501) is an arbitrary value that uniquely identifies each data entry, and a primary purpose of the first category may be to calculate an f1 score by comparing the first category with a thirty-ninth category (i.e., “is_converted” 539). Through the first category 501, each prediction result may be matched with the actual result to measure the accuracy, and the first category 501 may also be utilized for evaluating the model performance.

A second category (i.e., “bant_submit” 502) is a variation of a budget, authority, need, and timeline (BANT) framework, and may be used to evaluate MQL quality. For instance, the “budget” may mean customer's budget information, which represents the funds that may be allocated to a project or purchase. The “authority” may mean a customer's position, rank, or title which represents whether a person has decision-making authority. In addition, the “need” may mean customer's specific requirements, customer's problems or goals that a product or service should address, and the “timeline” may mean a customer's requested due date.

A third category (i.e., “customer_country” 503) represents customer's nationality, and a value or characters may correspond to or represent “region/country (e.g., Asia/Korea)”. The third category 503 may provide key information for regional business strategies, localized service provision, approaches based on legal and cultural understanding, etc. In addition, the third category 503 may be utilized to develop strategies that take into account time differences, language barriers, cultural differences, and the like that may arise in international business relationships.

A fourth category (i.e., “customer_country.1” 504) may refer to a region or country, such as a corporate region of a responsible company.

A fifth category (i.e., “business_unit” 505) may be a business unit within a company corresponding to a product or service requested in the MQL, and may be divided into a plurality of categories (e.g., five categories including ID, AS, IT, Solution, CM). These categories may be important for understanding the nature of leads and assigning an appropriate sales team or expert, and may be utilized for performance analysis, resource allocation, strategy formulation, etc., for each business unit.

A sixth category (i.e., “com_reg_ver_win_rate” 506) is a weight obtained by calculating an opportunity (oppty) ratio based on a specific business area (vertical level 1), a specific business unit or business division, or region, and may be used to predict a future success likelihood based on a past success rate.

A seventh category (i.e., “customer_idx” 507) may store a customer company name and the number of times that a customer company submits data to indirectly show the customer company's level of engagement or interest. A high value represents that the company frequently makes an inquiry or performs interaction, which may indicate a high level of interest or purchase intention. For example, the seventh category 507 may be used for customer segmentation, prioritization, the formulation of customized marketing strategies, etc.

An eighth category (i.e., “customer_type” 508) may data that classifies a customer's occupation, and may be useful for formulating targeted marketing or customized business strategies.

A ninth category (i.e., “enterprise” 509) may represent a size of a customer company, and may be divided into enterprise and small and medium business (SMB).

A tenth category (i.e., “historical_existing_cnt” 510) may mean the number of times that a customer or firm was successfully converted into a sale in the past. The tenth category 510 may be useful for evaluating customer loyalty or the likelihood of repeat purchases. A high value represents a strong business relationship with the corresponding customer and may be understood as a high likelihood of future transactions.

A eleventh category (i.e., “id_strategic_ver” 511) may include a weight representing the strategic importance of a combination of a specific business unit (BU) and a specific business area (vertical level 1). The eleventh category 511 may be utilized to optimize resource allocation by reflecting the company's strategic priorities and to increase a concentration level in specific business areas.

Similarly to the eleventh category 511, a twelveth category (i.e., “it_strategic_ver” 512) may include a weight representing the strategic importance of a combination of a specific business unit and a specific business area (vertical level 1). The weight is a weight for a specific business unit (e.g., IT business unit), so the efficient technical personnel allocation and planning may be established.

A thirteenth category (i.e., “idit_strategic_ver” 513) may include a composite indicator that integrates the eleventh category 511 and the twelveth category 512. When at least one of the eleventh category 511 and/or the twelveth category 512 has a value of 1, the thirteenth category 513 may be assigned a weight of 1. The thirteenth category 513 provides an integrated strategic importance encompassing ID and IT areas and may be utilized as a consideration factor in determining company-wide resource allocation.

A fourteenth category (e.g., “customer_job” 514) may include categorical data representing occupational groups. Through the fourtheenth category 514, a communication method considering the characteristics of each occupation may be adopted, and the customer grouping may be achieved based on the occupation.

A fifteenth category (e.g., “lead_desc_length” 515) may include the total length of lead description text written by a customer. The fifteenth category may indirectly represent the customer's level of interest or engagement and reflect the complexity of the customer's requirements or issues.

A sixteenth category (e.g., “inquiry_type” 516) may include information classifying a type of customer inquiry. For example, the sixteenth category 516 may be divided into a plurality of various categories (e.g., 71) including product information inquiries, purchase consultations, quotation requests, etc. Through this, the sixteenth category may be used to understand the customer's purchasing stage and serve as an important factor in formulating the marketing strategies. In addition, the sixteenth category 516 may assist in sales conversion by assigning an appropriate department or representative based on the inquiry type.

A seventeenth category (e.g., “product_category” 517) may include a parent category of a requested product. For example, the seventeenth category 517 may be divided into a plurality of categories (e.g., 357) including tablets, TVs, washing machines, refrigerators, etc. Through this, it is possible to develop the marketing strategies focused on the customer's desired categories.

A eighteenth category (e.g., “product_subcategory” 518) may include classification of more detailed subcategories of a requested product. For example, the eighteenth category 518 may be divided into a plurality of subcategories (e.g., 330), such as OLED, QLED, and 8K TVs, and thus, may include a more detailed product classification system. Through this, it is possible to identify precise customer needs and provide more segmented marketing.

A ninteenth category (e.g., “product_modelname” 519) may include a model name of a specific product requested by a customer. For example, since the customer provides very specific information, it is possible to accurately understand the customer's interest. Based on the model name of the specific product, it is possible to create customized proposals and develop personalized sales approaches. As a result, it is possible to increase the customer satisfaction and improve the sales conversion rate.

A twentieth category (e.g., “customer_position” 520) may include a customer's position within a company who made an inquiry. Through this, it is possible to understand the customer's level of authority in purchasing decisions. In addition, the twentieth category 520 may be a key element in formulating differentiated sales and marketing strategies based on the position.

A twenty-first category (e.g., ‘response_corporate’ 521) may include data of a string type that represents a corporate name of a company responsible for handling customer inquiries or transactions. The twenty-first category 521 may play a crucial role in an enterprise structure with multiple subsidiaries. By identifying which corporate is primarily involved in customer interactions or sales processes through the twenty-first category 521, it is possible to clarify responsibilities among internal organizations and maintain consistency in customer management. In addition, through the twenty-first category 521, it is possible to acquire insights necessary for performance analysis by each corporate, optimization of resource allocation, and formulation of company-wide sales strategies.

A twenty-second category (e.g., “expected_timeline” 522) may include a deadline for completing a task requested by a customer. The twenty-second category may be utilized as an important indicator in a prediction model. This is because a customer presenting a specific schedule can be a signal of strong purchase intention. In addition, the likelihood and speed of a transaction may be estimated based on the urgency of the twenty-second category 522. For example, a short deadline may imply the quick decision-making and high conversion rate, while a long deadline may mean a larger-scale transaction or complex decision-making process. Effectively utilizing the twenty-second category 522 may help optimize resource allocation by a sales team and develop customized customer approach strategies. In other words, the twenty-second category 522 may be a factor contributing to an increase in B2B sales conversion rate.

A twenty-third category (e.g., “ver_cus” 523) may be a category in which the impact of a combination of a specific business area and a customer type on sales conversion is quantified in the B2B sales. A weight of 1 may be assigned when a business belongs to a specific business area and at the same time, a customer type is an end consumer. Through this, it is possible to evaluate the likelihood of success in sales targeting a direct end user in a specific business area. The twenty-third category 523 reflects the importance of customer segmentation in the B2B sales strategies and may help identify a business area where an end-user-centric approach may be more effective.

A twenty-fourth category (e.g., “ver_pro” 524) may be a category that assigns a weight to a combination of a specific business area (vertical level 1) and a product type (product category). The twenty-fourth category 524 may be used to understand whether a specific product type has a higher sales conversion rate in a specific business area. The combination having the weight of 1 may mean that the product type has competitiveness and high demand in the corresponding business area. Through the twenty-fourth category 524, it is possible to understand the product groups to be prioritized in each business area and develop the customized business strategies.

A twenty-fifth category (e.g., “ver_win_rate_x” 525) may be a composite weight category that simultaneously considers the relative importance and success rate of each vertical. The twenty-fifth category is produced by multiplying the proportion occupied by the corresponding vertical among all leads by the sales conversion success rate within the vertical. The twenty-fifth category 525 enables a more balanced evaluation by considering not only the success rate but also the overall proportion of the corresponding vertical. Through this, it is possible to understand the actual importance of each vertical when allocating sales resources and formulating strategies.

A twenty-sixth category (e.g., “ver_win_ratio_per_bu” 526) may be a category that represents a sales conversion success rate for each business unit (or business division) within a specific business area. This may show how effectively each business unit is performing a business in a specific vertical. Through the twenty-sixth category 526, it is possible to identify which specific business unit is achieving the highest performance in each vertical, which may be utilized for optimal process sharing and resource allocation optimization within an organization. In addition, the twenty-sixth category 526 may be used to develop the customized sales strategies that leverage the strengths of each business unit.

A twenty-seventh category (e.g., “business_area” 527) may be a category that represents a main business area of a customer company. The twenty-seventh category 527 may be used to predict the B2B sales conversion rate. By understanding the business area of the customer company through the twenty-seventh category 527, it is possible to develop a customized approach strategy specialized for the corresponding business sector. In addition, through the twenty-seventh category 527, past success patterns in a specific business area may be analyzed to optimize sales strategies for new customer companies in similar business sectors. Through this, it is possible to promote the efficient allocation of sales resources and improve the conversion rate.

A twenty-eighth category (e.g., “business_subarea” 528) may include classification of a more detailed business area of a customer company. The twenty-eighth category 528 may help more accurately understand specific needs or requirements of a customer company. Utilizing the twenty-eighth category 528 in a prediction model may enable highly segmented market approach. Based on the twenty-eighth category 528, it is possible to develop the more sophisticated sales strategies and increase the conversion rate.

A twenty-ninth category (e.g., “lead_owner” 529) may be a category that represents a name of a sales representative responsible for each salesopportunity. The twenty-ninth category 529 may be used to analyze individual and team performance in a prediction model. In addition, through the twenty-ninth category 529, it is possible to identify the impact of a specific representative's sales skills, experience, or expertise in a specific business sector on the conversion rate. Furthermore, through the twenty-ninth category 529, by formulating the optimal lead allocation strategy and analyzing the collaboration patterns among team members, it is possible to improve the overall sales performance.

A thirtieth category (e.g., “lead_date” 530) may be a category that represents the date when the sales opportunity (lead) is first created. The thirtieth category 530 may be used to consider temporal factors in a prediction model. In addition, through the thirtieth category 530, it is possible to analyze the time required from lead generation to actual transaction closure, seasonal trends, changes in performance over a specific period, etc. Furthermore, through the thirtieth category 530, it is possible to understand the impact of lead recency on the conversion rate and develop timely and effective follow-up strategies. And, through this, it is possible to optimize the sales cycle and increase conversion rate.

A thirty-first category (e.g., “lead_from_channel” 531) may be a category that represents a marketing channel from which business opportunity information is collected. The thirty-first category 531 may be used to evaluate the effectiveness of each marketing channel in a prediction model. By analyzing the quality and conversion rate of the leads flowing in through a specific channel based on the thirty-first category 531, it is possible to identify the most effective marketing channel. In addition, based on the thirty-first category 531, it is possible to optimize the marketing budget allocation and develop the customized sales strategies for each channel. As a result, it is possible to improve the quality of leads and increase the overall sales conversion rates.

A thirty-second category (e.g., “event_name” 532) may be a category that represents a name of a specific marketing event in which a sales activity has been conducted. The thirty-second category 532 may be used to evaluate the effectiveness of each marketing event in a prediction model. By analyzing the quality and conversion rate of the leads generated through a specific event based on the thirty-second category 532, it is possible to identify the most successful event type. In addition, the future marketing event planning and resource allocation may be optimized, and the customized follow-up sales strategies tailored to the characteristics of each event may developed based on the thirty-second category 532. As a result, it is possible to improve the event ROI and increase the overall sales conversion rate.

A thirty-third category (e.g., ‘prefer_ver_count’ 533) may be a category that represents a distribution ratio of converted cases of a specific business unit in a specific business area. The thirty-third category 533 may be used to understand the fields of strength of each business unit in a prediction model. By analyzing, based on the thirty-third category 533, verticals associated with a given business unit that show relatively high success rates, an effective target market for each business unit may be determined. Through this, it is possible to develop specialized strategies for each business unit. As a result, it is possible to maximize the strengths of each business unit to improve the overall sales conversion rate.

A thirty-fourth category (e.g., “prefer_ver_mean” 534) is calculated based on criteria similar to those of the thirty-third category 533. The thirty-fourth category may be a category that represents a ratio of profit values instead of a simple sample count. The thirty-fourth category 534 is used to understand the fields of strength of each business unit in terms of profitability in a prediction model. By analyzing which vertical of a given business unit generates high profits, a strategy that takes into account the actual contribution to revenue rather than merely the number of successful cases can be developed. Through this, it is possible to conduct the intensive sales activities for the high-profit verticals and improve the overall sales profitability.

A thirty-fifth category (e.g., “transfer_agreement” 535) may be a category that represents whether a customer has consented to the export of the customer's lead information overseas. The thirty-fifth category 535 may be used to evaluate a customer's possibility, openness and likelihood of global collaboration in a prediction model. For instance, a customer who consents to the export of the information is more likely to be interested in a broader range of services or global solutions. Based on the thirty-fifth category 535, customized suggestions may be made for products or services requiring international collaboration, and may be utilized in formulating global business strategies.

A thirty-sixth category (e.g., ‘ver_win_rate_mean_upper’ 536) may be a category in which a value is expressed as 1 if the value exceeds an average value of each vertical, and 0 otherwise. The thirty-sixth category 536 may be used to evaluate relative performance within each vertical in a prediction model. By analyzing the characteristics of cases that achieve above-average performance based on the thirty-sixth category 536, key factors of successful sales strategies may be identified. Through this, by applying the best practices to other cases, it is possible to improve the overall sales performance.

A thirty-seventh category (e.g., “expected_budget” 537) may be a category that represents a customer's desired budget range. The thirty-seventh category 537 may be an important indicator for evaluating a customer's purchasing intention and project scale in a prediction model. Based on the thirty-seventh category 537, appropriate products or services may be proposed based on budget size, and customized solutions may be developed to meet customers' financial expectations. In addition, based on the thirty-seventh category 537, it is possible to identify the optimal target segment through the analysis of conversion rates for each budget range, and improve the overall sales performance by optimizing the resource allocation. In particular, the thirty-seventh category 537 may be a category that is responsible for money when applying a traditional RFM model.

A thirty-eighth category (e.g., “lead_description” 538) may be a category that includes requirements directly written by a customer. The thirty-eighth category 538 may be used to understand the customer's specific needs and interests in a prediction model. By analyzing the thirty-eighth category 538 using text mining and natural language processing (NLP), the customer's potential needs and preferences may be identified. Based on the thirty-eighth category 538, it is possible to write customized proposals and develop personalized sales approaches. As a result, it is possible to increase the customer satisfaction and improve the sales conversion rate.

A thirty-ninth category (e.g., “is_converted” 539) is a core category that represents a final result of a sales activity, and may represent whether sales success is achieved or not using a binary value (e.g., 1: success, 0: failure). The thirty-ninth category may be a target category (or specific category) to be ultimately predicted in a prediction model. Based on the thirty-ninth category 539, it is possible to analyze the impact of various categories and understand the characteristics of successful sales cases. In addition, through the thirty-ninth category 539, it is possible to evaluate the prediction accuracy of the prediction model and perform the continuous model improvement and optimization. As a result, by accurately predicting the thirty-ninth category 539 to support the efficient resource allocation and strategic decision-making, it is possible to improve the overall B2B sales performance.

A fortieth category (e.g., “len_expected_timeline” 540) may be a derived category generated during the pre-processing of the twenty-second category 522. Based on the fortieth category 540, it is possible to address the data inconsistency issue in the twenty-second category 522.

A forty-first category (e.g., “countrycoinside” 541) may be a derived category that represents whether a customer's nationality and regional information (continent) based on a corporate name of a responsible company are identical to each other. Based on the forty-first category 541, it is possible to develop a sales strategy considering regional characteristics.

A forty-second category (e.g., “lead_owner_job” 542) may be a derived category that is generated from the twenty-ninth category 529 to quantify the experience and proficiency of a sales representative in the B2B sales environment. The frequency of the sales representative appearing in the dataset is counted, and the higher the frequency, the more sale cases handled by the sales representative. Based on the forty-second category 542, an experienced representative may be assigned to important leads or complex cases to optimize the resource allocation, thereby ultimately increasing the customer satisfaction and sales conversion rate.

A forty-third category (e.g., “customer_idx_count” 543) may be a key indicator (or derived category) that represents customer loyalty and purchase intention. The number of appearances of each customer in the seventh category 507 is counted, and a high appearance count may mean that the customer has frequently made inquiries for transactions. This represents a continuing interest in products or services and may reflect the strength of potential purchase intention. Through the forty-third category 543, it is possible to determine a key target for establishing long-term business relationships, and it may be understood that the key target is highly likely to purchase various company products in the future.

A forty-fourth category (e.g., “oppty” 544) may be a derived category designed to predict a sales conversion rate in a B2B sales environment. The forty-fourth category 544 may extend the concept of frequency in the traditional RFM model to combine a sales representative's experience (e.g., “lead_owner_job”) with the frequency (e.g., “customer_idx_count”) of a customer's revisits. The synergy effect between experienced sales representatives and loyal customers may be quantified and calculated, thereby enabling more accurate sales performance prediction that go beyond mere transaction frequency to account for qualitative aspects of business relationships.

A forty-fifth category (e.g., “vertical_level” 545) may utilize an approach that identifies strategically important verticals within each business field and assigns weights to the verticals. The forty-fifth category 545 may be a derived category generated by analyzing existing weighted variables, such as the eleventh category 511, the twelveth category 512, and the twenty-third category 523. In a specific industry field, through these weighted variables, non-weighted data may be regarded as a strategically less important vertical in the corresponding field. Based on this logic, the forty-fifth category 545 may filter out strategically unimportant vertical data and assign additional weights to data corresponding to important verticals. Through this, it enables the effective identification of the most promising verticals in each business field and the formulation of the customized sales strategies accordingly, thereby contributing to the improvement of the overall business performance.

A forty-sixth category (e.g., “weight_expected_timeline” 546) is an important indicator in the B2B sales process, and may be a derived category used to predict the progress of customer transactions. The original data of the forty-sixth category 546 included an email address, consultation content, etc., unrelated to the actual timeline. However, the forty-sixth category 546 was improved considering that, due to the nature of B2B businesses, if there is no agreement on a clear timeline, the likelihood of actual transactions is low. Specifically, a scheme of assigning a weight to data including words representing a date or a period is applied. Through this, by assigning higher importance to data that is more likely to include actual timeline information, it has become possible to predict the sales conversion probability more accurately. This approach may increase the efficiency of the B2B sales process and contribute to the formulation of more accurate business strategies.

A forty-seventh category (e.g., ‘qcut’, 547) is a scheme of dividing intervals in numerical data based on quantiles. The traditional RFM model divides data into a specified number of groups using qcut, and groups the data so that the number of pieces of data belonging to each group is equal. This allows the characteristics of each group to be well reflected. The appropriate number of groups was determined by visualizing and checking the importance of variables. Eight derived categories using the qcut were generated by applying a scheme of splitting various numerical data into multiple groups with equal frequency. The splitting ensures that the number of data in each group is approximately equal. This is a methodology frequently used in the traditional RFM model. The approach minimizes the influence of extreme values and allows for effective comparison of characteristics between groups. Based on the results of visualizing and analyzing the importance of variables, data is split into an appropriate number of groups. This method may more clearly reveal the unique characteristics of each group and utilize the advantages of categorical data while preserving the characteristics of continuous variables, and thus, may be flexibly applied to various analysis techniques.

A forty-eighth category (e.g., “lead_date_yearmonth” 548) may be a time-based variable (derived category) generated by combining the year and month of a customer lead generation point. The forty-eighth category 548 may be generated by a following process. The thirtieth category 530 was grouped into various time units such as month, year, half-year, and quarter, and then analyzed. Among multiple time units, the form in which the year and month are combined showed the highest correlation and thus was selected. Through this, it is possible to reflect a business cycle of an enterprise. The yearly factor takes into account changes in a company's product lineup or changes in strategy over years, and the monthly factor reflects the tendency for customer company's purchase cycles or budget execution patterns to be concentrated in certain months. Through the forty-eighth category 548, it becomes possible to more accurately capture customer behavior patterns over time and to provide useful insights for formulating time-specific marketing strategies.

A forty-ninth category (e.g., “second_event” 549) may be a derived category generated to independently utilize important information extracted from the existing thirty-second category 532. The thirty-second category 532 may have a structure such as “(business_unit)(second_event)(lead_from_channel)(date)”. In this structure, all factors except “second_event” already existed as individual variables. However, “second_event” is the only one that is not expressed as an independent variable. Since an “event_name” variable is composed of four factors, due to various values of each factor, the “event_name” variable has the characteristic of being highly dispersed overall. This may make it difficult to find meaningful patterns during the data analysis or modeling. Therefore, by extracting the “second_event” as a separate variable, the important information may be utilized more effectively. This may contribute to more accurately reflecting the characteristics of the data and increasing the accuracy of analysis.

As described above, the train dataset 410 may include the plurality of respectively different categories 501 to 550 and the MQL data configured to have the values for the plurality of categories 501 to 550.

A fifth category (e.g., “is_fresh” 550) may be a derived category generated to increase the accuracy of customer classification. The fifth category 550 may classify customers into types such as entirely new customers, customers who previously made inquiries but did not proceed to an actual transaction, and customers with prior transaction experience. This classification or segmentation may provide crucial insights to the sales strategy formulation. This is because the approach and likelihood of success differ depending on each customer type. In particular, the second type of customers may have different needs and expectations than completely new customers, so classifying the second type of customers separately may facilitate effective customer management.

Meanwhile, the control unit 14 may perform the pre-processing on the train dataset 410 (see FIG. 4).

First, the control unit 140 may cleanse the train dataset 410 to handle the errors or missing values, and detect and remove abnormal values or duplicate records.

In an embodiment, the control unit 140 may replace the missing values with an average value or delete missing values in the train dataset 410 and identify and remove outliers and duplicate records in the train dataset 410.

In addition, when the train dataset 410 includes the categorical data, the control unit 140 may convert the categorical data into numeric data that the prediction model may understand.

In an embodiment, the control unit 140 may use at least one of the one-hot encoding and/or label encoding to convert a specific category (e.g., “is_converted” 539) into numeric data (e.g., “1” for purchase and “0” for non-purchase) that the prediction model may understand.

Furthermore, when the train dataset 410 includes at least one of numeric data and/or continuous data, the control unit 140 may adjust the range of the numeric data and/or continuous data.

In an embodiment, the control unit 140 may convert the numeric data into data with a mean of 0 and a variance of 1 through the Z-Score normalization for the numeric data, or may convert the continuous data into data between 0 and 1 through the min-max scaling for the continuous data.

Meanwhile, the control unit 140 may perform feature engineering on the train dataset 410 to generate a new category (or variable or data) from the train dataset 410.

Specifically, the control unit 140 may perform the feature engineering on the train dataset 410 of which existing categories have been preprocessed (e.g., cleansed, normalized, scaled, etc.) to generate the derived categories using one or more of the plurality of categories included in the train dataset 410 and the values corresponding to one or more of the plurality of categories.

For example, the operation of “generating the derived categories” may be an operation of extracting additional information (or meaning) from an existing category (or an original category) or generating a new category (or a derived category).

First, the control unit 140 may generate the derived variables for at least one of the plurality of categories based on a domain (see FIG. 4).

Specifically, the control unit 140 may generate the derived categories using at least one of the plurality of categories and the values corresponding to the at least one category, based on specific domain knowledge (or an analysis technique specialized for a specific domain). In this case, the control unit 140 may determine or understand which categories are important and which combinations are meaningful through the specific domain knowledge.

In an embodiment, as illustrated in FIG. 5, the control unit 140 may generate the derived category (e.g., “lead_date_yearmonth” 548) using an existing category (e.g., “lead_date” 530) and a value (e.g., “2024 Aug. 9”) corresponding to the existing category based on specialized knowledge of a specific domain (e.g., a marketing domain). The derived category 548 may be understood as a category utilized to analyze lead data at a specific point in time.

In addition, the control unit 140 may specify the value corresponding to the derived category based on the fact that the derived category is generated from the existing category. For example, the control unit 140 may specify the value corresponding to the derived category (e.g., “2024 August”) based on the fact that the derived category (e.g., “lead_date_yearmonth” 548) is generated from the existing category (e.g., “lead_date” 530) and the value corresponding to the existing category (e.g., “2024 Aug. 9”).

In addition, as described above, an embodiment of the present disclosure may generate the derived category from the train dataset 410 based on the recency-frequency-monetary (RFM) analysis.

More specifically, the control unit 140 may extract at least one category with high feature importance and a value corresponding to at least one category from the train dataset 410 based on the RFM analysis, and may generate the derived category using the extracted category and the value corresponding to the extracted category.

In an embodiment, as illustrated in FIG. 5, the control unit 140 may extract, based on RFM analysis, the seventh category (e.g., “customer_idx” 507) with high feature importance and a value (e.g., “CompanyA-1”) corresponding to the seventh category 507, the twenty-ninth category (e.g., “lead_owner” 529) and a value (e.g., “John Doe”) corresponding to the twenty-ninth category 529 from the train dataset 410, and generate the derived category using each of the extracted categories 507 and 529 and the values corresponding to the respective extracted categories. In this case, at least one derived category may be generated among the forty-second category (e.g., “lead_owner_job” 542), which represents the representative's experience level or frequency, the forty-third category (e.g., “customer_idx_count” 543), which represents whether the customer makes the repeat purchase or the frequency, and the forty-fourth category (e.g., “oppty” 544), which combines the sales representative's experience and the frequency of the customer's revisit.

The control unit 140 may specify a value corresponding to (or matching) the derived category. For example, the control unit 140 may specify a value (e.g., “25”) corresponding to the forty-second category (e.g., “lead_owner_job” 542), a value (e.g., “10”) corresponding to the forty-third category (e.g., “customer_idx_count” 543), and a value (e.g., “0.85”) corresponding to the forty-fourth category (e.g., “oppty” 544).

Through this, the train dataset 410 may further include the derived category generated through the derived variable generation process (or feature engineering) and the value corresponding to the derived category

In this way, in an embodiment of the present disclosure, by generating new derived variables from the existing data, the prediction model may learn meaningful patterns, thereby improving the performance of the prediction model.

At step S320 of FIG. 3, the train dataset may be used to configure the plurality of respectively different sub-datasets.

The control unit 140 may use the train dataset 410 to configure the plurality of respectively different sub-datasets.

For example, the operation of “configuring the plurality of respectively different sub-datasets” may be understood as an operation of configuring each of the plurality of respectively different sub-datasets using at least some of the plurality of records such that the ratio of each record including the respectively different values for a specific category among the plurality of records satisfies a preset criterion.

The control unit 140 may configure the plurality of respectively different sub-datasets based on the value corresponding to the specific category among the plurality of categories 501 to 550.

To this end, the control unit 140 may specify the specific category that serves as a basis for configuring the respectively different sub-datasets among the plurality of categories 501 to 550.

Here, the specific category may be a category representing whether the customer's purchase conversion has occurred. For instance, the control unit 140 may specify, as a specific category, the thirty-ninth category (e.g., “is_converted” 539)” which corresponds to the category representing whether the customer's purchase conversion has occurred among the plurality of categories 501 to 550. Hereinafter, for convenience of description, the specified thirty-ninth category 539 will be referred to as a specific category.

As described above, the specific category 539 is a category representing the final result of the sales activity. Whether sales success is achieved or not (e.g., whether a sales goal, such as contract conclusion and/or product purchase, is achieved) may be expressed using a binary value (e.g., “1” for success and “0” for failure).

In this case, the specific category 539 may be configured to have respectively different values depending on whether the customer's purchase conversion has occurred.

Here, the respectively different values may include a first value and a second value. More specifically, the first value may be a value corresponding to one case where the customer's purchase conversion has occurred, and the second value may be a value corresponding to another case where the customer's purchase conversion has failed.

In other words, the value corresponding to the specific category 539 may be configured to have the first value and the second value depending on whether a customer's purchase conversion has occurred.

Furthermore, the specific category 539 may correspond to the “target category” that the training target prediction model aims to predict. For example, the impact of the plurality of categories (e.g., 501 to 538, 540 to 550, etc.) may be analyzed based on the specific category 539 and the characteristics of successful sale cases may be identified.

However, in the present disclosure, the specific category is not necessarily limited to the thirty ninth category 539 as described above. For example, the specific category and the value corresponding to the specific category may vary depending on the purpose or use of the prediction system 100, and the specific category may be specified as one or more categories.

In an embodiment, the forty-third category (e.g., “customer_idx_count” 543), which represents the customer loyalty and purchase intention, may be specified as the specific category. In this embodiment, the first and second values corresponding to the thirty-ninth category 539 may be different from the first and second values corresponding to the forty-third category 543, which is specified as the specific category. The first value corresponding to the forty-third category 543 may be a value (e.g., “1” for high purchase intention) corresponding to one case where the customer's purchase intention is high, and the second value may be a value (e.g., “0” for low purchase intention) corresponding to another case where the customer's purchase intention is low.

Meanwhile, the control unit 140 may analyze the train dataset 410 to configure the plurality of respectively different sub-datasets.

For instance, the operation of analyzing the train dataset 410 may be an operation of understanding the plurality of records (or data) included in the train dataset 410 and determining (or analyzing) what value of each record has based on the understanding results.

As described above, the records may include a data value corresponding to each category.

Specifically, the control unit 140 may analyze the plurality of records included in the train dataset 410 based on the specific category 539, and, based on the analysis results, classify the plurality of records into a first record including the first value for the specific category 539 and a second record including the second value for the specific category 539, respectively.

In an embodiment, it is assumed that there are a total of 59,299 data items included in the train dataset 410. Based on the analysis results for the train dataset 410, the control unit 140 may classify, among the plurality of records included in the train dataset 410, records (e.g., “4,850 records”) including the first value for the specific category 539 as the first record, and records (e.g., “54,449 records”) including the second value for the specific category 539 as the second record.

Subsequently, the control unit 140 may calculate (or produce) the ratio of the first records and the second records included in the train dataset 410 based on the classified first and second records.

More specifically, the control unit 140 may specify the number of the classified first records and the number of the classified second records and, based on the number of the classified first records and the number of the classified second records, calculate (or produce) the ratio of the first records and the second records included in the train dataset 410.

In an embodiment, the control unit 140 may specify the number of classified first records as “4,850” and the number of classified second records as “54,449”, and, based on the specified numbers of the first and second records, produce the ratio of the first records (e.g., 8.18%) and the ratio of the second records (e.g., “91.82%). In this embodiment, the total ratio of the first records and the second records may be understood as “1:11”.

In addition, the control unit 140 may determine the number of respectively different sub-datasets in which each of the first and second records will be included, based on the specified ratios (or numbers) of the first and second records.

Here, the number of respectively different sub-datasets may be determined based on the number of second records including the second value for the specific category 539 and the number of first records including the first value for the specific category 539 among the total number of records included in the train dataset 410.

For example, the number of respectively different sub-datasets may be determined based on a value obtained or calculated by dividing the number of second records including the second value for the specific category 539 by the number of first records including the first value for the specific category 539.

The control unit 140 may determine the number of respectively different sub-datasets based on the value obtained or calculated by dividing the number of the second records including the second value for the specific category 539 included in the train dataset 410 by the number of the first records including the first value for the specific category 539. For example, as illustrated in FIG. 6, it is assumed that, among the total number of “59,299” of records included in the train dataset 410, 600, the number of the first records including the first value for the specific category 539 is “4,850” and the number of the second records including the second value for the specific category 539 is “54,449”. Based on the value obtained or calculated by dividing the number (e.g., “54,449”) of the second records including the second value for the specific category 539 by the number (e.g., “4,850”) of first records including the first value for the specific category 539, the number of respectively different sub-datasets 601 to 611 may be determined as “11”.

Meanwhile, the control unit 140 may include at least some of the plurality of records in the plurality of respectively different sub-datasets 601 to 611 such that the ratio of the first records and the second records included in the train dataset 410, 600 satisfies the preset ratio criterion.

Here, the preset ratio criterion may be preset to ensure that, in each of the plurality of respectively different sub-datasets 601 to 611, the number of the first records including the first value for the specific category 539 and the number of the second records including the second value for the specific category 539 have the same ratio.

That is, the control unit 140 may configure the plurality of respectively different sub-datasets 601 to 611 in which the number of the first records and the number of the second records including the respectively different values for the specific category 539 are balanced (e.g., have the same ratio).

First, the control unit 140 may include the first record including the first value for the specific category 539 in each of the plurality of respectively different sub-datasets 601 to 611.

In this case, the control unit 140 may include the first record in each of the plurality of respectively different sub-datasets 601 to 611 while maintaining the original number of first records including the first value for the specific category 539.

For example, the control unit 140 may include the first record in each of the plurality of respectively different sub-datasets 601 to 611 while maintaining the original number (e.g., “4,850”) of first records including the first value for the specific category 539 such that all the first records having the first value for the specific category 539 among the records included in the train dataset 410, 600 are included in each of the plurality of respectively different sub-datasets 601 to 611.

In this example, all of the plurality of respectively different sub-datasets 601 to 611 each includes the same first record.

Next, the control unit 140 may include one or more of the second records including the second value for the specific category 539 among the records included in the train dataset 410, 600 in each of the plurality of respectively different sub-datasets 601 to 611.

Here, the number of the second records included in each of the plurality of respectively different sub-datasets 601 to 611 may be determined based on the number of first records included in each of the plurality of respectively different sub-datasets 601 to 611.

The control unit 140 may include one or more of the second records in each of the plurality of respectively different sub-datasets 601 to 611 such that the number of the second records corresponds to the number of the first records included in each of the plurality of respectively different sub-datasets 601 to 611.

The respectively different second records may be extracted from each of the plurality of respectively different sub-datasets 601 to 611. The number of the second records extracted from each of the plurality of respectively different sub-datasets 601 to 611 may correspond to the number of first records included in each of the plurality of respectively different sub-datasets 601 to 611, and the extracted respectively different second records may be included in each of the plurality of respectively different sub-datasets 601 to 611.

In an embodiment, during the process of extracting one or more of the second records, the control unit 140 may extract each of the respectively different second records as many times as the number (e.g., “11”) of the plurality of sub-datasets 601 to 611. The number of the respectively different second records may correspond to the number of the first records included in each of the plurality of the respectively different sub-datasets 601 to 611, and the control unit 140 may include each of the respectively different second records in each of the plurality of respectively different sub-datasets 601 to 611.

That is, each of the plurality of respectively different sub-datasets 601 to 611 may include respectively different second records by a number corresponding to the number of the first records.

However, although the above-described embodiment described the process of configuring (or determining) eleven respectively different sub-datasets, the number of respectively different sub-datasets is not necessarily limited thereto in the present disclosure. The number of respectively different sub-datasets may vary depending on the total number of records included in the train dataset 410 or the ratio (or number) of the first records and the second records.

In an embodiment, it is assumed that the total number of records included in the train dataset 410 is “60,000”, the number of the first records including the first value for the specific category 539 is “8,000”, and the number of the second records including the second value for the specific category 539 is “52,000”. The control unit 140 may determine the number of respectively different sub-datasets to be “7” based on a value calculated by dividing the number (e.g., “52,000”) of the second records including the second value for the specific category 539 by the number (e.g., “8,000”) of the first records including the first value for the specific category 539.

In another embodiment, it is assumed that the total number of records included in the train dataset is “50,000”, the number of the first records including the first value for the specific category 539 is “3,000”, and the number of the second records including the second value for the specific category 539 is “47,000”. The control unit 140 may determine the number of respectively different sub-datasets to be “16” based on a value calculated by dividing the number of the second records (e.g., “47,000”) including the second value for the specific category 539 by the number of the first records (e.g., “3,000”) including the first value for the specific category 539.

In this way, an embodiment of the present disclosure may configure respectively different sub-datasets in which the first and second records each including a different value have the same ratio, and each sub-dataset may be independently used for model training. Through this, an embodiment of the present disclosure may address or resolve the unbalanced data problem of conventional art and prevent a model from being overfitted to a specific class, thereby improving the prediction performance of the model.

At step S330 of FIG. 3, the training target prediction model may be trained on each of the respectively different sub-datasets.

At step S340 of FIG. 3, the plurality of trained prediction models, each trained on the respectively different sub-datasets, may be acquired based on the training performed at step S330.

As described above, in an embodiment of the present disclosure, at least one training target prediction model may be included in the prediction system 100. For example, the prediction system 100 may include at least one of a first model 121, a second model 122, and a third model 123 to be trained.

For instance, the training target prediction model may be a prediction model based on a gradient boosting decision tree (GBDT) algorithm. However, the learning method according to an embodiment of the present disclosure is not necessarily limited to the prediction model based on the GBDT algorithm and may be applied to various models.

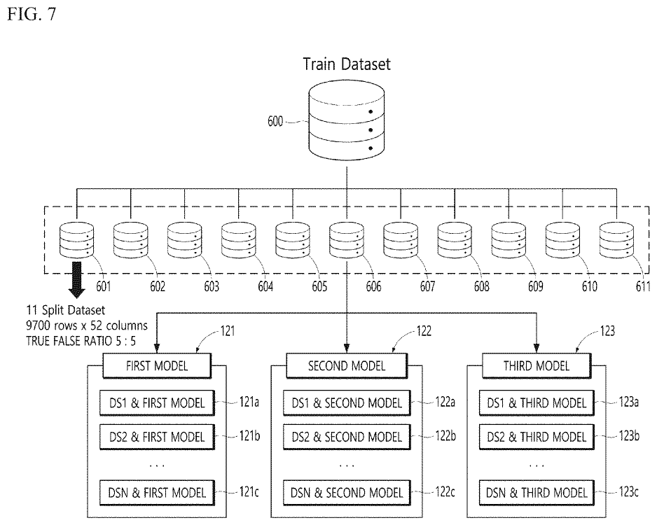

As illustrated in FIGS. 6 and 7, the control unit 140 may process the plurality of respectively different sub-datasets 601 to 611 as input to each of the plurality of prediction models 121, 122, and 123 to independently train each of the plurality of prediction models 121, 122, and 123.

Specifically, the control unit 140 may train the plurality of prediction models 121, 122, and 123 on each of the plurality of respectively different sub-datasets 601 to 611. In this embodiment, each of the plurality of prediction models 121, 122, and 123 may receive the plurality of respectively different sub-datasets 601 to 611 as inputs and perform training on each of the plurality of respectively different sub-datasets 601 to 611.

In an embodiment, the first model 121, the second model 122, and the third model 123 may each independently perform the training on the plurality of respectively different sub-datasets 601 to 611.

The control unit 140 trains each of the plurality of prediction models on each of the plurality of respectively different sub-datasets 601 to 611. When the training of the plurality of prediction models 121, 122, and 123 is completed, the plurality of trained prediction models (e.g. the number N of trained prediction models), each trained prediction model trained on the plurality of respectively different sub-datasets 601 to 611 may be acquired (see FIG. 4).

The control unit 140 may acquire the plurality of trained prediction models (e.g. 33 trained prediction models) by a number corresponding to the product of the number N (e.g., “11”) of respectively different sub-datasets 601 to 611 and the number M (e.g., “3”) of the plurality of prediction models 121, 122, and 123, as a result of training each of the plurality of prediction models 121, 122, and 123 on each of the respectively different sub-datasets 601 to 611.

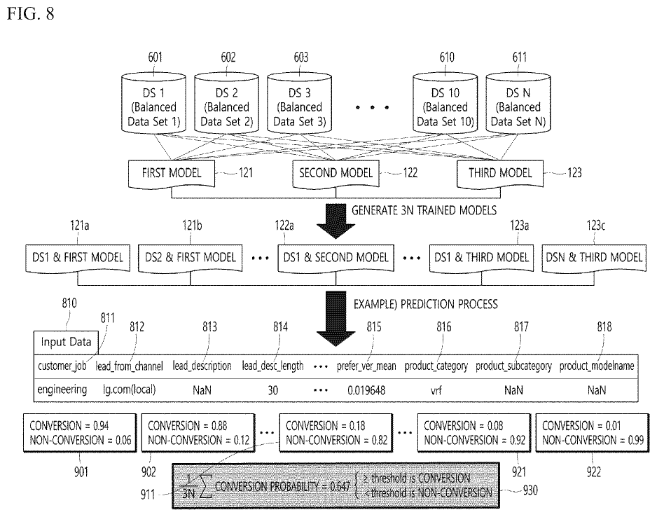

First, when the plurality of respectively different sub-datasets 601 to 611 is input to the first model 121, the first model 121 may perform the training on each of the plurality of respectively different sub-datasets 601 to 611. In this case, the control unit 140 may acquire the plurality of trained prediction models (e.g. 11 trained prediction models), each trained on the plurality of respectively different sub-datasets 601 to 611, as the results of training the first model 121 on each of the plurality of respectively different sub-datasets 601 to 611. For example, as illustrated in FIGS. 7 and 8, the control unit 140 may train the first model 121 on a first sub-dataset (e.g., “Balanced Data Set 1 (DS 1)” 601) and a second sub-dataset (e.g., “Balanced Data Set 2)” 602) to an N-th sub-dataset (e.g., “Balanced Data Set 2 (DS 2)” or a 11th sub-dataset 611), thereby acquiring a plurality of trained prediction models 121a, 121b, and 121c, each trained on the first sub-dataset 601 and the second sub-dataset 602 to the N-th sub-dataset 611.

In addition, when the plurality of respectively different sub-datasets 601 to 611 is input to the second model 122, the second model 122 may perform the training on each of the plurality of respectively different sub-datasets 601 to 611. In this case, the control unit 140 may acquire the plurality of trained prediction models, each trained on the plurality of respectively different sub-datasets 601 to 611 (e.g. 11 trained prediction models), as the results of training the second model 122 on each of the plurality of respectively different sub-datasets 601 to 611. For example, the control unit 140 may train the second model 122 on the first sub-dataset (e.g., “Balanced Data Set 1 (DS 1)” 601) and the second sub-dataset (e.g., “Balanced Data Set 2)” 602) to the N-th sub-dataset (e.g., “Balanced Data Set 2 (DS 2)” or 11th sub-dataset 611), thereby acquiring a plurality of trained prediction models 122a, 122b, and 122c, each trained on the first sub-dataset 601 and the second sub-dataset 602 to the N-th sub-dataset 611.

Furthermore, when the plurality of respectively different sub-datasets 601 to 611 are input to the third model 123, the third model 123 may perform the training on each of the plurality of respectively different sub-datasets 601 to 611. In this case, the control unit 140 may acquire the plurality of trained prediction models (e.g. 11 trained prediction models), each trained on the plurality of respectively different sub-datasets 601 to 611, as the results of training the third model 123 on each of the plurality of respectively different sub-datasets 601 to 611. For example, the control unit 140 may train the third model 123 on the first sub-dataset (e.g., “Balanced Data Set 1 (DS 1)” 601) and the second sub-dataset (e.g., “Balanced Data Set 2)” 602) to the N-th sub-dataset (e.g., “Balanced Data Set 2 (DS 2)” or 11th sub-dataset 611), thereby acquiring a plurality of trained prediction models 123a, 123b, and 123c, each trained on the first sub-dataset 601 and the second sub-dataset 602 to the N-th sub-dataset 611.

That is, when the training of each of the plurality of prediction models 121, 122, and 123 on each of the N respectively different sub-datasets is completed, each of the plurality of prediction models 121, 122, and 123 may include the plurality of trained prediction models trained on each of the N sub-datasets. In this case, the number of the plurality of trained prediction models may correspond to the product of the number N of respectively different sub-datasets and the number M of the plurality of prediction models.

Through the process described above, the control unit 140 may acquire the plurality of trained prediction models (e.g., 33 trained prediction models) in a number corresponding to the product of the number “11” of respectively different sub-datasets 601 to 611 and the number “3” of the plurality of prediction models 121, 122, and 123.

However, the number of the plurality of the acquired trained prediction models may vary depending on the number N of sub-datasets and the number M of prediction models.

In an embodiment, it is assumed that the number of respectively different sub-datasets is “20” and the number of the plurality of prediction models is “2”. In this case, the number of the plurality of the acquired trained prediction models may be “40”.

In another embodiment, it is assumed that the number of respectively different sub-datasets is “10” and the number of the plurality of prediction models is “5”. In this case, the number of the plurality of the acquired trained prediction models may be “50”.

In this way, an embodiment of the present disclosure may maximize data diversity and improve model generalization performance by independently training each model on each of the respectively different sub-datasets. In other words, according to an embodiment of the present disclosure, through the process described above, the model overfitting problem of conventional art may be reduced and the generalization performance may be improved.

At step S350 of FIG. 3, the input data to be predicted may be input to each of the plurality of trained prediction models.

At step S360 of FIG. 3, the plurality of prediction values for the input data may be acquired from each of the plurality of trained prediction models.

In this case, the input data input to the trained model may vary depending on the purpose or use of the prediction system 100. In an embodiment of the present disclosure, since the purpose of the prediction system 100 relates to the field of marketing and/or business, the following description is made on the premise that the input data related to the field of marketing and/or business is provided as input.

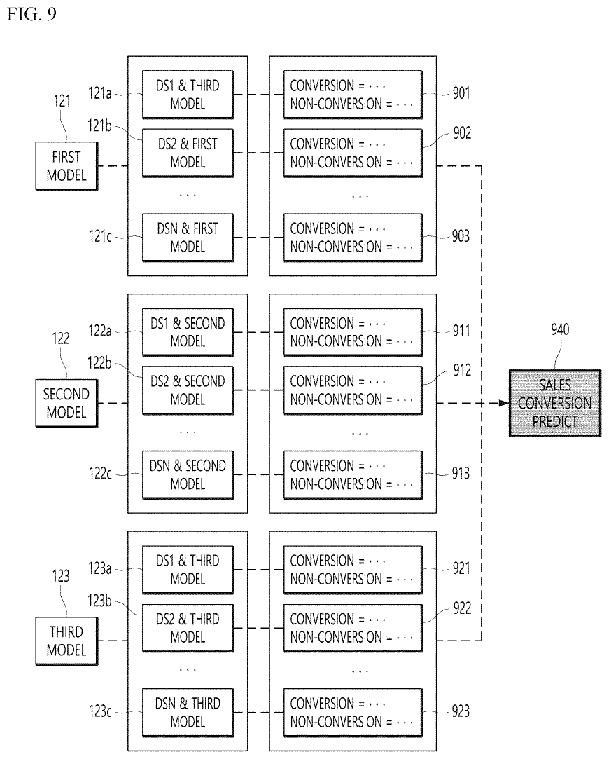

As illustrated in FIGS. 8 and 9, the control unit 140 may process at least one input data (e.g., “Input Data” 810) as input to each of the plurality of trained prediction models 121a, 121b, 121c, 122a, 122b, 122c, 123a, 123b, and 123c. Here, the input data 810 may include at least one of, for example, but not limited to, i) categorical data (e.g., “customer_job” 811) representing a customer's occupation, ii) a variable (e.g., “lead_from_channel” 812) representing a marketing channel from which business opportunity information is collected, iii) text data (e.g., “lead_description” 813) including requirements (or needs) or interests directly written by a customer, iv) text data (e.g., “lead_desc_length” 814) representing a customer's level of interest or engagement, v) a variable (e.g., “prefer_ver_mean” 815) representing a profit ratio generated from a specific vertical, vi) a variable (e.g., “product_category” 816) representing a higher category of a product requested by a customer, vii) a variable (e.g., “product_subcategory” 817) representing a lower category of a product requested by a customer, or viii) a variable (e.g., “product_modelname” 818) representing a model name of a specific product requested by a customer.

However, the information included in the input data is not limited to the examples described above and may include various other data. For example, the input data may include customer MQL data and/or customer lead data. As another example, the input data may include data related to the various categories 501 to 550 described above (see FIG. 5).

The control unit 140 may acquire the plurality of prediction values for the input data from each of the plurality of trained prediction models 121a, 121b, 121c, 122a, 122b, 122c, 123a, 123b, and 123c.

More specifically, the control unit 140 may acquire the plurality of prediction values output from each of the plurality of trained prediction models 121a, 121b, and 121c acquired through the training of the first model 121, the plurality of trained prediction models 122a, 122b, and 122c acquired through the training of the second model 122, and the plurality of trained prediction models 123a, 123b, and 123c acquired through the training of the third model 123.

In an embodiment, as illustrated in FIGS. 8 and 9, when the input data 810 is input to each of the plurality of trained prediction models 121a, 121b, and 121c acquired through the training of the first model 121, each of the plurality of trained prediction models 121a, 121b, and 121c may output prediction values for the input data 810, respectively. In this case, the prediction model (or the first model 121a) trained on the first sub-dataset 601 may output a first prediction value 901, the prediction model 121b trained on the second sub-dataset 602 may output a second prediction value 902, and the prediction model 121c trained on the N-th sub-dataset 611 may output an N-th prediction value 903.

In another embodiment, when the input data 810 is input to each of the plurality of trained prediction models 122a, 122b, and 122c acquired through the training of the second model 122, each of the plurality of trained prediction models 122a, 122b, and 122c may output the prediction values for the input data 810, respectively. In this case, the prediction model (or the second model 122a) trained on the first sub-dataset 601 may output a first prediction value 911, the prediction model 122b trained on the second sub-dataset 602 may output a second prediction value 912, and the prediction model 122c trained on the N-th sub-dataset 611 may output an N-th prediction value 913.

In another embodiment, when the input data 810 is input to each of the plurality of trained prediction models 123a, 123b, and 123c acquired through the training of the third model 123, each of the plurality of trained prediction models 123a, 123b, and 123c may output the prediction values for the input data 810, respectively. In this case, the prediction model (or the third model 123a) trained on the first sub-dataset 601 may output a first prediction value 921, the prediction model 123b trained on the second sub-dataset 602 may output a second prediction value 922, and the prediction model 123c trained on the N-th sub-dataset 611 may output an N-th prediction value 923.

In this case, the number of the plurality of prediction values 901, 902, 903, 911, 912, 913, 921, 922, and 923 acquired from the plurality of trained prediction models 121a, 121b, 121c, 122a, 122b, 122c, 123a, 123b, and 123c may correspond to a value obtained by multiplying the number N of respectively different sub-datasets by the number M of the plurality of prediction models. For example, the control unit 140 may acquire the plurality of prediction values in a number (e.g., “33”) corresponding to a value calculated or obtained by multiplying the number “11” of respectively different sub-datasets 601 to 611 by the number “3” of the plurality of prediction models 121, 122, and 123.

At step S370 of FIG. 3, a final prediction value for the input data may be specified using the plurality of prediction values.

The control unit 140 may specify a final prediction value for the input data 810 using the output of at least one trained prediction model.

Each of the plurality of trained prediction models 121a, 121b, 121c, 122a, 122b, 122c, 123a, 123b, and 123c described above may be configured to predict the value for the specific category 539. For example, each of the plurality of trained prediction models 121a, 121b, 121c, 122a, 122b, 122c, 123a, 123b, and 123c may predict whether the customer's purchase conversion will occur when the input data is input.

Specifically, the control unit 140 may use the plurality of prediction values 901, 902, 903, 911, 912, 913, 921, 922, and 923 acquired from each of the plurality of trained prediction models 121a, 121b, 121c, 122a, 122b, 122c, 123a, 123b, and 123c to specify the final prediction value for the input data 810.

First, the control unit 140 may perform soft voting based on the plurality of prediction values 901, 902, 903, 911, 912, 913, 921, 922, and 923 to specify the final prediction value (see FIG. 6).

Here, the soft voting is one of the ensemble techniques. For example, the soft voting may include an operation of determining the final prediction by averaging the results (or classes) independently predicted by each of the plurality of AI models.

The control unit 140 may calculate (or produce) an averaged probability (or purchase conversion probability, sales conversion probability, final prediction probability, etc.) based on the soft voting by averaging the plurality of prediction values 901, 902, 903, 911, 912, 913, 921, 922, and 923.

Here, the averaged probability is the result of synthesizing the plurality of prediction values output by each of the plurality of trained prediction models. The average probability may represent the likelihood (e.g. purchase conversion probability) of a customer purchasing a product or service as a probability value. For example, the control unit 140 may express the probability value as a value between 0 and 1. In this case, a value of 0.7 may indicate that a customer has a 70% likelihood of purchasing a product.

Furthermore, the control unit 140 may specify the final prediction value (e.g., sales conversion, purchase conversion, customer conversion, etc.) based on the averaged probability.

Here, the final prediction value is the finally extracted prediction result. The final prediction value may be provided with a binary classification representing whether a customer will purchase a product or service. For example, the control unit 140 may express “purchased (1)” when a customer is predicted to purchase a product, and “not purchased (0)” when a customer is predicted not to purchase a product.

In this case, the control unit 140 may compare the averaged probability with a preset threshold value. When the averaged probability satisfies a preset condition (e.g., when the averaged probability is greater than the preset threshold value), the final prediction value may be specified as “purchased (1)” and when the averaged probability does not satisfy the preset condition (e.g., when the averaged probability is less than the preset threshold value), the final prediction value may be specified as “not purchased (0)”.

The control unit 140 may specify the final prediction value for the input data 810 based on a mathematical equation 930 illustrated in FIG. 8.

In this case, it is assumed that the sales conversion probability is produced as “0.7 (70%)” and the preset condition is set to “0.65 (65%) or more”. The control unit 140 may determine whether the averaged probability (e.g., “70%”) satisfies the preset condition (e.g., “65% or more”).

In an embodiment, based on the fact that the averaged probability (e.g., “70%”) satisfies the preset condition (e.g., “65% or more”), the control unit 140 may specify the final prediction value (e.g., “sales conversion predict” 940) as “purchased (1)”.

In another embodiment, when it is assumed that the averaged probability is produced as “0.6 (60%)”, based on the fact that the averaged probability (e.g., “60%”) does not satisfy the preset condition (e.g., “65% or more”), the control unit 140 may specify the final prediction value (e.g., “sales conversion predict” 940) as “not purchased (0)”.

In this way, according to an embodiment of the present disclosure, by combining the output values of each of the plurality of models, it is possible to offset prediction errors inherent in individual models and improve overall prediction accuracy. This may improve more accurate and efficient prediction of the customer's purchase conversion probability, thereby enhancing the effectiveness of the marketing and sales strategies.

In other words, by averaging the prediction results of the plurality of trained models to produce the final prediction value, an embodiment of the present disclosure may reduce the uncertainty that may arise from relying on a single model and provide the optimized prediction results by maximally utilizing the characteristics of each model to provide optimized prediction results.

Meanwhile, in the inference stage, as illustrated in FIG. 10, a method for predicting a valid customer in a prediction system according to an embodiment of the present disclosure includes a step S1010 of receiving (or accepting) prediction target customer data to be predicted from a user terminal, a step S1020 of inputting the prediction target customer data to each of the plurality of prediction models, each trained on respectviely different sub-datasets which are split based on purchase customer data in a train dataset comprising the purchase customer data and non-purchase customer data, a step S1030 of acquiring, as output from each of the plurality of prediction models, a plurality of prediction values representing the probability that a customer corresponding to the prediction target customer data is a valid customer, a step S1040 of specifying the final prediction value for the prediction target customer data using the plurality of prediction values, and a step S1050 of providing, to the user terminal, information on whether the customer corresponding to the prediction target customer data is the valid customer using the specified final prediction value, thereby predicting whether a customer associated with customer data input by a user will purchase the company's product or service.

Here, the valid customer (or valid customer company) may mean a customer who has a clear demand for a specific product or service of a specific company and is highly likely to purchase the specific product or service.

In an embodiment, as illustrated in FIG. 11, upon receiving the prediction target customer data to be predicted from the user terminal 10, the control unit 140 may input the prediction target customer data to each of the plurality of prediction models, each trained on the respectively different sub-datasets split based on the purchase customer data in the train datasets comprising the purchase customer data and the non-purchase customer data.

The control unit 140 may obtain, as the outputs of each of the plurality of prediction models, the plurality of prediction values representing the probability that the customer corresponding to the prediction target customer data is the valid customer, and may use the plurality of prediction values to specify the final prediction value for the prediction target customer data.

Furthermore, the control unit 140 may use the specified final prediction value to provide the user terminal 10 with the information on whether the customer corresponding to the prediction target customer data is the valid customer. For example, as illustrated in FIG. 11, the control unit 140 may provide, through a service page 1000 output on the user terminal 10, prediction results 1021, 1022, and 1023 regarding whether a customer (or customer companies, U1, U2, and U3) related to customer data 1020 input by a user will purchase a specific product (e.g., “PuriCare Objet Collection Water Purifier”) of a specific company.

In this case, the first customer company U1 has a very high likelihood of purchase conversion for the specific product 1010 with a purchase probability of 80%, whereas the third customer company U3 has a low likelihood of purchase conversion for the specific product 1010 with a purchase probability of 30%.

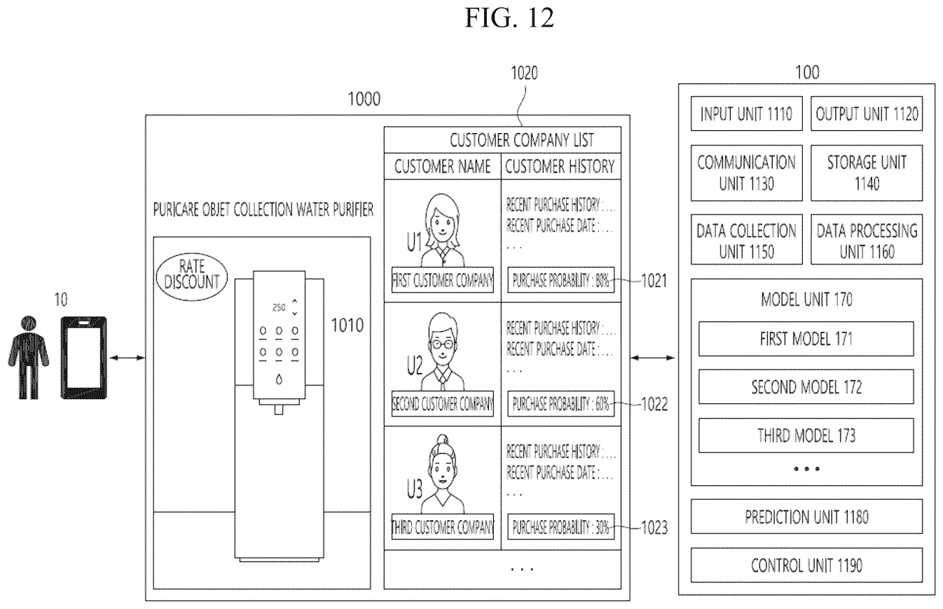

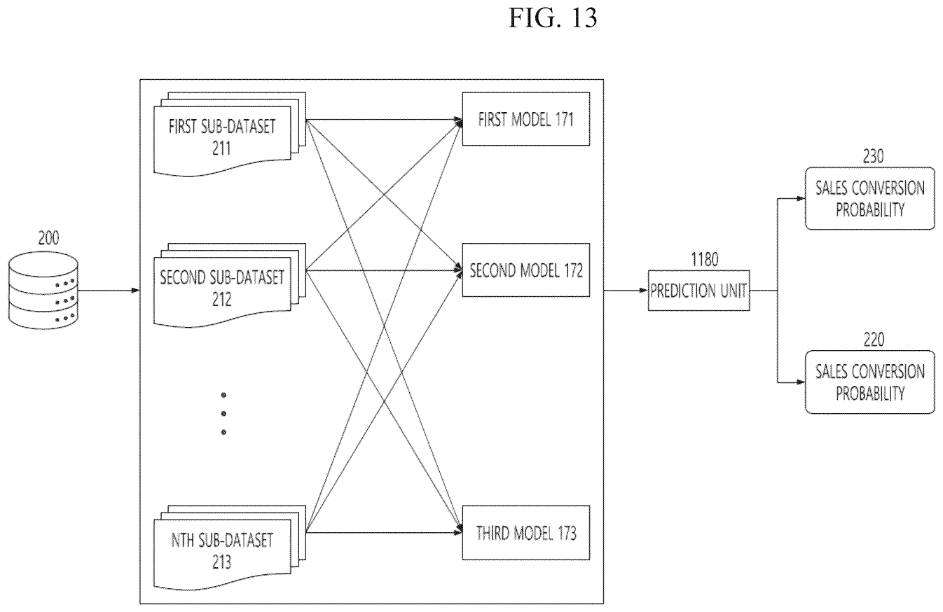

Meanwhile, an embodiment of the present disclosure may equally split the entire dataset into a preset size, configure the plurality of respectively different sub-datasets based on an index, and train a model using the plurality of respectively different sub-datasets configured based on the index. FIGS. 12 and 13 are conceptual diagrams for describing a prediction system according to another embodiment of the present disclosure.

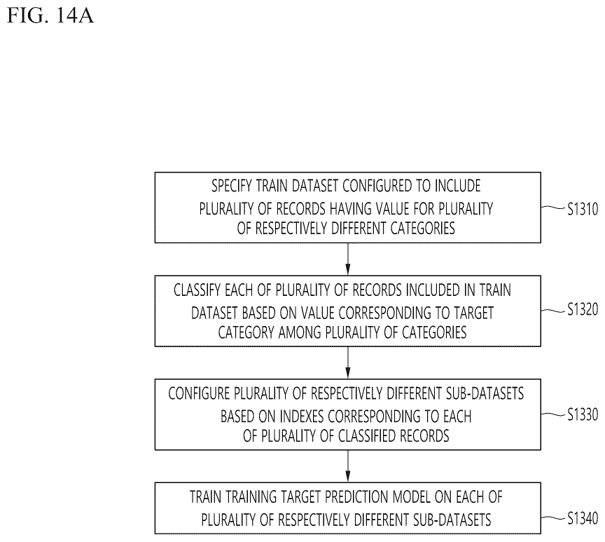

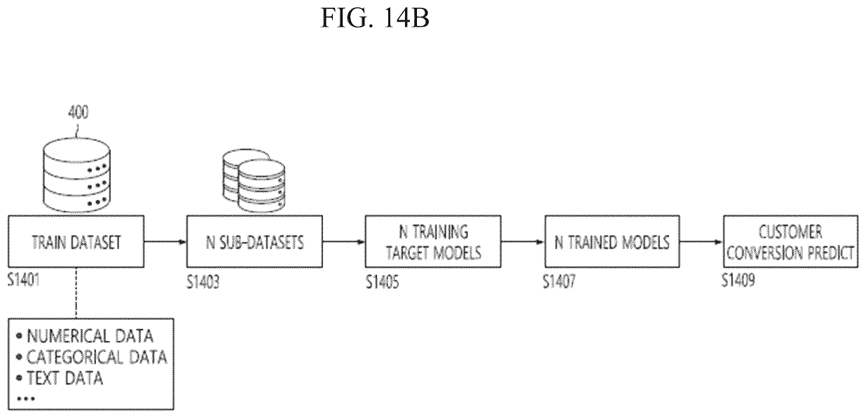

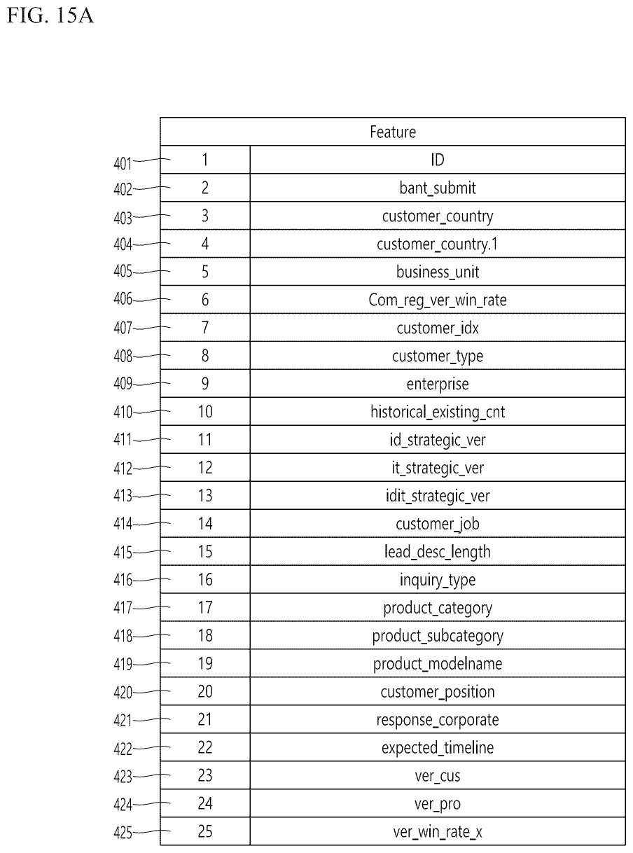

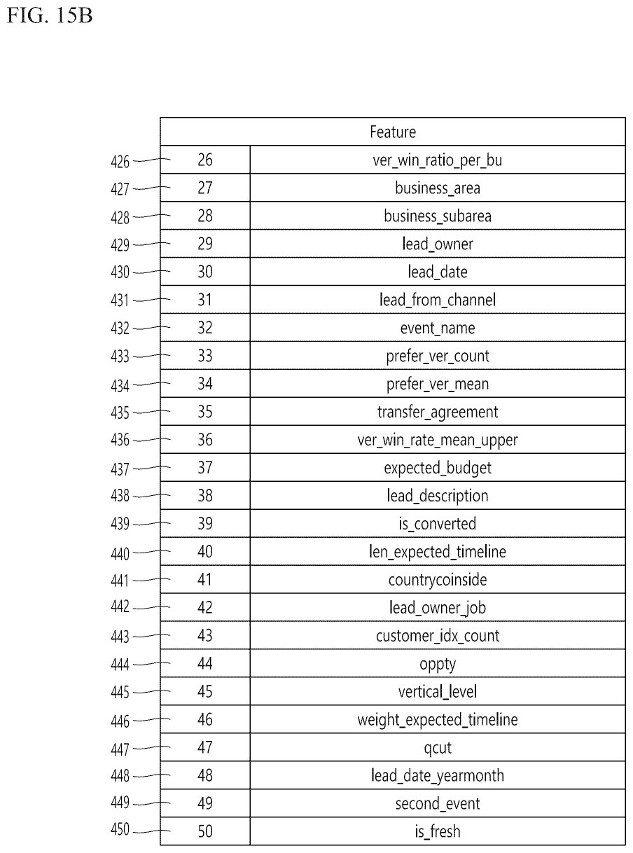

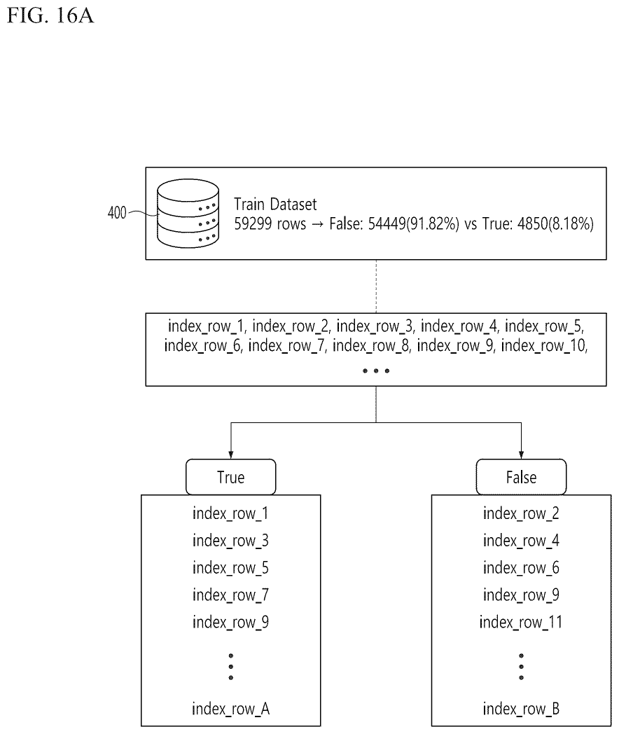

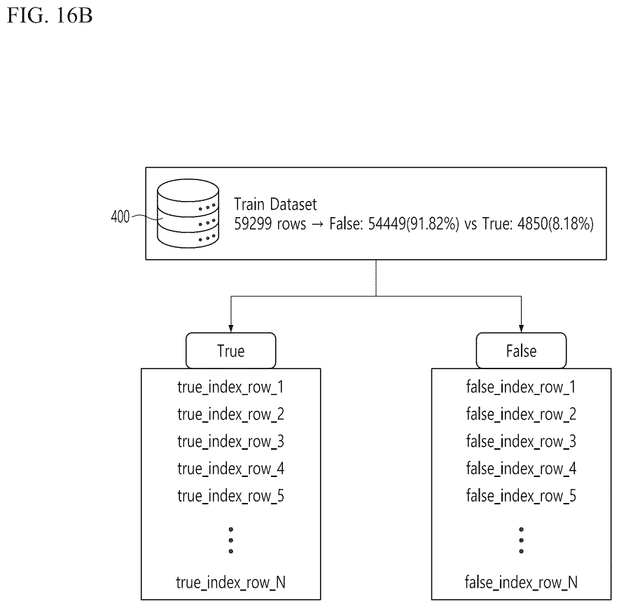

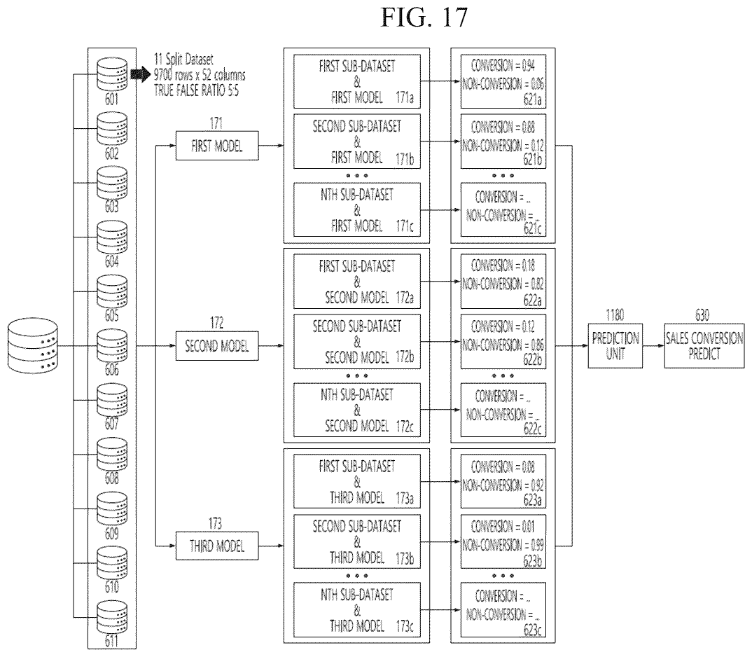

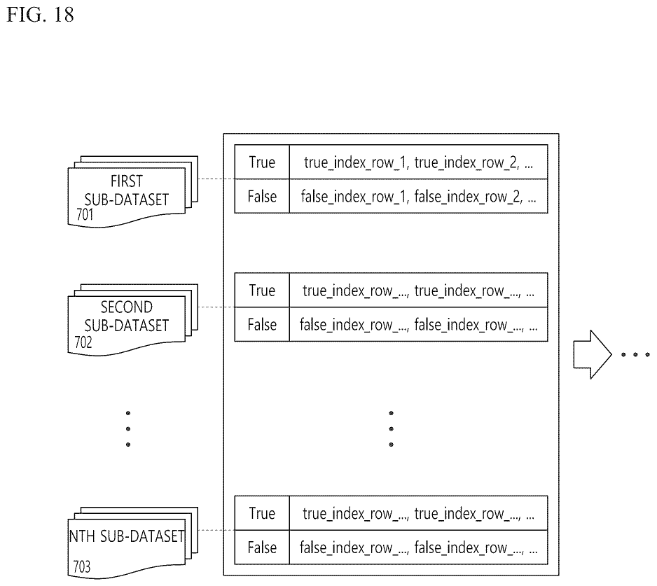

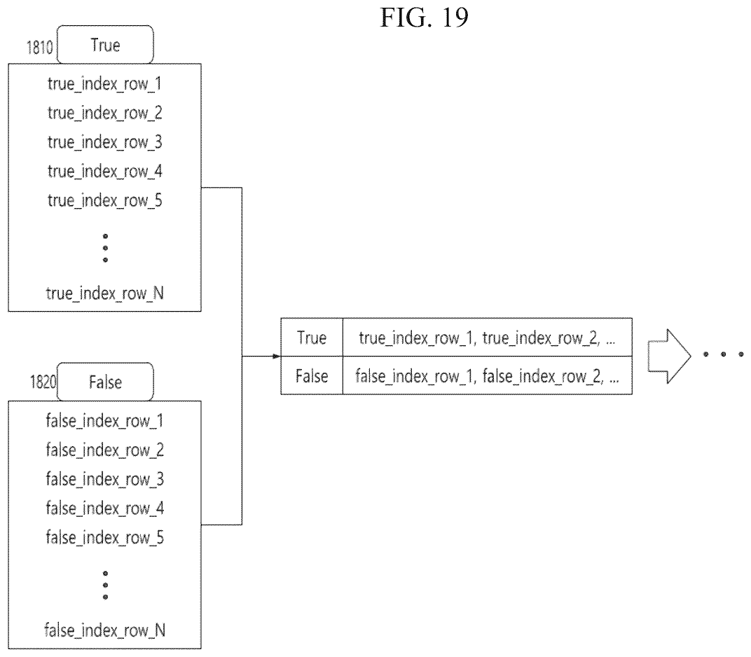

FIGS. 14A and 14B are flowcharts for describing a learning method of a prediction system according to another embodiment of the present disclosure. FIGS. 15A and 15B are conceptual diagrams for describing a train dataset according to another embodiment of the present disclosure. FIGS. 16A and 16B are conceptual diagrams for describing an embodiment of classifying each of a plurality of records included in a train dataset according to another embodiment of the present disclosure. FIG. 17 is a conceptual diagram for describing a learning method of a prediction system according to another embodiment of the present disclosure. FIGS. 18 and 19 are conceptual diagrams for describing an embodiment of the present disclosure for efficiently processing data by utilizing a data sequence-based index.

Referring to FIG. 12, a prediction system 100 according to another embodiment of the present disclosure may include at least one of an input unit 1110, an output unit 1120, a communication unit or a communicator1130, a storage unit 1140, a data collection unit 1150, a data processing unit or a data processor 1160, a model unit 1170, a prediction unit 1180, and a control unit or a controller 1190.

The prediction system 100 or one or more units or components comprised in the prediction system 100 according to an embodiment of the present disclosure may be implemented as one or more processors. The processors may include one or more general-purpose processors and/or one or more special-purpose processors (e.g., a digital signal processor, a tensor processing unit (TPU), a graphics processing unit (GPU), a neural network processing unit (NPU), an application-specific integrated circuit (ASIC), a field programmable gate array (FPGA), a quantum processing device (or quantum processor (QPU), etc). One or more processors may be configured to execute instructions stored or included in the storage unit 1140, computer-readable instructions, and/or other instructions described herein. The prediction system and its control method according to an embodiment of the present disclosure may perform data processing to be described below in association with a memory and at least one processor. The processor may perform a series of operations and data processing using data and information stored in the memory. In this case, the memory may be a component of the storage unit 1140.

In addition, the prediction system 100 according to an embodiment of the present disclosure may perform data processing and calculation processes using a quantum gate, quantum entanglement, and quantum superposition states by considering implementation in a quantum computer environment. For example, an embodiment of the present disclosure may perform a qubit-based parallel operation, and such a quantum operation may operate complementarily with computers.

The quantum computer may include a high-speed data processing device or processor utilizing the qubit-based parallel operation and the quantum entanglement, and enables hardware-based computation optimization using the FPGA and ASIC. In addition, the quantum computer may utilize a quantum processor configured to perform the qubit-based parallel operation, and improve data processing efficiency through a hybrid structure with computers.

Meanwhile, the input unit 1110 serves as a means for data input, and may be implemented in various forms. For example, the input unit 1110 may be configured to receive the user input. The input unit 1110 may be configured to receive the user input from a user terminal 10. Here, the operation of receiving the input may include an operation of receiving an input signal (or a selection signal) corresponding to the user input made by the user through the configuration of the input unit provided in the user terminal 10.

For example, the user terminal 10 may include at least one of a mobile phone, a smart phone, a notebook computer, a laptop computer, a slate personal computer (PC), a tablet PC, an ultrabook, a desktop computer, a digital broadcasting terminal, a personal digital assistant (PDA), a portable multimedia player (PMP), a navigation device, or a wearable device (e.g., a smartwatch, smart glass, or a head-mounted display (HMD)).

In addition, in an embodiment of the present disclosure, the input unit 1110 does not necessarily refer to a hardware means, but may be understood as a channel for receiving input from a user.

The input unit 1110 may include a user interface module. Additionally, the input unit 1110 may include a touch screen, a computer mouse, a keyboard, a keypad, a touch pad, a trackball, a joystick, a voice recognition module, or any type of devices which are capable of receiving a user's input. However, in the present disclosure, the type of the input unit 1110 is not limited to examples described above.

The user input may include documents, text, images (or videos), speech, etc. And, the prediction system 100 may include a module that converts speech into text.

Next, the output unit 1120 may output information through one or more components (e.g., a display, a touch screen, a speaker, etc.) provided in the user terminal 10 communicationally connected or linked to the prediction system 100 according to an embodiment of the present disclosure. For example, the output unit 1120 may output a page (e.g., a service page 1000) communicationally connected or linked to the prediction system 100 according to an embodiment of the present disclosure to the display of the user terminal 10. In addition, the output unit 1120 does not necessarily refer to hardware means, but may be understood as a channel for outputting information or processed results to the user.

Next, the communication unit or communicator 1130 may be connected to the user terminal 10, a server (e.g., a server communicationally connected or linked to the prediction system 100, a central server, an external server, etc.), a device, and at least one network or the like via a wireless or wired network, and may be configured to receive or transmit overall data and information necessary for one or more operations of the prediction system 100 according to an embodiment of the present disclosure.

The communication unit 1130 may support various communication schemes depending on communication standards of a communicating device.

For example, the communication unit 1130 may be configured to communicate with a communication target using at least one of wireless LAN (WLAN), wireless-fidelity (Wi-Fi), wireless fidelity (Wi-Fi) direct, digital living network alliance (DLAN), wireless broadband (WiBro), world interoperability for microwave access (WiMAX), high speed downlink packet access (HSDPA), high speed uplink packet access (HSUPA), long term evolution (LTE), long term evolution-advanced (LTE-A), 5th generation (5G) mobile telecommunication, Bluetooth (Bluetooth™), radio frequency identification (RFID), infrared data association (IrDA), ultra-wideband (UWB), ZigBee, near field communication (NFC), Wi-Fi direct, and wireless universal serial bus (wireless USB) technologies.

The storage unit or memory 1140 may be configured to store various data and may include one or more non-transitory or transitory computer-readable storage media that may be read and/or accessed by one or more processors.

One or more computer-readable storage media may include volatile and/or non-volatile storage components, such as optical, magnetic, organic or other memory or a disk storage device. In some examples, the storage unit 1140 may be implemented using a single physical device (e.g., a single optical, magnetic, organic, or other memory or a disk storage device), while, in other examples, the storage unit 1140 may be implemented using a plurality of physical devices.

The storage unit 1140 may store or include computer-readable instructions and additional data. The storage unit 1140 may include storage for performing one or more of the methods, processes, operations, scenarios, and techniques described herein and/or one or more functions of the devices and networks described in some embodiments of the present disclosure.

Furthermore, at least a portion of the storage unit 1140 may be implemented as a cloud storage or a cloud server. The storage unit 1140 may store data corresponding to the user input received from the input unit 1110 and at least a portion of the train dataset (or train data).

That is, the storage unit 1140 may have a storage space for storing information for one or more operations of the prediction system 100 according to an embodiment of the present disclosure, and it may be understood that there are no physical space limitations.

Furthermore, the storage unit 1140 may store a computer program including computer program instructions. Furthermore, the storage unit 1140 may store a computer program including computer program instructions that control the operation of the prediction system 100 or the operation of the control unit 1190 when the computer program instructions are loaded onto or executed by the processor of the prediction system 100.

Next, the data collection unit 1150 may be configured to collect the data for the prediction system 100 according to an embodiment of the present disclosure from various sources (e.g., a database (DB), a website, the API, a server communicationally connected or linked to the prediction system 100, a central server, an external server, a cloud storage, a user terminal 10, etc.).

The data collection unit 1150 may collect various data used for training at least one of models 1171, 1172, and 1173 included in the model unit 1170. For example, as illustrated in FIG. 13, the data collection unit 1150 may collect a train dataset 200 to be used for training at least one of the models 1171, 1172, and 1173 from various sources. In this case, the train dataset 200 may be configured to include the MQL data configured to have values for the plurality of respectively different categories.

For example, the MQL data may be information about or on potential customers (e.g., customer companies) selected through marketing activities. The MQL data may be data which may be used to identify potential customers who have shown interest in products or services or are likely to purchase products or services. The MQL data may include various elements related to records and/or behaviors indicating a customer's interest in products or services. For example, the various elements may include at least one of customer information such as information about a customer company (e.g., name, account (or customer identification number or code), contact information, email address, job title, location information, country of affiliation, affiliated enterprise (or firm) of a customer, etc.), information on an affiliated enterprise of a customer (e.g., enterprise's name, industry, size, etc.), a type and/or category of products or services that the customer has shown interest in, a customer's event history (e.g., website visit record (or number of visits) of a customer, purchase history of a customer, product page views, product inquiry, survey response, etc.), and information related to a customer's purchase intention (e.g., information such as expected budget, expected time of purchase, etc.).

However, the collected data is not necessarily limited to the examples described above. In an embodiment, in addition to the MQL data, the data processing unit 1160 may collect at least one of product data (e.g., product identification information (e.g., a product code), product name and description, product price, inventory status, product category, product ratings and reviews, product launch date, product specifications and features, etc.), sales process data (e.g., lead information, sales representative information, sales opportunity information, sales activity records, sales stages, contract information, performance indicators, etc.), and market trend data (e.g., market research reports, competitor information, industry trends, consumer behavior, economic indicators, technology trends, regional-specific or national-specific characteristics and regulatory information, etc.). Hereinafter, for convenience of description, the collected data will be referred to as a “train dataset” (e.g., “train data”).

Next, the data processing unit 1160 may be configured to perform pre-processing on the data collected from the data collection unit 1150. The data processing unit 1160 may perform pre-processing on the train dataset 200.

The data processing unit 1160 may cleanse the train dataset 200 to handle errors or missing values in the train dataset 200 and detect (or identify) and remove abnormal values or duplicate records (or data) in the train dataset 410, 600. For example, the data processing unit 1160 may replace the missing values with an average value or delete the missing values in the train dataset 200 and detect and remove the abnormal values (e.g., outliers) which are abnormally large or small and the duplicate records in the train dataset 410, 600.

In addition, when the train dataset 200 includes categorical data (or variables), the data processing unit 1160 may convert the categorical data into a numerical form understandable by an artificial intelligence (AI) model. For example, the data processing unit 1160 may convert the categorical data into a multidimensional vector using at least one of one-hot encoding and/or label encoding.

In addition, the data processing unit 1160 may adjust the range of numerical data (or continuous data) so that all variables have the same range. For example, the data processing unit 1160 may convert the numerical data into data with a mean of 0 and a variance of 1 through normalization (e.g., Z-score normalization) for the numerical data, or convert continuous data into data with a range between 0 and 1 through scaling (e.g., min-max scaling) for the continuous data. This may be understood as data processing to prevent the results from being distorted by the size of a specific variable during AI model training or to prevent the AI model from being biased toward specific features.

Furthermore, the data processing unit 1160 may expand (or augment) the data from which the AI model may learn by generating new variables (or derived variables) from the train dataset through feature engineering for the train dataset in which the existing variables have been preprocessed.

In this case, the data processing unit 1160 may generate the derived variables (or derived categories) from the train dataset 200 based on recency-frequency-monetary (RFM) analysis during the feature engineering process.

The RFM analysis is a marketing method used to evaluate and classify customers, and may include recency, frequency, and monetary. Here, the recency may refer to the time from a customer's most recent time of purchase to the present, the frequency may refer to the number of times of purchase made by a customer over a certain period or a predetermined period, and the monetary may refer to the total amount a customer has spent over a certain period or a preset period.

In an embodiment, the data processing unit 1160 may extract specific data (or variables, for example, sales representative (e.g., “lead_owner”), customer's identification information (e.g., “customer_idx”), etc.) with high feature importance from the train dataset 200 based on the RFM analysis, and generate derived variables (for example, variables representing a representative's experience level or frequency (e.g., “lead_owner_job”), variables representing whether and how often a customer makes repeat purchases (e.g., “customer_idx_count”), variables in which a sales representative's experience and a customer's revisit frequency are combined (e.g., “oppty”, etc.), etc.) for the extracted specific data.

In another embodiment, the data processing unit 1160 may separate year and month information using date data (e.g., “lead_date”) included in the train dataset 200, and generate derived variables (e.g., “lead_date_yearmonth”) that include the customer's recent purchase activity.

Meanwhile, the data processing unit 1160 may assign an index to each of the plurality of records (or data) included in the train dataset 200. For example, the index may refer to identification information (e.g., identifier, reference value, etc.) assigned to uniquely identify or make reference to each of the plurality of records included in the train dataset 200. The index may be configured to include identification information in the form of a unique identifier (ID), a numeric value, a character value, or a hash value, which is generated based on the order, position, unique key, etc., of the corresponding record.

Such an index may be assigned to each of the plurality of records included in the train dataset 200 when the collection of the train dataset 200 is complete. Alternatively, when the classification of each of the plurality of records according to the target category is complete, the index may be assigned to correspond to each classified record. In this case, the index may be employed (or used, utilized, etc.) to classify each record or configure a sub-dataset. That is, the index may be matched to a record and stored in pre-specified storage (e.g., the storage unit 1140 or memory, etc.), and may be usefully used in subsequent processing steps, such as reconfiguring records, building a dataset for model learning or evaluation, etc.

Meanwhile, the data processing unit 1160 may use the train dataset 200 to configure at least one sub-dataset.

For example, the train dataset 200 may be in an unbalanced state where data including a specific value is excessively or insufficiently included compared to data including another value, which may lead to problems in which the AI model may be biased toward frequently occurring classes. For example, in the MQL data, data including values corresponding to a case where a customer's purchase conversion has occurred may occur relatively less frequently than data including values corresponding to a case where the customer's purchase conversion has not occurred. This may lead to the unbalanced data problem and negatively impact the learning and prediction performance of the artificial intelligence model.

To address this unbalanced data problem, the data processing unit 1160 may configure a plurality of respectively different sub-datasets such that a ratio of the plurality of records each including respectively different values for a target category (or a specific category) among a plurality of data (or records) included in the train dataset 200 satisfies a preset ratio criterion. More specific description thereof will be described below.

The model unit 1170 may include at least one training target prediction model. For example, the model unit 1170 may include at least one of a first model 171, a second model 172, and a third model 173 which are a training target.

For instance, the first model 171 may be referred to as a “CatBoost model” and may be a model specialized for processing categorical data (or variables or features). The first model 171 may use a regularization technique or method called “Ordered Target Statistics” and/or “Ordered Boosting” to prevent a target leakage problem that may occur in the categorical data. In addition, the first model 171 may use a symmetric tree structure to distribute balanced data at each level of a tree. This first model 171 may prevent overfitting and achieve high prediction performance.

The second model 172 may bereferred to as a “LightGBM (LGBM) model”, and may be a model that uses “gradient-based one-side sampling (GOSS)” and/or “exclusive feature bundling (EFB)” methods to maximize a training speed, maintain high prediction performance, and reduce memory usage. The gradient-based one-side sampling (GOSS) may reduce computational complexity by sampling data based on the magnitude of the gradient, while the exclusive feature bundling (EFB) reduces the number of variables by bundling rare features. Furthermore, the second model 172 may use a leaf-wise tree growth scheme to learn deeply about specific portions of data and better identify complex data patterns.

The third model 173 may be referred to as a “XGBoost model”, and may be a gradient boosting decision tree (GBDT) algorithm-based model which is optimized for high prediction performance and overfitting prevention. The third model 173 may use normalization to prevent the overfitting and tree pruning to reduce model complexity by removing unnecessary branches. The third model 173 provides flexibility in handling missing values, and may use the level-wise tree growth scheme to equally split all nodes, thereby performing extensive training to effectively reflect diverse characteristics.

The first model 171, the second model 172, and the third model 173 may be a gradient boosting decision tree (GBDT) algorithm-based model, and may split data and perform training based on the decision tree.

However, one or more models included in the model unit 1170 according to an embodiment of the present disclosure are not necessarily limited to the examples of the models described above, and may include various models. In some embodiments of the present disclosure, the model unit 1170 may include one or more models, and the number of models included in the model unit 1170 may change variously depending on the necessity of the operations of the model unit 1170.

Meanwhile, the plurality of respectively different sub-datasets 211, 212, and 213 generated from the data processing unit 1160 may be input to each of the first, second, and third model 171, 172, and 173 included in the model unit 1170. Each of the plurality of models 171, 172, and 173 may receive the plurality of respectively different sub-datasets 211, 212, and 213 as inputs and perform training on each of the plurality of respectively different sub-datasets 211, 212, and 213.

Specifically, the first model 171, the second model 172, and the third model 173 independently perform training on each of the plurality of respectively different sub-datasets 211, 212, and 213, and when the training of each model 171,172, and 173 is completed, the plurality of trained prediction models may be acquired.

Here, the “plurality of trained prediction models” may include the trained prediction models corresponding to a number equal to the product of the number “N” of the plurality of respectively different sub-datasets 211, 212, and 213 and the number “M” of the plurality of prediction models 171, 172, and 173, as a result of training each of the plurality of prediction models 171, 172, and 173 on each of the plurality of sub-datasets 211, 212, and 213.

That is, when the training of each of the plurality of prediction models 171,172, 173, and 173 on each of the N respectively different sub-datasets is completed, each of the plurality of prediction models 171,172, 122, and 123 may include the plurality of trained prediction models trained on each of the N sub-datasets. In the present disclosure, the prediction model may also be referred to as a “binary classification model” or a BalancedTreeMarketer model.

The prediction unit 1180 may be configured to specify a final prediction result (e.g., a final prediction value) using output values of at least one trained prediction model (e.g., N trained models).

Specifically, the prediction unit 1180 may perform soft voting based on the plurality of prediction values output from each of the plurality of trained prediction models to determine or specify a final prediction value.

In an embodiment, the prediction unit 1180 may calculate (or produce) the averaged probability (or sales conversion probability 230) by averaging the plurality of prediction values (or prediction probabilities) independently predicted by each of the plurality of trained prediction models based on the soft voting, and determine or specify the final prediction value (or sales conversion predict or customer conversion, etc.) 220 based on the calculated sales conversion probability 230.

Here, the soft voting is one of ensemble techniques, and may determine a final prediction by combining (e.g., averaging) results (e.g., probabilities) independently predicted by each of a plurality of AI models. That is, the prediction unit 1180 may determine or specify the final prediction result (or a prediction value) by combining the result values (or prediction values) from each of the plurality of trained prediction models.

In addition, the averaged probability is a result of synthesizing the prediction values output by the trained prediction models, and may be understood as representing, as a probability value, the likelihood (purchase conversion probability) that a customer will purchase a product or service. For example, the prediction unit 1180 may express the probability value as a value between 0 and 1. In this example, a value of 0.7 may indicate that a customer has a 70% likelihood of purchasing a product.

Furthermore, the final prediction value 220 is the finally extracted prediction result, and may be, for instance, but not limited to, a binary classification representing whether a customer will purchase a product or service. For example, the prediction unit 1180 may indicate “purchased (1)” when a customer is predicted to purchase a product, and “not purchased (0)” when a customer is predicted not to purchase a product.

For instance, the prediction unit 1180 may compare the sales conversion probability 230 with a preset threshold value, and when the sales conversion probability 220 exceeds the preset threshold value, specify the final prediction value 220 as “purchased (1)”, and when the sales conversion probability 220 does not exceed the preset threshold value, determine or specify the final prediction value 230 as “not purchased (0)”. More specific description thereof will be described below.

The control unit 1190 may be configured to control the overall operation of the prediction system 100. The control unit 1190 may process signals, data, information, etc., input or output through the components of the prediction system 100 described above, or perform a series of data processing to process or provide information and functions to a user. The control unit 1190 may be physically implemented by the processor described above.

In an embodiment, the control unit 1190 may provide a service page 1000 to a user terminal 10. The service page 1000 may provide a list of at least one enterprise (or a list 1020 of at least one customer company) that interacts (e.g., transactions, collaborates, etc.) with a specific enterprise. In this example, the control unit 1190 may provide to one area of the service page 1000 information on a purchase probability of each customer company for a specific product (e.g., “PuriCare Objet Collection Water Purifier”) sold by a specific enterprise, as predicted by the prediction system 100.

Some embodiments of the present disclosure may provide a prediction system which may address an unbalanced data problem and be applied universally across various industry fields, a control method of the prediction system, and a learning method of the prediction system. More specifically, certain embodiments of the present disclosure may provide a prediction system capable of predicting valid customers by analyzing various customer data. Hereinafter, a learning method of a prediction system or a prediction model will be described in more detail.

At step S1310 of FIG. 14A, a train dataset configured to include a plurality of records having values for a plurality of respectively different categories may be specified.

At step S1401 of FIG. 14B, the control unit 1190 may specify a train dataset 410, 600 to be used for training a training target prediction model.

The criteria (or scheme, method, etc.) for specifying the train dataset 410, 600 may vary. The control unit 1190 may specify the train dataset 410, 600 to be used for training the training target prediction model based on various criteria.

In an embodiment, the control unit 1190 may collect (or receive) the dataset from at least one of various sources (e.g., the database (DB), the website, the API, the server communicationally connected or linked to the prediction system 100, the central server, the external server, and the cloud storage) and specify the collected dataset as the train dataset 410, 600 to be used for training the training target prediction model.

In another embodiment, the control unit 1190 may specify the dataset stored in at least one of various storages (e.g., the storage unit 1140 (or memory), the storage server, etc.) as the train dataset 410, 600 to be used for training the training target prediction model.

The train dataset 410, 600 may include various data. For example, the train dataset 410, 600 may include at least one of the MQL data, the product data, the sales process data, and the market trend data. The data included in the train dataset may comprise at least one of the following forms: numerical data, categorical data, and text data. However, the form of the data included in the train dataset is not necessarily limited to the examples described above, and the train dataset may include data in various other forms as well.

The train dataset 410, 600 may be configured to include a plurality of records having values for a plurality of respectively different categories.

Here, the record represents at least one data unit, and may include data values (i.e., multiple fields, attributes, or the like) for a plurality of categories. In a database, the record may also be referred to as a “row”. For example, in an Excel spreadsheet, each row represents one record, and each column may represent data values for various categories within the record.

That is, each piece of data included in one dataset, or a single data unit including data values for a plurality of categories, may be referred to as a “record” or a “sample”.

The train dataset 410, 600 may include the MQL data configured to have the values for the plurality of respectively different categories. Furthermore, in the present disclosure, the categories may also be referred to as “features”, “variables”, or “elements”.

Before describing a process for pre-processing the train dataset 410, 600, the plurality of categories 401 to 450 included in the train dataset 410, 600 and the values for the plurality of categories 401 to 450 will be described with reference to FIGS. 15A and 15B.

A first category (e.g., “ID” 401) is an arbitrary value that uniquely identifies each data entry, and a primary purpose of the first category may be to calculate an f1 score by comparing the first category with a thirty-ninth category (i.e., “is_converted” 439). Through the first category 401, it is possible to measure accuracy by matching each predicted result with the actual result, and the first category 401 may also be used to evaluate model performance.

A second category (e.g., “bant_submit” 402), which is a variation of a budget, authority, need, and timeline (BANT) framework, may be used to evaluate MQL quality. For instance, the “budget” may mean customer's budget information, which represents funds that may be allocated to a project or purchase. The “authority” means a customer's position, rank, or title which represents whether a person has decision-making authority. In addition, the “need” may mean customer's specific requirements, customer's problems or goals that a product or service should address, and the “timeline” may mean a customer's requested due date.

A third category (e.g., “customer_country” 403) represents customer's nationality, and a value or characters may correspond to or represent “region/country (e.g., Asia/Korea)”. The third category 403 may provide key information for regional business strategies, localized service provision, approaches based on legal and cultural understanding, etc. In addition, the third category 403 may be utilized to develop strategies that take into account time differences, language barriers, cultural differences, and the like that may arise in international business relationships.

A fourth category (e.g., “customer_country.1” 404) may refer to a region or country, such as a corporate region of a responsible company.

A fifth category (e.g., “business_unit” 405) may be a business unit within a company corresponding to a product or service requested in the MQL, and may be divided into a plurality of categories (e.g., five categories including ID, AS, IT, Solution, CM). These categories may be important for understanding the nature of leads and assigning an appropriate sales team or expert, and may be utilized for performance analysis, resource allocation, strategy formulation, etc., for each business unit.

A sixth category (e.g., “com_reg_ver_win_rate” 406) is a weight obtained by calculating an opportunity (oppty) ratio based on a specific business area (vertical level 1), a specific business unit or business division, or region, and may be used to predict a future success likelihood based on a past success rate.

A seventh category (e.g., “customer_idx” 407) may store a customer company name and the number of times that a customer company submits data to indirectly show the customer company's level of engagement or interest. A high value represents that the company frequently makes an inquiry or performs interaction, which may indicate a high level of interest or purchase intention. For example, the seventh category 407 may be used for customer segmentation, prioritization, the formulation of customized marketing strategies, etc.

An eighth category (e.g., “customer_type” 408) may be data that classifies a customer's occupation, and may be useful for formulating targeted marketing or customized business strategies.

A ninth category (e.g., “enterprise” 409) may represent a size of a customer company, and may be divided into enterprise and small and medium business (SMB).

A tenth category (e.g., “historical_existing_cnt” 410) may mean the number of times that a customer or firm was successfully converted into a sale in the past. The tenth category 410 may be useful for evaluating customer loyalty or the likelihood of repeat purchases. A high value represents a strong business relationship with the corresponding customer and may be understood as a high likelihood of future transactions.

A eleventh category (e.g., “id_strategic_ver” 411) may include a weight representing the strategic importance of a combination of a specific business unit (BU) and a specific business area (vertical level 1). The eleventh category 411 may be utilized to optimize resource allocation by reflecting the company's strategic priorities and to increase a concentration level in specific business areas.

Similarly to the eleventh category 412, a twelveth category (e.g., “it_strategic_ver” 411) may include a weight representing the strategic importance of a combination of a specific business unit and a specific business area (vertical level 1). The weight is a weight for a specific business unit (e.g., IT business unit), so the efficient technical personnel allocation and planning may be established.

A thirteenth category (e.g., “idit_strategic_ver” 413) may include a composite indicator that integrates the eleventh category 411 and the twelveth category 412. When at least one of the eleventh category 411 and/or the twelveth category 412 has a value of 1, the thirteenth category 413 may be assigned a weight of 1. The thirteenth category 413 provides an integrated strategic importance encompassing ID and IT areas and may be utilized as a consideration factor in determining company-wide resource allocation.

A fourteenth category (e.g., “customer_job” 414) may include categorical data representing occupational groups. Through the fourteenth category 414, a communication method considering the characteristics of each occupation may be adopted, and the customer grouping may be achieved based on the occupation.

A fifteenth category (e.g., “lead_desc_length” 415) may include the total length of lead description text written by a customer. The fifteenth category may indirectly indicate the customer's level of interest or engagement and reflect the complexity of the customer's requirements or issues.

A sixteenth category (e.g., “inquiry_type” 416) may include information classifying a type of customer inquiry. For example, the sixteenth category 416 may be divided into a plurality of various categories (e.g., 71) including product information inquiries, purchase consultations, quotation requests, etc. Through this, the sixteenth category may be used to understand the customer's purchasing stage and serve as an important factor in formulating the marketing strategies. In addition, the sixteenth category 416 may assist in sales conversion by assigning an appropriate department or representative based on the inquiry type.

A seventeenth category (e.g., “product_category” 417) may include a parent category of a requested product. For example, the seventeenth category 417 may be divided into a plurality of categories (e.g., 357) including tablets, TVs, washing machines, refrigerators, etc. Through this, it is possible to develop the marketing strategies focused on the customer's desired categories.

A eighteenth category (e.g., “product_subcategory” 418) may inlcude classification of more detailed subcategories of a requested product. For example, the eighteenth category 418 may be divided into a plurality of subcategories (e.g., 330), such as OLED, QLED, and 8K TVs, and thus, may include a more detailed product classification system. Through this, it is possible to identify precise customer needs and provide more segmented marketing.

A ninteenth category (e.g., “product_modelname” 419) may include a model name of a specific product requested by a customer. For example, since the customer provides very specific information, it is possible to accurately understand the customer's interest. Based on the model name of the specific product, it is possible to create customized proposals and develop personalized sales approaches. As a result, it is possible to increase the customer satisfaction and improve the sales conversion rate.

A twentieth category (e.g., “customer_position” 420) may include a customer's position within a company who made an inquiry. Through this, it is possible to understand the customer's level of authority in purchasing decisions. In addition, the twentieth category 420 may be a key element in formulating differentiated business and marketing strategies based on the position.

A twenty-first category (e.g., ‘response_corporate’ 421) may include data of a string type that represents a corporate name of a company responsible for handling customer inquiries or transactions. The twenty-first category 421 may play a crucial role in an enterprise structure with multiple subsidiaries. By identifying which corporate is primarily involved in customer interactions or sales processes through the twenty-first category 421, it is possible to clarify responsibilities among internal organizations and maintain consistency in customer management. In addition, through the twenty-first category 421, it is possible to acquire insights necessary for performance analysis by each corporate, optimization of resource allocation, and formulation of company-wide sales strategies.

A twenty-second category (e.g., “expected_timeline” 422) may include a deadline for completing a task requested by a customer. The twenty-second category may be utilized as an important indicator in a prediction model. This is because a customer presenting a specific schedule can be a signal of strong purchase intention. In addition, the likelihood and speed of a transaction may be estimated based on the urgency of the twenty-second category 422. For example, a short deadline may imply the quick decision-making and high conversion rate, while a long deadline may mean a larger-scale transaction or complex decision-making process. Effectively utilizing the twenty-second category 422 may help optimize resource allocation by a sales team and develop customized customer approach strategies. In other words, the twenty-second category 422 may be a factor contributing to an increase in B2B sales conversion rate.

A twenty-third category (e.g., “ver_cus” 423) may be a category in which the impact of a combination of a specific business area and a customer type on the sales conversion is quantified in the B2B sales. A weight of 1 may be assigned when a business belongs to a specific business area and at the same time, a customer type is an end consumer. Through this, it is possible to evaluate the likelihood of success in sales targeting a direct end user in a specific business area. The twenty-third category 423 reflects the importance of customer segmentation in the B2B sales strategies and may help identify a business area where an end-user-centric approach may be more effective.

A twenty-fourth category (e.g., “ver_pro” 424) may be a category that assigns a weight to a combination of a specific business area (vertical level 1) and a product type (product category). The twenty-fourth category 424 may be used to understand whether a specific product type has a higher sales conversion rate in a specific business area. The combination having the weight of 1 may mean that the product type has competitiveness and high demand in the corresponding business area. Through the twenty-fourth category 424, it is possible to understand the product groups to be prioritized in each business area and develop the customized business strategies.

A twenty-fifth category (e.g., “ver_win_rate_x” 425) may be a composite weight category that simultaneously considers the relative importance and success rate of each vertical. The twenty-fifth category is produced by multiplying the proportion occupied by the corresponding vertical among all leads by the sales conversion success rate within the vertical. The twenty-fifth category 425 enables a more balanced evaluation by considering not only the success rate but also the overall proportion of the corresponding vertical. Through this, it is possible to understand the actual importance of each vertical when allocating sales resources and formulating strategies.

A twenty-sixth category (e.g., “ver_win_ratio_per_bu” 426) may be a category that represents a sales conversion success rate for each business unit (or business division) within a specific business area. This may show how effectively each business unit is performing a business in a specific vertical. Through the twenty-sixth category 426, it is possible to identify which specific business unit is achieving the highest performance in each vertical, which may be utilized for optimal process sharing and resource allocation optimization within an organization. In addition, the twenty-sixth category 426 may be used to develop the customized sales strategies that leverage the strengths of each business unit.

A twenty-seventh category (e.g., “business_area” 427) may be a category that represents a main business area of a customer company. The twenty-seventh category 427 may be used to predict the B2B sales conversion rate. By understanding the business area of the customer company through the twenty-seventh category 427, it is possible to develop a customized approach strategy specialized for the corresponding business sector. In addition, through the twenty-seventh category 427, past success patterns in a specific business area may be analyzed to optimize sales strategies for new customer companies in similar business sectors. Through this, it is possible to promote the efficient allocation of sales resources and improve the conversion rate.

A twenty-eighth category (e.g., “business_subarea” 428) may include classification of a more detailed business area of a customer company. The twenty-eighth category 428 may help more accurately understand specific needs or requirements of a customer company. Utilizing the twenty-eighth category 428 in a prediction model may enable highly segmented market access. Based on the twenty-eighth category 428, it is possible to develop the more sophisticated business strategies and increase the conversion rate.

A twenty-ninth category (e.g., “lead_owner” 429) may be a category that represents a name of a sales representative responsible for each sales opportunity. The twenty-ninth category 429 may be used to analyze individual and team performance in a prediction model. In addition, through the twenty-ninth category 429, it is possible to identify the impact of a specific representative's sales skills, experience, or expertise in a specific business sector on the conversion rate. Furthermore, through the twenty-ninth category 429, by formulating the optimal lead allocation strategy and analyzing the collaboration patterns among team members, it is possible to improve the overall sales performance.

A thirtieth category (e.g., “lead_date” 430) may be a category that represents the date when the sales opportunity (lead) is first created. The thirtieth category 430 may be used to consider temporal factors in a prediction model. In addition, through the thirtieth category 430, it is possible to analyze the time required from lead generation to actual transaction closure, seasonal trends, changes in performance over a specific period, etc. Furthermore, through the thirtieth category 430, it is possible to understand the impact of lead recency on the conversion rate and develop timely and effective follow-up strategies. And, through this, it is possible to optimize the sales cycle and increase conversion rate.

A thirty-first category (e.g., “lead_from_channel” 431) may be a category that represents a marketing channel from which business opportunity information is collected. The thirty-first category 431 may be used to evaluate the effectiveness of each marketing channel in a prediction model. By analyzing the quality and conversion rate of the leads flowing in through a specific channel based on the thirty-first category 431, it is possible to identify the most effective marketing channel. In addition, based on the thirty-first category 431, it is possible to optimize the marketing budget allocation and develop the customized sales strategies for each channel. As a result, it is possible to improve the quality of leads and increase the overall sales conversion rates.

A thirty-second category (e.g., “event_name” 432) may be a category that represents a name of a specific marketing event in which the sales activity has been conducted. The thirty-second category 432 may be used to evaluate the effectiveness of each marketing event in a prediction model. By analyzing the quality and conversion rate of the leads generated through a specific event based on the 32nd category 432, it is possible to identify the most successful event type. In addition, the future marketing event planning and resource allocation may be optimized, and the customized follow-up sales strategies tailored to the characteristics of each event is developed based on the thirty-second category 432. As a result, it is possible to improve the event ROI and increase the overall sales conversion rate.

A thirty-third category (e.g., ‘prefer_ver_count’ 433) may be a category that represents a distribution ratio of converted cases of a specific business unit in a specific business area. The thirty-third category 433 may be used to understand the fields of strength of each business unit in a prediction model. By analyzing which vertical of a specific business unit shows a high success rate based on the thirty-third category 433, it is possible to identify the most effective target market for each business unit. Through this, it is possible to develop specialized strategies for each business unit. As a result, it is possible to maximize the strengths of each business unit to improve the overall sales conversion rate.

A thirty-fourth category (e.g., “prefer_ver_mean” 434) is calculated based on criteria similar to those of the thirty-third category 433. The thirty-fourth category may be a category that represents a ratio of profit values instead of a simple sample count. The thirty-fourth category 434 is used to understand the fields of strength of each business unit in terms of profitability in a prediction model. By analyzing which vertical of a specific business unit generates high profits, a strategy that takes into account the actual contribution to revenue rather than merely the number of successful cases can be developed. Through this, it is possible to conduct the intensive sales activities for the high-profit verticals and improve the overall sales profitability.

A thirty-fifth category (e.g., “transfer_agreement” 435) may be a category that represents whether a customer has consented to the export of the customer's lead information overseas. The thirty-fifth category 435 may be used to evaluate a customer's possiblity, openness and likelihood of global collaboration in a prediction model. For instance, a customer who consents to the export of the information is more likely to be interested in a broader range of services or global solutions. Based on the thirty-fifth category 435, customized suggestions may be made for products or services requiring international collaboration, and may be utilized in formulating global business strategies.

A thirty-sixth category (e.g., ‘ver_win_rate_mean_upper’ 436) may be a category in which a value is expressed as 1 if the value exceeds an average value of each vertical, and 0 otherwise. The thirty-sixth category 436 may be used to evaluate relative performance within each vertical in a prediction model. By analyzing the characteristics of cases that achieve above-average performance based on the thirty-sixth category 436, key factors of successful sales strategies may be identified. Through this, by applying the best practices to other cases, it is possible to improve the overall sales performance.

A thirty-seventh category (e.g., “expected_budget” 437) may be a category that represents a customer's desired budget range. The thirty-seventh category 437 may be an important indicator for evaluating a customer's purchasing intention and project scale in a prediction model. Based on the thirty-seventh category 437, appropriate products or services may be proposed based on budget size, and customized solutions may be developed to meet customers' financial expectations. In addition, based on the thirty-seventh category 437, it is possible to identify the optimal target segment through the analysis of conversion rates for each budget range, and improve the overall sales performance by optimizing the resource allocation. In particular, the thirty-seventh category 437 may be a category that is responsible for money when applying a traditional RFM model.

A thirty-eighth category (e.g., “lead_description” 438) may be a category that includes requirements directly written by a customer. The thirty-eighth category 438 may be used to understand the customer's specific needs and interests in a prediction model. By analyzing the thirty-eighth category 438 using text mining and natural language processing (NLP), the customer's potential needs and preferences may be identified. Based on the thirty-eighth category 438, it is possible to write customized proposals and develop personalized sales approaches. As a result, it is possible to increase the customer satisfaction and improve the sales conversion rate.

A thirty-ninth category (e.g., “is_converted” 439) is a core category that represents a final result of a sales activity, and may represent whether sales success is achieved or not (or whether sales succeed) using a binary value (e.g., 1: success, 0: failure). The thirty-ninth category may be a target category (or specific category) to be ultimately predicted in a prediction model. Based on the thirty-ninth category 439, it is possible to analyze the impact of various categories and understand the characteristics of successful sale cases. In addition, through the thirty-ninth category 439, it is possible to evaluate the prediction accuracy of the prediction model and perform the continuous model improvement and optimization. As a result, by accurately predicting the thirty-ninth category 439 to support the efficient resource allocation and strategic decision-making, it is possible to improve the overall B2B business performance.

A fortieth category (e.g., “len_expected_timeline” 440) may be a derived category generated during the preprocessing of the twenty-second category 422. Based on the fortieth category 440, it is possible to address the data inconsistency issue in the twenty-second category 422.

A forty-first category (e.g., “countrycoinside” 441) may be a derived category that represents whether a customer's nationality and regional information (continent) based on a corporate name of a responsible company are identical to each other. Based on the forty-first category 441, it is possible to develop a sales strategy considering regional characteristics.

A forty-second category (e.g., “lead_owner_job” 442) may be a derived category that is generated from the twenty-ninth category 429 to quantify the experience and proficiency of a sales representative in the B2B sales environment. The frequency of a sales representative appearing in the dataset is counted, and it is considered that, the higher the frequency, the more sales cases handled by the sales representative. Based on the forty-second category 442, an experienced representative may be assigned to important leads or complex cases to optimize the resource allocation, thereby ultimately increasing the customer satisfaction and sales conversion rate.

A forty-third category (e.g., “customer_idx_count” 443) may be a key indicator (or derived category) that represents customer loyalty and purchase intention. The number of appearances of each customer in the seventh category 407 is counted, and a high appearance count may mean that the customer has frequently made inquiries for transactions. This represents a continuing interest in products or services and may reflect the strength of potential purchase intention. Through the forty-third category 443, it is possible to determine a key target for establishing long-term business relationships, and it may be understood that the key target is highly likely to purchase various company products in the future.

A forty-fourth category (e.g., “oppty” 444) may be a derived category designed to predict a sales conversion rate in a B2B sales environment. The forty-fourth category 444 may extend the concept of frequency in the traditional RFM model to combine a sales representative's experience (e.g., “lead_owner_job”) with the frequency (e.g., “customer_idx_count”) of a customer's revisits. The synergy effect between experienced sales representatives and loyal customers may be quantified and calculated, thereby enabling more accurate sales performance prediction that go beyond mere transaction frequency to account for qualitative aspects of business relationships.

A forty-fifth category (e.g., “vertical_level” 445) may utilize an approach that identifies strategically important verticals within each business field and assigns weights to the verticals. The forty-fifth category 445 may be a derived category generated by analyzing the existing weighted variables, such as the eleventh category 411, the twelveth category 412, the twenty-third category 423, and the like. In a specific industry field, through these weighted variables, non-weighted data may be regarded as a strategically less important vertical in the corresponding field. Based on thislogic, the forty-fifth category 445 may filter out strategically unimportant vertical data and assign additional weight to data corresponding to important verticals. Through this, it enables the effective identification of the most promising verticals in each business field and the formulation of the customized sales strategies accordingly, thereby contributing to the improvement of the overall business performance.

A forty-sixth category (e.g., “weight_expected_timeline” 446) is an important indicator in the B2B sales process, and may be a derived category used to predict the progress of customer transactions. The original data of the forty-sixth category 446 included an email address, consultation content, etc., unrelated to the actual timeline. However, the forty-sixth category 546 was improved considering that, due to the nature of B2B businesses, if there is no agreement on a clear timeline, the likelihood of actual transactions is low. Specifically, a scheme of assigning a weight to data including words representing a date or a period is applied. Through this, by assigning higher importance to data that is more likely to include actual timeline information, it has become possible to predict the sales conversion probability more accurately. This approach may increase the efficiency of the B2B sales process and contribute to the formulation of more accurate business strategies.

A forty-seventh category (e.g., ‘qcut’, 447) is a scheme of dividing intervals in numerical data based on quantiles. The traditional RFM model divides data into a specified number of groups using qcut, and groups the data so that the number of pieces of data belonging to each group is equal. This allows the characteristics of each group to be well reflected. The appropriate number of groups was determined by visualizing and checking the importance of variables. Eight derived categories using the qcut were generated by applying a scheme of splitting various numerical data into multiple groups with equal frequency. The splitting ensures that the number of data in each group is approximately equal. This is a methodology frequently used in the traditional RFM model. The approach minimizes the influence of extreme values and allows for effective comparison of characteristics between groups. Based on the results of visualizing and analyzing the importance of variables, data is split into an appropriate number of groups, respectively. This method may more clearly reveal the unique characteristics of each group and utilize the advantages of categorical data while preserving the characteristics of continuous variables, and thus, may be flexibly applied to various analysis techniques.

A forty-eighth category (e.g., “lead_date_yearmonth” 448) may be a time-based variable (derived category) generated by combining the year and month of a customer lead generation point. The forty-eighth category 448 may be generated by a following process. The thirtieth category 430 was grouped into various time units such as month, year, half-year, and quarter, and then analyzed. Among multiple time units, the form in which the year and month are combined showed the highest correlation and thus was selected. Through this, it is possible to reflect a business cycle of an enterprise. The yearly factor takes into account changes in a company's product lineup or changes in strategy over years, and the monthly factor reflects the tendency for customer company's purchase cycles or budget execution patterns to be concentrated in certain months. Through the forty-eighth category 448, it becomes possible to more accurately capture customer behavior patterns over time and to provide useful insights for formulating time-specific marketing strategies”.

A forty-ninth category (e.g., “second_event” 449) may be a derived category generated to independently utilize important information extracted from the existing thirty-second category 432. The thirty-second category 432 may have a structure such as “(business_unit)(second_event)(lead_from_channel)(date)”. In this structure, all factors except “second_event” already existed as individual variables. However, “second_event” is the only one that is not expressed as an independent variable. Since an “event_name” variable is composed of four factors, due to various values of each factor, the “event_name” variable has the characteristic of being highly dispersed overall. This may make it difficult to find meaningful patterns during the data analysis or modeling. Therefore, by extracting the “second_event” as a separate variable, the important information may be utilized more effectively. This may contribute to more accurately reflecting the characteristics of the data and increasing the accuracy of analysis.

A fifth category (e.g., “is_fresh” 450) may be a derived category generated to increase the accuracy of customer classification. The fifth category 450 may classify customers into types such as entirely new customers, customers who previously made inquiries but did not proceed to an actual transaction, and customers with prior transaction experience. This classification or segmentation may provide crucial insights to the sales strategy formulation. This is because the approach and likelihood of success differ depending on each customer type. In particular, the second type of customers may have different needs and expectations than completely new customers, so classifying the second type of customers separately may facilitate effective customer management.

As described above, the train dataset 410, 600 may include the plurality of respectively different categories 401 to 450 and the MQL data configured to have values for the plurality of categories 401 to 450.

Meanwhile, the control unit 1190 may perform the pre-processing on the train dataset 410, 600.

First, the control unit 1190 may cleanse the train dataset 410, 600 to handle the errors or missing values and detect and remove abnormal values or duplicate records.

In an embodiment, the control unit 1190 may replace the missing values with an average value or delete missing values in the train dataset 410, 600 and identify and remove outliers and duplicate records in the train dataset 410, 600.

In addition, when the train dataset 410, 600 includes the categorical data, the control unit 1190 may convert the categorical data into numeric data that the prediction model may understand.

In an embodiment, the control unit 1190 may use at least one of the one-hot encoding and/or label encoding to convert a specific category (e.g., “is_converted” 439) into numeric data (e.g., “1” for purchase and “0” for non-purchase) that the prediction model may understand.

Furthermore, when the train dataset 410, 600 includes at least one of numeric data and/or continuous data, the control unit 1190 may adjust the range of the numeric data and/or continuous data.

In an embodiment, the control unit 1190 may convert the numeric data into data with a mean of 0 and a variance of 1 through the Z-Score normalization for the numeric data, or may convert the continuous data into data between 0 and 1 through the min-max scaling for the continuous data.

Meanwhile, the control unit 1190 may perform feature engineering on the train dataset 410, 600 to generate a new category (or variable or data) from the train dataset 410, 600.

Specifically, the control unit 1190 may perform the feature engineering on the train dataset 410, 600 of which existing categories have been preprocessed (e.g., cleansed, normalized, scaled, etc.) to generate the derived categories using one or more of the plurality of categories included in the train dataset 410, 600 and the values corresponding to one or more of the plurality of categories.

For example, the operation of “generating the derived categories” may be an operation of extracting additional information (or meaning) from an existing category (or an original category) or generating a new category (or a derived category).

First, the control unit 1190 may generate the derived variables for at least one of the plurality of categories based on a domain (see FIG. 14B).

Specifically, the control unit 1190 may generate the derived categories using at least one of the plurality of categories and the values corresponding to the at least one category, based on specific domain knowledge (or an analysis technique specialized for a specific domain). In this case, the control unit 1190 may determine or understand which categories are important and which combinations are meaningful through the specific domain knowledge.

In an embodiment, as illustrated in FIGS. 15A and 15B, the control unit 1190 may generate the derived category (e.g., “lead_date_yearmonth” 448) using an existing category (e.g., “lead_date” 430) and a value (e.g., “2024 Aug. 9”) corresponding to the existing category based on specialized knowledge of a specific domain (e.g., a marketing domain). The derived category 448 may be understood as a category utilized to analyze lead data at a specific point in time.

In addition, the control unit 1190 may specify the value corresponding to the derived category based on the fact that the derived category is generated from the existing category. For example, the control unit 1190 may specify the value corresponding to the derived category (e.g., “2024 August”) based on the fact that the derived category (e.g., “lead_date_yearmonth” 448) is generated from the existing category (e.g., “lead_date” 430) and the value corresponding to the existing category (e.g., “2024 Aug. 9”).

In addition, as described above, an embodiment of the present disclosure may generate the derived category from the train dataset 410, 600 based on the recency-frequency-monetary (RFM) analysis.

More specifically, the control unit 1190 may extract at least one category with high feature importance and a value corresponding to at least one category from the train dataset 410, 600 based on the RFM analysis, and may generate the derived category using the extracted category and the value corresponding to the extracted category.

In an embodiment, as illustrated in FIGS. 15A and 15B, the control unit 1190 may extract, based on the RFM analysis, the seventh category (e.g., “customer_idx” 407) with high feature importance and a value (e.g., “CompanyA-1”) corresponding to the seventh category 407, the twenty-ninth category (e.g., “lead_owner” 429) and a value (e.g., “John Doe”) corresponding to the twenty-ninth category 429 from the train dataset 410, 600, and generate the derived category using each of the extracted categories 407 and 429 and the values corresponding to the respective extracted categories. In this case, at least one derived category may be generated among the forty-third category (e.g., “lead_owner_job” 442), which represents the representative's experience level or frequency, the forty-third category (e.g., “customer_idx_count” 443), which represents whether the customer makes the repeat purchase or the frequency, and the forty-fourth category (e.g., “oppty” 444), which combines the sales representative's experience and the frequency of the customer's revisit.

The control unit 1190 may specify a value corresponding to (or matching) the derived category. For example, the control unit 1190 may specify a value (e.g., “25”) corresponding to the forty-second category (e.g., “lead_owner_job” 442), a value (e.g., “10”) corresponding to the forty-third category (e.g., “customer_idx_count” 443), and a value (e.g., “0.85”) corresponding to the forty-fourth category (e.g., “oppty” 444).

Through this, the train dataset 410, 600 may further include the derived category generated through the derived variable generation process (or feature engineering) and the value corresponding to the derived category.

In this way, in an embodiment of the present disclosure, by generating new derived variables from the existing data, the prediction model may learn meaningful patterns, thereby improving the performance of the prediction model.

At step S1320 of FIG. 14A, each of the plurality of records included in the train dataset may be classified based on the value corresponding to the target category among the plurality of categories.

The control unit 1190 may classify each of the plurality of records included in the train dataset 410, 600 based on the value corresponding to the specific category among the plurality of categories 401 to 450.

To this end, the control unit 1190 may specify the target category, which serves as a criterion for classifying each of the plurality of records included in the train dataset 410, 600 among the plurality of categories 401 to 450.

Here, the target category may be a category representing whether the customer's purchase conversion has occurred. For instance, the control unit 1190 may specify, as a target category, the thirty-ninth category (e.g., “is_converted” 439)” which corresponds to the category representing whether the customer's purchase conversion has occurred among the plurality of categories 401 to 450. Hereinafter, for convenience of description, the specified thirty-ninth category 439 will be referred to as a target category. In the present disclosure, the target category may also be referred to as the “specific category”.

As described above, the target category 439 is a category representing the final result of the sales activity. Whether sales success is achieved or not (e.g., whether a sales goal, such as contract conclusion and/or product purchase, is achieved) may be expressed using a binary value (e.g., “1” for success and “0” for failure).

In this case, the target category 439 may be configured to have respectively different values depending on whether the customer's purchase conversion has occurred.

Here, the respectively different values may include a first value and a second value. More specifically, the first value may be a value (e.g., true) corresponding to one case where the customer's purchase conversion has occurred, and the second value may be a value (e.g., false) corresponding to another case where the customer's purchase conversion has failed.

In other words, the value corresponding to the target category 439 may be configured to have the first value and the second value depending on whether a customer's purchase conversion has occurred.

Furthermore, the target category 439 may correspond to the “target category” that the training target prediction model aims to predict. For example, the impact of the plurality of categories may be analyzed based on the target category 439 and the characteristics of the successful sales case may be identified.

However, in the present disclosure, the specific category is not necessarily limited to the thirty-ninth category 439 as described above. For example, the target category and the value corresponding to the target category may vary depending on the purpose or use of the prediction system 100, and the target category may be specified as one or more categories.

In an embodiment, the forty-third category (e.g., “customer_idx_count” 443), which represents the customer loyalty and purchase intention, may be specified as the target category. In this embodiment, the first and second values corresponding to the thirty-ninth category 439 may be different from the first and second values corresponding to the forty-third category 443, which is specified as the target category. The first value corresponding to the forty-third category 443 may be a value (e.g., “1” for high purchase intention) corresponding to one case where the customer's purchase intention is high, and the second value may be a value (e.g., “0” for low purchase intention) corresponding to another case where the customer's purchase intention is low.

Further, in an embodiment of the present disclosure, an index may be assigned (or mapped, matched, set, assigned, created, included, etc.) to each of the plurality of records such that indexes correspond to the plurality of records, respectively. For example, in an embodiment shown in FIG. 16A, the train dataset 410, 600 includes a total of 59,299 records. When the train dataset 410, 600 is collected, the control unit 1190 (or data processing unit 1160) may assign an index (e.g., index_row_1, index_row_2, index_row_3, index_row_4, index_row_5, index_row_6, index_row_7, index_row_8, index_row_9, index_row_10, etc.) to each of the plurality of records included in the train dataset 410, 600. The information on the plurality of records and the indexes corresponding to each of the plurality of records may be stored in the pre-specified storage (e.g., the storage unit 1140 or memory). In addition, the train dataset 410, 600 includes the plurality of records and the indexes corresponding to each of the plurality of records, and the train dataset 410, 600 may also be stored or included in the pre-specified storage.

Meanwhile, the control unit 1190 may classify (or categorize) each of the plurality of records included in the train dataset 410, 600 based on the values that each of the plurality of records includes for the target category 439 to configure the plurality of respectively different sub-datasets. In this case, the process of classifying the plurality of records in an embodiment of the present disclosure may also be performed by the data processing unit 1160. However, for convenience of description, an example that the process of classifying the plurality of records is performed by the control unit 1190 is described herein, but that process can be performed by the data processing unit 1160.

The control unit 1190 may analyze the train dataset 410, 600 to classify each of the plurality of records included in the train dataset 410, 600.

For instance, the operation of analyzing the train dataset 410, 600 may include an operation of understanding the plurality of records (or data) included in the train dataset 410 and determining (or analyzing) what value each record has based on the results of the operation of understanding the pluraliyt of records.

As described above, the records may include a data value corresponding to each category. The control unit 1190 may classify the plurality of records included in the train dataset 410, 600 into the respectively different classes (or labels, groups, types, etc.) based on the values that each of the plurality of records includes for the target category 439.

Specifically, the control unit 1190 may analyze the plurality of records included in the train dataset 410, 600 based on the target category 439, and, based on the analysis results, classify the plurality of records into a first record(s) including the first value for the target category 439 and a second record(s) including the second value for the target category 439, respectively.

For example, in an embodiment shown in FIG. 16A, the total number of records included in the train dataset 410, 600 is 59,299. Based on the analysis results for the train dataset 410, 600, the control unit 1190 may classify, as the first record, 4,850 records including the first value (e.g., “true”) for the target category 439 among the plurality of records included in the train dataset 410, 600. In addition, the control unit 1190 may classify, as the second record, 54,449 records including the second value (e.g., “false”) for the target category 439.

In this embodiment, the indexes corresponding to each of the plurality of classified records may include first indexes (e.g., index_row_1, index_row_3, index_row_5, index_row_7, index_row_9, index_row_A, etc.) corresponding to each of the plurality of first records and second indexes (e.g., index_row_2, index_row_4, index_row_6, index_row_9, index_row_11, index_row_B, etc.) corresponding to each of the plurality of second records.

Meanwhile, in an embodiment of the present disclosure, the indexes assigned to each of the plurality of records may also be assigned after the classification of each of the plurality of records is completed according to the target category 439.

For example, in an embodiment illustrated in FIG. 16B, the classification of the first record (e.g., “4,850 records”) including the first value (e.g., “true”) for the target category 439 and the second record (e.g., “54,449 records”) including the second value (e.g., “false”) for the target category 439 among the plurality of records included in the train dataset 410, 600 has been completed. The control unit 1190 may assign respectively different preset indexes to each of the plurality of classified records. Here, the respectively different preset indexes may include at least one of the first index assigned to the record having the first value for the target category 439 and the second index assigned to the record having the second value for the target category 439.

Accordingly, the control unit 1190 may assign the first index (e.g., true_index_row_1, true_index_row_2, true_index_row_3, true_index_row_4, true_index_row_5, true_index_row_N, etc.) to each of the plurality of first records having the first value for the target category 439, and may assign the second index (e.g., false_index_row_1, false_index_row_2, false_index_row_3, false_index_row_4, false_index_row_5, false_index_row_N, etc.) to each of the plurality of second records having the second value for the target category 439. In this case, the first index may be configured in a format of “true_index_row_ . . . ” and the second index may be configured in a format of “false_index_row_ . . . ”. Accordingly, the identification information for the first index assigned to the first record and the indeitification information for the second index assigned to the second record are different from each other. However, the format in which the index is configured is not necessarily limited to the examples described above, and the indexes may be changed by the prediction system 100 or an administrator (or a user) of the prediction system 100.

In this way, when the collection of the train dataset is complete, an index corresponding to each of the plurality of records may be assigned to each of the plurality of records included in the train dataset. Alternatively, when the classification of each of the plurality of records according to the target category is complete, an index may be assigned to correspond to each classified record. However, the present disclosure is not limited to the order in which the indexes are assigned to each of the plurality of records to a single order.

Furthermore, the control unit 1190 may store the plurality of classified records and the indexes corresponding to the plurality of classified records in the pre-specified storage (e.g., the storage unit 1140 or memory, etc.) based on the value corresponding to the target category 439. For example, the control unit 1190 may group each of the plurality of classified records and store the grouped classified records in the pre-specified storage, or store the grouped classified records in the pre-specified storage in a list format.

As described above, the plurality of classified records may include the first record including the first value for the target category 439 and the second record including the second value for the target category 439.

The control unit 1190 may match the first record with the first index corresponding to the first record and store the matched first record and first index in the pre-specified storage. In addition, the control unit 1190 may match the second record with the second index corresponding to the second record and store the matched second record and second index in the pre-specified storage.

In an embodiment, the control unit 1190 may group (or list) the plurality of first records and the first indexes each corresponding to each of the plurality of first records and store the grouped first records and the first indexes in the pre-specified storage. In an embodiment of the present disclosure, the group including the plurality of first records and the first indexes each matching each of the plurality of first records may also be referred to as a “first record group (or first group)”, a “first record list (or first list)”, a “first index group” or a “first index list”, etc.

In another embodiment, the control unit 1190 may group (or list) the plurality of second records and the second indexes each corresponding to each of the plurality of second records and store the grouped second records and second index in the pre-specified storage. In this embodiment of the present disclosure, the group including the plurality of second records and the second indexes each matching each of the plurality of second records may also be referred to as a “second record group (or second group)”, a “second record list (or second list)”, a “second index group”, or a “second index list”, etc.

At step S1330 of FIG. 14A, the plurality of respectively different sub-datasets may be configured based on the indexes corresponding to each of the plurality of classified records.

At step S1403 of FIG. 14B, when the classification of the plurality of records included in the train dataset 410, 600 is completed at step S1401, the control unit 1190 may configure the plurality of respectively different sub-datasets using the plurality of classified records.

For example, the operation of configuring the plurality of respectively different sub-datasets may include an operation of configuring each of the plurality of respectively different sub-datasets using one or more of the plurality of records such that the ratio of each of the plurality of records including the respectively different values for the target category satisfies a preset ratio criterion.

The control unit 1190 may configure the plurality of respectively different sub-datasets based on the value corresponding to the target category 439 among the plurality of categories 401 to 450. More specifically, the control unit 1190 may configure the plurality of respectively different sub-datasets having a preset size based on the indexes corresponding to each of the plurality of records classified based on the value corresponding to the target category 439. For example, the preset size may be set to a size between 512 KB and 2 MB, considering both data transmission efficiency and storage space utilization. However, the preset size may be changed by the prediction system 100 or an administrator (or a user) of the prediction system 100.

As described above, the pre-specified storage may store the plurality of classified records and the indexes corresponding to each of the plurality of classified records. The control unit 1190 may configure the plurality of respectively different sub-datasets having a preset size based on the indexes corresponding to each of the plurality of classified records stored in the pre-specified storage. For example, the control unit 1190 may configure the plurality of respectively different sub-datasets having the preset size based on the first index corresponding to the first record and the second index corresponding to the second record which are stored in the pre-specified storage.

In this regard, the control unit 1190 may determine or specify one or more of the plurality of classified records to be included in each of the plurality of respectively different sub-datasets based on the indexes corresponding to each of the plurality of classified records, and may configure the plurality of respectively different sub-datasets having the preset size by including one or more of the specified records in each of the plurality of respectively different sub-datasets.

For instance, the operation of determining or specifying one or more of the plurality of classified records to be included in each of the plurality of respectively different sub-datasets based on the index may include an operation of determining or specifying one or more of the first and second records to be included in each of the plurality of respectively different sub-datasets based on the indexes corresponding to each of the first and second records. That is, it may be understood as a scheme for selecting only at least some of the first and second records necessary for configuring the plurality of respectively different sub-datasets, by utilizing the indexes corresponding to the respective first and second records. For example, the first index corresponding to the first record and the second index corresponding to the second record may be utilized to calculate the ratio of the first records and the second records, determine the number of sub-datasets, or determine the number of first records and the number of second records to be included in each of the plurality of respectively different sub-datasets.

First, the control unit 1190 may calculate (or produce) the ratio of the first records and second records included in the train dataset 410, 600 based on the classified first and second records. Alternatively, the control unit 1190 may calculate the ratio of the first records and second records stored in the pre-specified storage based on the first indexes corresponding to each of the plurality of classified first records and the second indexes corresponding to each of the plurality of classified second records.

The control unit 1190 may specify the numbers of classified first and second records, respectively, and calculate the ratio of the first records and the second records based on the specified number.

In an embodiment, the control unit 1190 may specify the number of classified first records as “4,850” and the number of classified second records as “54,449”, and, based on the specified numbers of the first and second records, calculate the ratio of the first records (e.g., 8.18%) and the ratio of the second records (e.g., “91.82%). In this case, the total ratio of the first records and the second records is “1:11”.

In addition, the control unit 1190 may determine the number of respectively different sub-datasets in which each of the first and second records will be included, based on the specified ratios (or numbers) of the first and second records.

Here, the number of respectively different sub-datasets may be determined based on the number of second records including the second value for the target category 439 and the number of first records including the first value for the target category 439 among the total number of the plurality of classified records. Alternatively, the number of second indexes corresponding to the second records and the number of first indexes corresponding to the first records may be determined based on the total number of the plurality of classified records.

For example, the control unit 1190 may determine the number of respectively different sub-datasets based on the value obtained or calculated by dividing the number of the second records including the second value for the target category 439 by the number of thefirst records including the first value for the target category 439. Alternatively, the control unit 1190 may determine the number of respectively different sub-datasets based on the value obtained by dividing the number of the second indexes corresponding to the second records by the number of the first indexes corresponding to the first records.

For example, as illustrated in FIG. 17, it is assumed that, among the total number of “59,299” of the plurality of records (e.g., the first and second records) included in the train dataset 410, 600 (or stored in the pre-specified storage), the number of the first records including the first value for the target category 439 is determined as “4,850” and the number of the second records including the second value for the target category 439 is determined as “54,449”. The control unit 1190 may determine the number of respectively different sub-datasets 601 to 611 as “11” based on the value obtained or calculated by dividing the number (e.g., “54,449”) of second records (or the second indexes corresponding to the second records) by the number (e.g., “4,850”) of first records (or the first indexes corresponding to the first records).

In this way, by utilizing the indexes assigned to each of the plurality of records, an embodiment of the present disclosure may flexibly configure various combinations of sub-datasets without physically splitting the entire dataset. In other words, by referring to the indexes corresponding to each of the plurality of records, an embodiment of the present disclosure may flexibly configure various combinations of the sub-datasets without duplicate records.

Meanwhile, the control unit 1190 may include at least some of the plurality of records in each of the plurality of respectively different sub-datasets 601 to 611 such that the ratio of the first records and the second records satisfies the preset ratio criterion.

Here, the preset ratio criterion may be preset to ensure that, in each of the plurality of respectively different sub-datasets 601 to 611, the number of the first records including the first value for the target category 439 and the number of the second records including the second value for the target category 439 have the same ratio.

That is, the control unit 1190 may configure the plurality of respectively different sub-datasets 601 to 611 in which the number of the first records and the number of the second records including the respectively different values for the target category 439 are balanced (e.g., have the same ratio). Alternatively, the configuration may be performed by using an equal splitting method that equally splits (or divides) data into each of the plurality of respectively different sub-datasets 601 to 611.

First, the control unit 1190 may include the first record including the first value for the target category 439 among the plurality of classified records in each of the plurality of respectively different sub-datasets 601 to 611.

In this case, the control unit 1190 may include the first record in each of the plurality of respectively different sub-datasets 601 to 611 while maintaining the original number of first records including the first value for the target category 439.

For example, the control unit 1190 may include the first record in each of the plurality of respectively different sub-datasets 601 to 611 while maintaining the original number (e.g., “4,850”) of first records including the first value for the target category 439 such that all the first records including the first value for the target category 439 among the plurality of classified records are included in each of the plurality of respectively different sub-datasets 601 to 611.

In this example, all of the plurality of respectively different sub-datasets 601 to 611 each includes the same first record.

Next, the control unit 1190 may include one or more of the second records including the second value for the target category 439 among the plurality of classified records in each of the plurality of respectively different sub-datasets 601 to 611.

Here, the number of the second records included in each of the plurality of respectively different sub-datasets 601 to 611 may be determined based on the number of first records included in each of the plurality of respectively different sub-datasets 601 to 611.

The control unit 1190 may include one or more of the second records in each of the plurality of respectively different sub-datasets 601 to 611 such that the number of the second records corresponds to the number of the first records included in each of the plurality of respectively different sub-datasets 601 to 611.

The respectively different second records may be extracted from each of the plurality of respectively different sub-datasets 601 to 611. The number of the second records extracted from each of the plurality of respectively different sub-datasets 601 to 611 may correspond to the number of first records included in each of the plurality of respectively different sub-datasets 601 to 611, and the extracted respectively different second records may be included in each of the plurality of respectively different sub-datasets 601 to 611.

In an embodiment, during the process of extracting one or more of the second records, the control unit 1190 may extract each of the respectively different second records as many times as the number (e.g., “11”) of the plurality of sub-datasets 601 to 611. The number of the respectively different second records may correspond to the number of the first records included in each of the plurality of the respectively different sub-datasets 601 to 611, and the control unit 1190 may include each of the respectively different second records in each of the plurality of respectively different sub-datasets 601 to 611.

That is, each of the plurality of respectively different sub-datasets 601 to 611 may include respectively different second records by a number corresponding to the number of the first records.

However, although the above-described embodiment described the process of configuring (or determining) eleven respectively different sub-datasets, the number of respectively different sub-datasets is not necessarily limited thereto in the present disclosure. The number of respectively different sub-datasets may vary depending on the total number of records included in the train dataset 410, 600 or the ratio (or number) of the first records and the second records.

In an embodiment, it is assumed that the total number of the records included in the train dataset is “60,000”, the number of the first records including the first value for the target category 439 is “8,000”, and the number of the second records including the second value for the target category 439 is “52,000”. The control unit 1190 may determine the number of respectively different sub-datasets to be “7” based on the value calcualted by dividing the number (e.g., “52,000”) of the second records including the second value for the target category 439 by the number (e.g., “8,000”) of the first records including the first value for the target category 439.

In another embodiment, it is assumed that the total number of records included in the train dataset is “50,000”, the number of the first records including the first value for the target category 439 is “3,000”, and the number of the second records including the second value for the target category 439 is “47,000”. The control unit 1190 may determine the number of respectively different sub-datasets to be “16” based on the value calculated by dividing the number of the second records (e.g., “47,000”) including the second value for the target category 439 by the number of the first records (e.g., “3,000”) including the first value for the target category 439.

In this way, an embodiment of the present disclosure may configure respectively different sub-datasets in which the first and second records each including a different value have the same ratio, and each sub-dataset may be independently used for model training. Through this, an embodiment of the present disclosure may address or resolve the unbalanced data problem of conventional art and prevent the model from being overfitted to a specific class, thereby improving the prediction performance of the model.

At step S1330 of FIG. 14A, the training target prediction model may be trained on each of the plurality of respectively different sub-datasets. At step S1340 of FIG. 14A, the plurality of trained prediction models, each trained on the plurality of respectively different sub-datasets, may be acquired based on the training performed at step S1330.

As described above, in an embodiment of the present disclosure, at least one training target prediction model may be included. For example, the prediction system 100 may include at least one of a first model 171, a second model 172, and a third model 173 to be trained.

For instance, the training target prediction model may be a prediction model based on a gradient boosting decision tree (GBDT) algorithm. However, the learning method according to an embodiment of the present disclosure is not necessarily limited to the prediction model based on the GBDT algorithm and may be applied to various models.

As illustrated in FIG. 17, the control unit 1190 may treat the plurality of respectively different sub-datasets 601 to 611 as input to each of the plurality of prediction models 171, 172, and 173 to independently train each of the plurality of prediction models 171, 172, and 173.

Specifically, the control unit 1190 may train the plurality of prediction models 171, 172, and 173 on each of the plurality of respectively different sub-datasets 601 to 611. In this embodiment, each of the plurality of prediction models 171, 172, and 173 may receive the plurality of respectively different sub-datasets 601 to 611 as inputs and perform training on each of the plurality of respectively different sub-datasets 601 to 611.

In an embodiment, the first model 171, the second model 172, and the third model 173 may each independently perform the training on the plurality of respectively different sub-datasets 601 to 611.

The control unit 1190 trains each of the plurality of prediction models on each of the plurality of respectively different sub-datasets 601 to 611. At step S1407 of FIG. 14B, when the training of the plurality of prediction models 171, 172, and 173 is completed, the plurality of trained prediction models (e.g. the number N of trained prediction models), each trained prediction model trained on the plurality of respectively different sub-datasets 601 to 611 may be acquired.

The control unit 1190 may acquire the plurality of trained prediction models (e.g. 33 trained prediction models) by a number corresponding to the product of the number N (e.g., “11”) of respectively different sub-datasets 601 to 611 and the number M (e.g., “3”) of the plurality of prediction models 171, 172, and 173, as a result of training each of the plurality of prediction models 171, 172, and 173 on each of the respectively different sub-datasets 601 to 611.

First, when the plurality of respectively different sub-datasets 601 to 611 is input to the first model 171, the first model 171 may perform the training on each of the plurality of respectively different sub-datasets 601 to 611. In this case, the control unit 1190 may acquire the plurality of trained prediction models (e.g. 11 trained prediction models), each trained on the plurality of respectively different sub-datasets 601 to 611, as the results of training the first model 171 on each of the plurality of respectively different sub-datasets 601 to 611. For example, the control unit 1190 may train the first model 171 on each of the first sub-dataset 601 and the second sub-dataset 602 to the Nth sub-dataset (or the 11th sub-dataset, 611), thereby acquiring a plurality of trained prediction models 171a, 171b, and 171c each trained on the first sub-dataset 601 and the second sub-dataset 602 to the Nth sub-dataset 611.

In addition, when the plurality of respectively different sub-datasets 601 to 611 is input to the second model 172, the second model 172 may perform the training on each of the plurality of respectively different sub-datasets 601 to 611. In this case, the control unit 1190 may acquire the plurality of trained prediction models, each trained on the plurality of respectively different sub-datasets 601 to 611 (e.g. 11 trained prediction models), as the results of training the second model 172 on each of the plurality of respectively different sub-datasets 601 to 611. For example, the control unit 1190 may train the second model 172 on each of the first sub-dataset 601 and the second sub-dataset 602 to the Nth sub-dataset (or the 11th sub-dataset, 611), thereby acquiring a plurality of trained prediction models 172a, 172b, and 172c, each trained on the first sub-dataset 601 and the second sub-dataset 602 to the Nth sub-dataset 611.

Furthermore, when the plurality of respectively different sub-datasets 601 to 611 are input to the third model 173, the third model 173 may perform the training on each of the plurality of respectively different sub-datasets 601 to 611. In this case, the control unit 1190 may acquire the plurality of trained prediction models (e.g. 11 trained prediction models), each trained on the plurality of respectively different sub-datasets 601 to 611 as the results of training the third model 173 on each of the plurality of respectively different sub-datasets 601 to 611. For example, the control unit 1190 may train the third model 173 on each of the first sub-dataset 601 and the second sub-dataset 602 to the Nth sub-dataset (or the 11th sub-dataset, 611), thereby acquiring a plurality of trained prediction models 173a, 173b, and 173c, each trained on the first sub-dataset 601 and the second sub-dataset 602 to the Nth sub-dataset 611.

That is, when the training of each of the plurality of prediction models 171, 172, and 173 on each of the N respectively different sub-datasets is completed, each of the plurality of prediction models 171, 172, and 173 may include the plurality of trained prediction models trained on each of the N sub-datasets. In this case, the number of the plurality of trained prediction models may correspond to the product of the number N of respectively different sub-datasets and the number M of the plurality of prediction models.

Through the process described above, the control unit 1190 may acquire the plurality of trained prediction models (e.g., 33 trained prediction models) in a number corresponding to the product of the number “11” of respectively different sub-datasets 601 to 611 and the number “3” of the plurality of prediction models 171, 172, and 173.

However, the number of the plurality of the acquired trained prediction models may vary depending on the number N of sub-datasets and the number M of prediction models.

In an embodiment, it is assumed that the number of respectively different sub-datasets is “20” and the number of the plurality of prediction models is “2”. In this case, the number of the plurality of the acquired trained prediction models may be “40”.

In another embodiment, it is assumed that the number of respectively different sub-datasets is “10” and the number of the plurality of prediction models is “5”. In this case, the number of the plurality of the acquired trained prediction models may be “50”.

In this way, an embodiment of the present disclosure may maximize data diversity and improve model generalization performance by independently training each model on each of the respectively different sub-datasets. In other words, according to an embodiment of the present disclosure, through the process described above, the model overfitting problem of conventional art may be reduced and the generalization performance may be improved.

Meanwhile, an embodiment of the present disclosure may input the input data to be predicted to each of the plurality of trained prediction models, and acquire the plurality of prediction values for the input data from each of the plurality of trained prediction models.

In this case, the input data input to the trained model may vary depending on the purpose or use of the prediction system 100. In an embodiment of the present disclosure, since the purpose of the prediction system 100 relates to the field of “marketing and/or business, the following description is made on the premise that the input data related to the field of “marketing and/or business” is provided as input.

The control unit 1190 may process at least one input data as input to each of the plurality of trained prediction models 171a, 171b, 171c, 172a, 172b, 172c, 173a, 173b, and 173c. Here, the input data may include at least one of, for example, but not limited to, i) categorical data (e.g., “customer_job”) representing a customer's occupation, ii) a variable (e.g., “lead_from_channel”) representing a marketing channel from which business opportunity information is collected, iii) text data (e.g., “lead_description”) including requirements (or needs) or interests directly written by a customer, iv) text data (e.g., “lead_desc_length”) representing a customer's level of interest or engagement, v) a variable (e.g., “prefer_ver_mean”) representing a profit ratio generated from a specific vertical, vi) a variable (e.g., “product_category”) representing a higher category of a product requested by a customer, vii) a variable (e.g., “product_subcategory”) representing a lower category of a product requested by a customer, or viii) a variable (e.g., “product_modelname”) representing a model name of a specific product requested by a customer.

However, the information included in the input data is not limited to the examples described above and may include various other data. For example, the input data may include customer MQL data and/or customer lead data. As another example, the input data may include data related to the various categories 401 to 450 described above (see FIG. 5).

The control unit 1190 may acquire the plurality of prediction values for the input data from each of the plurality of trained prediction models 171a, 171b, 171c, 172a, 172b, 172c, 173a, 173b, and 173c.

More specifically, the control unit 1190 may acquire the plurality of prediction values output from each of the plurality of trained prediction models 171a, 171b, and 171c acquired through the training of the first model 171, the plurality of trained prediction models 172a, 172b, and 172c acquired through the training of the second model 171, and the plurality of trained prediction models 173a, 173b, and 173c acquired through the training of the third model 172.

In an embodiment, as illustrated in FIG. 17, when the input data is input to each of the plurality of trained prediction models 171a, 171b, and 171c acquired through the training of the first model 171, each of the plurality of trained prediction models 171a, 171b, and 171c may output the prediction values for the input data, respectively. In this case, the prediction model 171a trained on the first sub-dataset 601 may output a first prediction value 621a, the prediction model 171b trained on the second sub-dataset 602 may output a second prediction value 621b, and the prediction model 171c trained on the N-th sub-dataset 611 may output an N-th prediction value 621c.

In another embodiment, when the input data is input to each of the plurality of trained prediction models 172a, 172b, and 172c acquired through the training of the second model 172, each of the plurality of trained prediction models 172a, 172b, and 172c may output the prediction values for the input data, respectively. In this case, the prediction model 172a trained on the first sub-dataset 601 may output a first prediction value 622a, the prediction model 172b trained on the second sub-dataset 602 may output a second prediction value 622b, and the prediction model 172c trained on the N-th sub-dataset 611 may output an N-th prediction value 622c.

In another embodiment, when the input data is input to each of the plurality of trained prediction models 173a, 173b, and 173c acquired through the training of the third model 173, each of the plurality of trained prediction models 173a, 173b, and 173c may output the prediction values for the input data, respectively. In this case, the prediction model 173a trained on the first sub-dataset 601 may output a first prediction value 623a, the prediction model 173b trained on the second sub-dataset 602 may output a second prediction value 623b, and the prediction model 173c trained on the N-th sub-dataset 611 may output an N-th prediction value 623c.

In this case, the number of the plurality of prediction values 621a, 621b, 621c, 622a, 622b, 622c, 623a, 623b, and 623c acquired from the plurality of trained prediction models 171a, 171b, 171c, 172a, 172b, 172c, 173a, 173b, and 173c may correspond to the value obtained by multiplying the number N of respectively different sub-datasets by the number M of prediction models. For example, the control unit 1190 may acquire the plurality of prediction values in a number (e.g., “33”) corresponding to a value calculated or obtained by multiplying the number “11” of respectively different sub-datasets 601 to 611 by the number “3” of the plurality of prediction models 171, 172, and 173.

At step S370 of FIG. 3, a final prediction value for the input data may be specified using the plurality of prediction values.

The control unit 1190 may specify a final prediction value for the input data 810 using the output of at least one trained prediction model.

Each of the plurality of trained prediction models 171a, 171b, 171c, 172a, 172b, 172c, 173a, 173b, and 173c described above may be configured to predict the value for the target category 439. For example, each of the plurality of trained prediction models 171a, 171b, 171c, 172a, 172b, 172c, 173a, 173b, and 173c may predict whether the customer's purchase conversion will occur when the input data is input.

Specifically, the control unit 1190 may use the plurality of prediction values 621a, 621b, 621c, 622a, 622b, 622c, 623a, 623b, and 623c acquired from each of the plurality of trained prediction models 171a, 171b, 171c, 172a, 172b, 172c, 173a, 173b, 173c to specify the final prediction value for the input data 810.

First, the control unit 1190 may perform soft voting based on the plurality of prediction values 621a, 621b, 621c, 622a, 622b, 622c, 623a, 623b, and 623c to specify the final prediction value.

Here, the soft voting is one of the ensemble techniques. For example, the soft voting may include an operation of determining the final prediction by averaging the results (or classes) independently predicted by each of the plurality of AI models.

The control unit 1190 (or the prediction unit 1180) may calculate (or produce) an averaged probability (or purchase conversion probability, sales conversion probability, final prediction probability, etc.) based on the soft voting by averaging the plurality of prediction values 621a, 621b, 621c, 622a, 622b, 622c, 623a, 623b, and 623c.

Here, the averaged probability is the result of synthesizing the plurality of prediction values output by each of the plurality of trained prediction models. The average probability may represent the likelihood (e.g., purchase conversion probability) of a customer purchasing a product or service as a probability value. For example, the control unit 1190 may express the probability value as a value between 0 and 1. In this case, a value of 0.7 may indicate that a customer has a 70% likelihood of purchasing a product.

At step S1409 of FIG. 14B, the control unit 1190 may specify the final prediction value (or sales conversion, purchase conversion, customer conversion, etc.) based on the averaged probability.

Here, the final prediction value is the finally extracted prediction result. The final prediction value may be provided with a binary classification representing whether a customer will purchase a product or service. For example, the control unit 1190 may express “purchased (1)” when a customer is predicted to purchase a product, and “not purchased (0)” when a customer is predicted not to purchase a product.

In this case, the control unit 1190 may compare the averaged probability with a preset threshold value. When the averaged probability satisfies a preset condition (e.g., when the averaged probability is greater than the preset threshold value), the final prediction value may be specified as “purchased (1)” and when the averaged probability does not satisfy the preset condition (e.g., when the averaged probability is less than the preset threshold value) the threshold value, the final prediction value may be specified as “not purchased (0)”.

For example, it is assumed that the sales conversion probability is produced as “0.7 (70%)” and the preset condition is set to “0.65 (65%) or more”. The control unit 1190 may determine whether the averaged probability (e.g., “70%”) satisfies the preset condition (e.g., “65% or more”).

In an embodiment, based on the fact that the averaged probability (e.g., “70%”) satisfies the preset condition (e.g., “65% or more”), the control unit 1190 may specify the final prediction value (e.g., “sales conversion predict” 630) as “purchased (1)”.

In another embodiment, when it is assumed that the averaged probability is produced as “0.6 (60%)”, based on the fact that the averaged probability (e.g., “60%”) does not satisfy the preset condition (e.g., “65% or more”), the control unit 1190 may specify the final prediction value (i.e., “sales conversion predict” 630) as “not purchased (0)”.

In this way, according to an embodiment of the present disclosure, by combining the output values of each of the plurality of models, it is possible to offset prediction errors inherent in individual models and improve overall prediction accuracy. This may improve a more accurate and efficient prediction of the customer's purchase conversion probability, thereby enhancing the effectiveness of the marketing and sales strategies.

In other words, by averaging the prediction results of the plurality of trained models to produce the final prediction value, an embodiment of the present disclosure may reduce the uncertainty that may arise from relying on a single model and provide the optimized prediction results by maximally utilizing the characteristics of each model to provide the optimized prediction results.

Meanwhile, the plurality of respectively different sub-datasets described above may be stored in the pre-specified storage and utilized in various situations.

The prediction system 100 stores the plurality of respectively different sub-datasets configured through the equal splitting method in the pre-specified storage, and may utilize the plurality of respectively different sub-datasets stored in the pre-specified storage in various situations.

In an embodiment, when it is determined that additional training (or fine-tuning) of the trained prediction model (or the plurality of trained prediction models) is necessary, the prediction system 100 may utilize the indexes corresponding to the records included in each of the plurality of respectively different sub-datasets to select (or specify) only as many records as required for additional training of the trained prediction model. It is assumed that 1,000 first records and 500 second records are needed for the additional training of the trained prediction model. In this case, as illustrated in FIG. 18, the prediction system 100 may utilize an index corresponding to the first record (e.g., true_index_row . . . ) and an index corresponding to the second record (e.g., false_index_row . . . ), which are included in at least one of the plurality of respectively different sub-datasets 701, 702, and 703, to select as many first and second records as required for the additional training of the trained prediction model, respectively. In addition, the prediction system 100 may use the selected first and second records for the additional training of the trained prediction model.

In another embodiment, when it is determined that the evaluation (or verification) of the trained prediction model (or the plurality of trained prediction models) is necessary, the prediction system 100 may utilize the indexes corresponding to the records included in each of the plurality of respectively different sub-datasets to select onlyas many records as required for the evaluation of the trained prediction model. For example, when 3,000 first records and 3,000 second records are needed for evaluation of the trained prediction model, the prediction system 100 may utilize the index (e.g., true_index_row . . . ) corresponding to the first record and the index (e.g., false_index_row . . . ) corresponding to the second record, which are included in at least one of the plurality of respectively different sub-datasets 701, 702, and 703, to select as many first and second records as required for the evaluation of the trained prediction model, respectively. In addition, the prediction system 100 may use the selected first and second records for the evaluation of the trained prediction model.

Meanwhile, as described above, each of the plurality of classified records in the train dataset may be stored in the pre-specified storage in the form of groups and/or lists. For example, as illustrated in FIG. 19, a first record group 1810 including the first record and the first index corresponding to the first record, and a second record group 1820 including the second record and the second index corresponding to the second record may be stored.

In an embodiment, when it is determined that the additional training of the trained prediction model (or the plurality of trained prediction models) is necessary, the prediction system 100 may utilize the plurality of respectively different record groups 1810 and 1820 to select only as many records as required for the additional training of the trained prediction model. For instance, when 1,000 first records and 1,000 second records are needed for the additional training of the trained prediction model, the prediction system 100 may utilize the index (e.g., true_index_row . . . ) corresponding to the first record included in the first record group 1810 and the index (e.g., false_index_row . . . ) corresponding to the second record included in the second record group 1820 to select as many first and second records as required for the additional training of the trained prediction model, respectively. In addition, the prediction system 100 may use the selected first and second records for the additional training of the trained prediction model.

In another embodiment, when it is determined that the evaluation (or verification) of the trained prediction model (or the plurality of trained prediction models) is necessary, the prediction system 100 may utilize the plurality of respecively different record groups 1810 and 1820 to select only asmany records as required for the evaluation of the trained prediction model. For instance, when 3,000 first records and 3,000 second records are needed for evaluation of the trained prediction model, the prediction system 100 may utilize the index (e.g., true_index_row . . . ) corresponding to the first record included in the first record group 1810 and the index (e.g., false_index_row . . . ) corresponding to the second record included in the second record group 1820 to select as many first and second records as required for the evaluation of the trained prediction model, respectively. In addition, the prediction system 100 may use the selected first and second records for the evaluation of the trained prediction model.

In another embodiment, when the prediction system 100 needs to configure the plurality of sub-datasets for training the training target prediction model, the prediction system 100 may use the plurality of respecively different record groups 1810 and 1820 to configure the plurality of respectively different sub-datasets necessary for training the training target prediction model. Since the method of configuring the plurality of respectively different sub-datasets has been described above, description thereof will be omitted.

Meanwhile, the prediction system 100 according to an embodiment of the present disclosure may operate in a cluster environment. Here, the cluster environment may include a computing environment in which a plurality of servers (or nodes) are configured to operate as a single system. Generally, the cloud environment is used in high-performance computing (HPC), large-scale data processing (Hadoop, Spark), cloud storage systems (e.g., Ceph, HDFS), etc. That is, the cluster environment is a method of configuring a plurality of servers (or device, computer, etc.) as a single entity and operating the servers as a single system, and is used for purposes such as high performance, high availability, and load distribution.

As described above, an embodiment of the present disclosure may configure the plurality of sub-datasets by applying an equal splitting method of equally splitting the entire dataset (or entire data file) into physical pieces of a certain size, i.e., data blocks and/or sub-datasets. Each data block (or sub-dataset) is set to have a preset size (e.g., between 512 KB and 2 MB), which may be designed to simultaneously consider data transfer efficiency and storage space utilization. That is, the equal splitting may be a key foundation for determining parallel read performance in subsequent steps, and the an embodiment of present disclosure may utilize a data sequence-based index to flexibly select only as much data as needed. In this case, the index may be used as metadata representing the order or location information of the equally split data blocks and/or sub-datasets. In other words, when the entire data file is split into the plurality of blocks, each block is assigned a unique number (e.g., block #0, block #1, block #N−1, etc.), which may be a logical identifier that allows selecting or combining only necessary blocks based on the corresponding number.

In this regard, when the prediction system 100 according to an embodiment of the present disclosure operates in the cluster environment, the prediction system 100 may include at least one or more storage servers (for example, N storage servers). In this case, the prediction system 100 may split the entire data file into a number corresponding to the N storage servers, and as a result, each storage server 200 may share the data equally. Here, including the N storage servers means the number of storage servers constituting the cluster, and the N storage servers may be configured to store data within one system (cluster), i.e., nodes that may store data. That is, in an embodiment of the present disclosure, data is split equally and stored in each storage server 200, and each storage server 200 may be used to read (or search) data in parallel when necessary.

Accordingly, in an embodiment of the present disclosure, the number of sub-datasets may be determined based on the number of storage servers in which respectively different sub-datasets are stored. For example, when the prediction system 100 includes 11 storage servers, the number of sub-datasets may be determined to be 11, corresponding to the number of storage servers. As another example, when the prediction system 100 includes 20 storage servers, the number of sub-datasets may be determined to be 20, corresponding to the number of storage servers.

When the number of respectively different sub-datasets is determined based on the number of storage servers, the prediction system 100 may configure the respectively different sub-datasets in a number corresponding to the number of storage servers and store the plurality of respectively different sub-datasets in the storage servers. For example, when it is assumed that the number of storage servers included in the prediction system 100 is 11, the prediction system 100 may configure 11 respectively different sub-datasets corresponding to the number of storage servers and store 11 configured respectively different sub-datasets in 11 storage servers, respectively. That is, the prediction system 100 may configure as many sub-datasets as the number of the plurality of storage servers, and store the plurality of configured sub-datasets in the storage servers 200, respecitvely.

Meanwhile, in the inference stage, a method for predicting a valid customer in a prediction system according to an embodiment of the present disclosure may include a step of receiving (or accepting) prediction target customer data to be predicted from a user terminal, a step of inputting the prediction target customer data to each of the plurality of prediction models, each trained on respectviely different sub-datasets which are split (or equally split) based on purchase customer data in a train dataset comprising the purchase customer data and non-purchase customer data, a step of acquiring, as output from each of the plurality of prediction models, a plurality of prediction values representing the probability that a customer corresponding to the prediction target customer data is a valid customer, a step of specifying the final prediction value for the prediction target customer data using the plurality of prediction values, and a step of providing, to the user terminal, information on whether the customer corresponding to the prediction target customer data is the valid customer using the specified final prediction value, in order to predict whether a customer associated with customer data input by a user will purchase the company's product or service.

Here, the valid customer (or valid customer company) may mean a customer who has a clear demand for a specific product or service of a specific company and is highly likely to purchase the specific product or service.

In an embodiment, upon receiving the prediction target customer data to be predicted from the user terminal 10, the control unit 1190 may input the prediction target customer data to each of the plurality of prediction models, each trained on the respectively different sub-datasets split based on the purchase customer data in the train datasets comprising the purchase customer data and the non-purchase customer data.

The control unit 1190 may acquire, as the outputs of each of the plurality of prediction models, the plurality of prediction values representing the probability that the customer corresponding to the prediction target customer data is the valid customer, and may use the plurality of prediction values to specify the final prediction value for the prediction target customer data.

Furthermore, the control unit 1190 may use the specified final prediction value to provide the user terminal 10 with the information on whether the customer corresponding to the prediction target customer data is the valid customer. For example, as illustrated in FIG. 12, the control unit 1190 may provide, through a service page 1000 output on the user terminal 10, prediction results 1021, 1022, and 1023 regarding whether a customer (or customer companies, U1, U2, and U3) related to customer data 1020 input by a user will purchase a specific product (e.g., “PuriCare Objet Collection Water Purifier”) of a specific company.

In this case, the first customer company U1 has a very high likelihood of purchase conversion for the specific product 1010 with a purchase probability of 80%, whereas the third customer company U3 has a low likelihood of purchase conversion for the specific product 1010 with a purchase probability of 30%.

As described above, according to some embodiments of the present disclosure, a prediction system, its control method, and a learning method of the prediction system according to the present disclosure may provide a prediction model trained on various business data, thereby effectively responding to various sales situations.

In addition, according to certain embodiments of the present disclosure, a prediction system, its control method, and a learning method of the prediction system may provide learning on balanced train data by addressing an unbalanced data problem of various business data. Through this, by training the prediction model with the balanced input data, some embodiments of the present disclosure may maintain stable and high prediction performance even in diverse inputs (e.g., in various situations or without being biased toward specific data) during the actual use.

In addition, according to some embodiments of the present disclosure, a prediction system, its control method, and a learning method of the prediction system can address the unbalanced data problem in the actual use environment, by performing the learning on the balanced business data. That is, by enhancing the generalization performance of the prediction model, certain embodiments of the present disclosure may provide precise and efficient computation for enabling more accurate sales conversion prediction in an actual business environment, efficient allocation of business resources, and formulation of optimized business strategy.

In addition, according to certain embodiments of the present disclosure, a prediction system, its control method, and a learning method of the prediction system according to the present disclosure may provide an automatic computation environment for formulating customized business strategies tailored to customer characteristics by analyzing various customer data. In this way, by allowing the enterprise to flexibly respond to various customer types and market environments, some embodiments of the present disclosure may strengthen long-term relationships with customers and significantly improve the performance of various businesses. In addition, the enterprise may optimize the performance in a global market and develop customized strategies tailored to country-specific characteristics. In other words, according to certain embodiments of the present disclosure, it is possible to provide critical insights for enterprise's strategic decision-making and contribute to enhancing long-term business performance.

Furthermore, according to some embodiments of the present disclosure, a prediction system, its control method, and a learning method of the prediction system may equally split the entire dataset into a predetermined size and construct a plurality of respectively different sub-datasets based on index information. In this way, certain embodiments of the present disclosure can achieve diverse combinational experiments without wasting the storage space and therefore may perform operations with less computation and storage resources. In particular, by constructing sub-datasets to satisfy ratio conditions according to a target class, some embodiments of the present disclosure may effectively alleviate the unbalanced data problem during learning. This can help improve both the accuracy and generalization performance of the prediction model.

Furthermore, according to certain embodiments of the present disclosure, by equally configuring the entire dataset to have a preset size, a prediction system, its control method, and a learning method of the prediction system according to the present disclosure may simultaneously consider data transmission efficiency and storage space utilization. In this way, some embodiments of the present disclosure may enable the parallel learning of the prediction model and shorten the overall learning time. At least one target prediction model is trained in parallel using each of several different sub-datasets.

Meanwhile, as described above, the present disclosure may be implemented as a program that is executed by one or more processes on a computer and stored on a computer-readable medium (or recording medium).

Furthermore, as described above, the present disclosure may be implemented as computer-readable codes or instructions on a medium recording the program. In other words, the present disclosure may be provided in the form of a program.

Meanwhile, the computer readable medium may include all kinds of recording devices in which computer system-readable data is stored. An example of the computer readable medium may include a hard disk drive (HDD), a solid state disk (SSD), a silicon disk drive (SDD), a read only memory (ROM), a random access memory (RAM), a compact disk read only memory (CD-ROM), a magnetic tape, a floppy disk, an optical data storage, and the like.

Furthermore, the computer-readable medium may be a server or cloud storage that includes storage and may be accessed by an electronic device via communication. In this case, the computer may download a program according to the present disclosure from the server or cloud storage via wired or wireless communication.

Furthermore, in the present disclosure, the computer described above is an electronic device equipped with a processor, i.e., a central processing unit (CPU), and there are no particular limitations on its type.

Meanwhile, the above-described detailed description is to be interpreted as being illustrative rather than being restrictive in all aspects. The scope of the present disclosure is to be determined by reasonable interpretation of the claims, and all modifications within an equivalent range of the present disclosure fall in the scope of the present disclosure.

What is claimed is:

1. A computerized method comprising:
specifying a train dataset including values for a plurality of different categories;
configuring a plurality of different sub-datasets based on a specific value of a specific category, which is at least one of values for the specific category, using the train dataset such that a ratio of different values corresponding to the specific category among the plurality of different categories satisfy a preset ratio criterion;
training a plurality of target prediction models on each of the plurality of different sub-datasets;
inputting input data to be predicted to each of the plurality of the trained target prediction models;
acquiring a plurality of prediction values for the input data from the plurality of trained target prediction models; and
specifying a final prediction value for the input data using the plurality of prediction values acquired from the plurality of the trained target prediction models.

2. The computerized method of claim 1, wherein the train dataset is configured to include a plurality of records having the values for the plurality of different categories.

3. The computerized method of claim 2, wherein:
the train dataset includes marketing qualified lead (MQL) data including the values for the plurality of different categories,
the specific category is a category representing whether a customer's purchase conversion has occurred, and
the specific value of the specific category is configured to be a first value or a second value depending on whether the customer's purchase conversion has occurred.

4. The computerized method of claim 2, wherein each of the plurality of the trained prediction models is configured to predict a value for the specific category.

5. The computerized method of claim 2, further comprising performing feature engineering on the train dataset,
wherein the performing of the feature engineering comprises generating a derived category using one or more of the plurality of categories and values corresponding to the one or more of the plurality of different categories, and specifying a value corresponding to the generated derived category.

6. The computerized method of claim 5, wherein the train dataset further includes the derived category and the value corresponding to the derived category.

7. The computerized method of claim 2, wherein:
the specific value of the specific category is configured to be a first value or a second value, and
the configuring of the plurality of different sub-datasets comprises including one or more of the plurality of records in each of the plurality of different sub-datasets such that a ratio of a number of one or more first records including the first value for the specific category to a number of one or more second records including the second value for the specific category among the plurality of records satisfies the preset ratio criterion.

8. The computerized method of claim 7, wherein the preset ratio criterion is preset such that each of the plurality of different sub-datasets has an equal ratio of the number of the one or more first records including the first value for the specific category and the number of the one or more second records including the second value for the specific category.

9. The computerized method of claim 8, further comprising determining a number of the plurality of different sub-datasets to be configured, based on the number of the one or more second records including the second value for the specific category and the number of the one or more first records including the first value for the specific category among a total number of the plurality of records included in the train dataset.

10. The computerized method of claim 9, wherein the number of the plurality of different sub-datasets to be configured is determined based on a value calculated by dividing the number of the one or more second records including the second value for the specific category by the number of the one or more first records including the first value for the specific category.

11. The computerized method of claim 8, wherein:
each of the plurality of different sub-datasets includes all of the one or more first records having the first value for the specific category among the records included in the train dataset, and
one or some of the second records having the second value for the specific category among the records included in the train dataset are included in each of the plurality of different sub-datasets in a number corresponding to the number of the one or more first records included in each of the plurality of different sub-datasets.

12. The computerized method of claim 11, wherein:
the one or more first records included in each of the plurality of different sub-datasets are identical to each other, and
the one or more second records included in each of the plurality of different sub-datasets are different from each other.

13. The computerized method of claim 1, wherein:
the plurality of target prediction models is based on a gradient boosting decision tree (GBDT) algorithm, and
the training of the plurality of target prediction models comprises training each of the plurality of target prediction models on each of the different sub-datasets, and acquiring the plurality of the trained target prediction models, each trained on the different sub-datasets.

14. The computerized method of claim 13, wherein the training of the plurality of target prediction models comprises, by training each of the plurality of target prediction models on each of the plurality of different sub-datasets, acquiring the plurality of the trained target prediction models in a number corresponding to a product of a number N of the different sub-datasets and a number M of the plurality of target prediction models.

15. The computerized method of claim 14, wherein a number of the plurality of prediction values acquired from the plurality of the trained target prediction models corresponds to a value calculated by multiplying the number N of the different sub-datasets by the number M of the plurality of target prediction models.

16. The computerized method of claim 15, wherein the specifying of the final prediction value comprises performing soft voting based on the plurality of prediction values to specify the final prediction value.

17. A computerized method comprising:
receiving prediction target customer data to be predicted from a user terminal;
inputting the prediction target customer data to each of a plurality of prediction models, each trained on a plurality of different sub-datasets;
acquiring a plurality of prediction values which represents a probability that a customer corresponding to the prediction target customer data is a valid customer and is output from the plurality of prediction models in response to the inputting of the prediction target customer data;
specifying a final prediction value for the prediction target customer data using the plurality of prediction values output from the plurality of prediction models; and
providing, to the user terminal, information about whether the customer corresponding to the prediction target customer data is the valid customer using the specified final prediction value for the prediction target customer data.

18. The computerized method of claim 17, wherein:
the prediction target customer data includes customer data of the customer who is a purchase prediction target for a specific product, and
the plurality of prediction models is trained on the plurality of sub-datasets generated using marketing qualified lead (MQL) data related to the specific product.

19. The computerized method of claim 18, wherein the plurality of sub-datasets are data that is split based on a value corresponding to a specific category among a plurality of different categories, in a train dataset including values for the plurality of different categories.

20. A system, comprising:
a memory configured to store executable instructions; and
one or more processors configured to execute one or more of the instructions to perform operations comprising:
configure, using a train dataset including values for a plurality of different categories, a plurality of different sub-datasets based on a specific value of a specific category, which is at least one of values for the specific category, such that a ratio of different values corresponding to the specific category among the plurality of different categories satisfy a preset ratio criterion;
train a plurality of target prediction models on each of the plurality of different sub-datasets;
input, to each of the plurality of the trained target prediction models, input data to be predicted;
acquire a plurality of prediction values for the input data from the plurality of trained target prediction models; and
specify a final prediction value for the input data using the plurality of prediction values acquired from the plurality of the trained target prediction models.
